(19) United States
(12) Patent Application Publication
(10) Pub. No.: US 2005/0080520 A1
(43) Pub. Date: Apr. 14, 2005

(54) Waste recovery and material handling process to replace the traditional trash transfer station and landfil by extracting reusable material and energy from joined refuse streams to include; office waste, dry waste, wet garbage and the special hazardous material handling of biological, chemical, and nuclear waste

(76) Inventors: Robert Kline, Potomac, MD (US); Richard Clark Walker, Waldorf, MD (US)

Correspondence Address: RICHARD WALKER, 15000 HUNTERS HARBOR LANE, WALDORF, MD, 20601, US

(21) Appl. No.: 10/943,897

(22) Filed: Sep. 20, 2004

Related U.S. Application Data
(60) Provisional application No. 60/503,882, filed on Sep. 22, 2003.

(51) Int. Cl. G06F 7/00

(52) U.S. Cl. 701/1

(57) ABSTRACT

This innovative technology involves stationary as well as, portable application in the form of a waste material recovery and conversion center/power plant, which is termed The Recovery Center. It has been created to replace the traditional unsanitary trash transfer station and its final repository the landfill and or city dump. The invention is ecologically friendly, reduces the nation's dependency on oil, and is politically acceptable and publicly embraced as a good neighbor business for any community. The process taught separates wet waste from dry waste and recyclables during the collection process and at the center via smart routing of refuse vehicles and progressive plant automation. One big advantage is that the same vehicle is used for most all the waste and recyclable tonnage in a single area. These united loads are isolated by special bagging and dumped on a tipping floor at the Recovery center where multiple loads are divided into dry trash, office paper, co-mingle recyclables, cardboard and flat dry waste. Wet and dry waste are processed by an auger feeds as a consistent past quality fuel stock into either a gassifier reactors, or an incinerator steam boiler with stack and scrubbers to drive turbines and generators. Along with waste to energy conversion other value added products are recovered from the waste stream and sold locally, nationally and internationally. A stationary Recovery Center is contained in a metal building structure and placed on a concrete slab, while the portable center is in modular form contained in containers and transported by road and or rail car to a permanent of temporary location for use. The invention is designed to give municipalities choices in the way they handle their waste, produce energy, use energy, develop employment from recovery manufacturing, and recapture valuable real estate from their legacy landfills.

### RELATED APPLICATIONS

This application 121148-41341US2 claims priority from U.S. Provisional Patent Application 60/503,882 filed Sep. 22, 2003 which claims priority from U.S. patent applications Ser. No. 10/693,960 filed Oct. 28, 2003 which claims priority from U.S. Provisional Application 60/421,572 which was filed Oct. 28, 2002 which claims priority from U.S. patent application Ser. No. 10/260,525 filed Oct. 1, 2002 which claims priority from U.S. Provisional Patent Applications Nos. 60/325,538 Filed Oct. 1, 2001 which claims priority from U.S. Provisional Patent Application 60/330088 filed Oct. 19, 2000 which claims priority from U.S. Provisional Patent Application 60/200,872 filed May 1, 2000 which claims priority from U.S. Provisional Patent Application 60/176,818 filed Jan., 19, 2000 which claims priority from U.S. Provisional Patent Application docket 60/139,759 filed Jun. 15, 1999 which claims priority from U.S. Provisional Patent Application No. 60/140,029 Jun. 18, 1998 which claims priority from U.S. Provisional Patent Application No. Jan. 15, 1998 This application is related to U.S. Patent Application No. 08/975,140, filed Nov. 20, 1997, and PCT Application No. PCT/US 97/21516, filed on Nov. 24, 1997, which claim priority to U.S. Provisional Patent Application No. 60/032,217 filed on Dec. 2, 1996, all of which are incorporated in the following manner to monitor and remotely control vehicles, equipment and material specifically regarding the present entitled invention “A Fiber Recovery Process To Replace The Traditional Trash Transfer Station and Landfills By Extracting Recyclables And Energy From A Joined Refuse Stream Hauled Together To A Local Separation And Redistribution Complex”; with the stipulation, that all licensing and sale of PFN/TRAC System listed as related technology is reserved and requires specific approval and or licensing from the inventor, Richard Clark Walker.

### BACKGROUND OF THE INVENTION

1. Field of the Invention

Prior art has employed the separate hauling of garbage to landfills and recycling products to MRFS or recycling operations by separate transport vehicles specific to the operation's activities. This has required two some times more trucks to handle the same geographic waste area. Residential/curbside recyclables are routed to MRFS for the separation of low-grade paper fiber products News and Card Board, plastics, metals (ferrous/non-ferrous) and glass. The invention a Recovery Process and Center provides a new and unique set of processes with automated material sensing and management for the handling of dry waste and recyclable paper in combined loads with other waste components. Either, sorted pre sorted or not sorted at all from the source. These three options are maintained to best service the various types of material sources (community of customers) and the haulers that service them.

The process (invention) begins by specifically targeting office dry trash and recycling products from their source because of costly double trucking and the fact that paper weight from this commercial source is not now well recovered, and therefore takes up valuable landfill space. The cost reduction realized includes hauling costs; dump fees and environmental impacts. The new revenues generated come from more recycled products, waste to energy conversion and sales, and because of flexible material handling modalities that better meet paying markets with the desired products when processed by the recovery center. Unique to the recovery technology the produced products in many cases are sub products requiring additional manufacturing. So making the change in component materials at this level is simpler than finished product manufacturing Also the recovery center is totally automated in its final form with the PFN/TRAC management and security System™ (Managed with robotics and remote control). The market can change and within 24 hours the Recovery center will be producing the most valuable sub-product to supply the most lucrative return e.g. paper fiber, to absorbent product, or electricity and back to paper fiber, etc.). All depending on what the market will pay. This kind of recession proofing is essential to a city that needs to guarantee its waste material handling.

The invention among other things creates a market modality incentive for trash companies to reroute some specific vehicles to handle only dry trash and waste paper together in one truck, with the separation and sorting taking place via a protected labeling and bagging and debagging process both at the source and in the recovery center. The process starts in the individual offices and is completed at the Recovery center. The initial set up requires education and cooperation from the source and the hauler. Many municipalities have their own waste disposal authority like Maryland's Northeast Maryland Waste Disposal Authority NMWDA. These quasi governmental organizations offer funding mechanisms and services like public education programs to encourage recycling. The recovery technology teaches the enlistment of these organizations after the commercial arrangements have been made with the area haulers to develop a cost effective educational program that teaches the recovery technology to the public to meet the hauler's needs and to defray the cost of such activities for all parties.

The invention employs techniques to improve hauling and handling proficiency to provide single truck recovery service for office paper, recyclables and dry trash. Then through similar modalities focuses on residential/curbside and commercial wet garbage applications like (food service). This unique waste recovery method targets the lucrative markets of office waste and commercial dry trash producers first as this is an area still land filling much of the waste paper and it is easier and faster to incorporate this process with existing trash haulers. It also provides a value added product and revenue increase from the paper fiber harvested to justify the center rapidly and satisfy banking interests. Currently MRFS are selling their low-grade recycled paper products 6,7,8,9,10 news and corrugated Card Board to mills handling their product, but these grades do not pay as well consistently as does office waste and higher grades. The automated center can up grade or degrade recyclable paper stock for specific mill acceptance and can become a local controller or certified standard to review mill shipments for desired specifications. The Recovery Center an invention of progressive automated material handling and distribution is not just for paper and other standard recyclables like MRFS).

Recovery Components for the Invention are Endless

Including but not limited to Paper Fiber, Metals, Glass, Agricultural Products, Fuel, Oils, Electricity, Building Materials, Heat and Energy.

The Invention Replaces the Need for Land fills and Transfer Stations

Traditionally major trash haulers have expanded and secured their markets by owning the local landfill and any transfer stations in an area. This has two distinct advantages for that company first they are in control of their product from cradle to grave and second their competition isn't. Meaning the competition has to pay the land fill owner higher prices to dump. And if a transfer station is needed because of the distance to the landfill, then it behooves the hauler to own that as well, so he can charge his competitor higher rates to tip his truck at the transfer station as well. For this reason only a few major waste handling companies exist in the continental US with one basically the largest.

The Recovery Center and technology (the invention) basically eliminates the need for both the transfer station and the land fill in the future. The technology can be used in part or together synergistically with all aspects of the technology taught in this specification and fall within the nature and scope of the invention, no mater how it is employed with either legacy waste handling and or recycling technology described, and is so claimed.

The Invention Reclaims Landfills

Initially, landfill requirements will lessen in the future due to the recovery technology (the invention The Recovery Center). Not only bulk but the weight of waste requiring storage in a land fill will be diminished in volume by the recovery process in an exponential manner. Additionally, future final waste products that require landfill storage will be compressed or reduced through waste to energy techniques and hydraulic compaction taught in the specification so as to require less space, less time to become stable and will meet build on compaction standards never before envisioned for landfill sites.

Because of rapid consumption of waste that the recovery process (the invention via multiple centers) will be able to handle, the mining of old existing landfills will be targeted to stop the leaching of toxins into the aquifers and to recapture valuable land as well as energy and recyclables. Due to the advent of plastic bags and land fill baling of waste and garbage much of the waste is packaged so tightly that it is not deteriorating in an anaerobic state. Therefore, it is a ticking time bomb, but also well preserved. Special recovery centers would be brought in and set up to rework these sites and mine them for recoverable and recyclable materials as well as, recapture the landscape previously marred by the legacy technology of land filling or burring trash. For this reason the inventors wish to see government and cities license the technology as they stand to gain the greatest return for the citizens they claim to protect and serve. However, responsible industry has a tremendous opportunity to generate massive corporate profits and do the right thing by providing a complete service for the community using this invention. (Business=providing a service (ME definition)).

This recovery Center invention is a combination of numerous technologies taught here to be operated synergistically to conserve energy and produce sub products rather than just transport and store waste material. The process is made most efficient via the PFN/TRAC management system that gives flexible equipment and material control for numerous types of production to meet market demand for individual products on a daily basis. This proficient use of waste material to manufacture value added products can reseed job markets where they are most needed, in the waste lands of cities in the Northeast and Midwestern United States. And through the proficient handling of the nation's waste Homeland Security is provided a state of the art portable sensing network with remote control interdiction, where no other industry or government has proposed a unified security technology for transportation.

### BRIEF DESCRIPTION OF DRAWINGS

FIG. 1 The Routing & Recovery process

FIG. 2 Plant Configuration

FIG. 3 Basic Recovery Center Architecture

FIG. 4 Window's Plant Depiction

FIG. 5 Graphic for Equipment Location

FIG. 6 Clamp Machine in Plant

FIG. 7 Window Display of Clamp Machine

FIG. 8 Plant Graphic Of All Operating Equipment

FIG. 9 IT Connections with Control Center

FIG. 10 Smaller Debagging Machine

FIG. 11 Bags For Joined Handling

FIG. 12 Plant equipment Display

FIG. 13 In Feed to Mass Bagger

FIG. 14 Top View of Mass Bagger and Sorting Belt

FIG. 15 Side View of Mass Bagger

FIG. 16 Mass Bagger Chamber Function

FIG. 17 Variation On Mass Bagger Functions

FIG. 18 A Bag Design

FIG. 19 A Bag Design

FIG. 20 Sorting belt and Jogger System

FIG. 21 Windows Display Of The Jogger Belt

FIG. 22 PFN/TRAC System On A Vehicle

FIG. 23 Windows Graphic Of The vehicle (Real-time Data0

FIG. 24 Inner-Modal Web of Transport equipment

FIG. 25 Windows Display For Roll Off Container Truck

FIG. 26 The PFN Unit General ASIC

FIG. 27 TRAC/FACT Electronic Architecture

FIG. 28 PFN/TRAC/FACT Connection For Homeland Security

FIG. 29 PFN/TRAC Scan &Repeat Function with Multiple Wireless

FIG. 30 PFN/TRAC Fact Connect Network for Homeland Security

FIG. 31 PFN/TRAC System Connection for The Recovery Center

FIG. 32 Personal PFN Repeating Capacity

FIG. 33 Commercial Quick Connect For Public Safety Frequencies

FIG. 34 Windows Geographic Asset Display of Vehicle Operations

FIG. 35 Further Asset Display Information

FIG. 36 Bag Slicer and Trommel

FIG. 37 Waste Preparation For Waste to Energy

FIG. 38 Gasification Process

FIG. 39 Power Produced From 10 Gassifiers and Turbine Electric

FIG. 40 Square Foot Location Grid of Plant with gassifiers

FIG. 41 Duplication of Plant Layout with Gassifiers

FIG. 42 Introduction of Synergistic Technology (Absorbents)

FIG. 43 Absorbent Process another Invention (121148-PSW02)

FIG. 44 Absorbent Process another Invention (121148-PSW02)

FIG. 45 Absorbent Process another Invention (121148-PSW02)

FIG. 46 Absorbent Process another Invention (121148-PSW02)

FIG. 47 Absorbent Process another Invention (121148-PSW02)

FIG. 48 Absorbent Process another Invention (121148-PSW02)

FIG. 49 Absorbent Process another Invention (121148-PSW02)

FIG. 50 Window Format of Total Plant Production

FIG. 51 BRC Building

FIG. 52 BRC Building renewal

FIG. 53 Recovery Community Center

### DESCRIPTION OF THE DRAWINGS

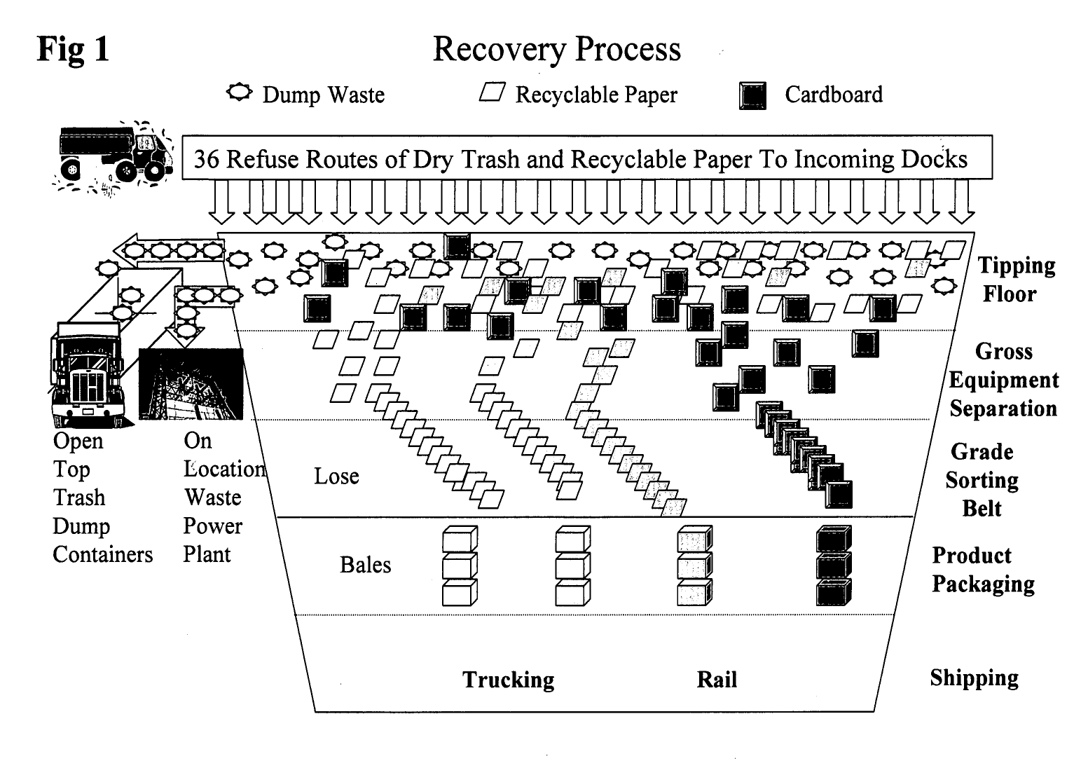

FIG. 1

Dry waste from office buildings is discussed first as the initial progression to redirect the hauling process just a little to quickly yield value added paper fiber. At the point of origin, this invention provides special plastic and paper bag separation containments to transport and process more easily recyclable paper products in dry trash and semi-wet garbage streams transported in a single truck. In the recovery center the bags are recognized in a gross sort by machine operators and personnel initially and progressively by special debagging machines. The over all flow is illustrated in the first figure

Figure one is an illustration of the recovery process. Three types of materials are identified at the top of the figure, dump waste, recyclable paper and cardboard. Different patterns as well as colors are used to indicate different grades of paper. The top of the page shows 36 trash trucks that are strategically routed to pickup dry waste and paper only. Office waste is a desired product for some paper mills and they can handle all types of paper except news and cardboard in their mix. Because of new mill technology negative sorting can be employed in the recovery center to extract only the most detrimental contaminants like copier ink cartridges that can damage a batch of pulp.

Basically, routes servicing office buildings in a city are to be isolated from wet garbage producers like residential customers and restaurants. This is a new capacity within the millworks and this new recovery process specifically provides correct mixes of material or straight paper to market high quality recyclable fiber for this new application. Customized routing is part of the invention. Further separation of paper is accomplished uniquely via special bagging of paper only in either paper bags (with windows) or clear plastic bags. The trash is picked up with the bagged paper and the bagged paper is compressed in the compactor but does not separate and mingle. Nor do the bags pop or dump their components. This unique observation of plastic bags in waste streams is the basis for this facet of the invention. This removes the need for offices to have boxes and separate pickups for recycling and for the regular dry office trash.

Down below the trash trucks on the page is the tipping floor (generally for a large city at least 1-1¼ of an acre under roof) where the trash, cardboard and bagged office waste as well as lose paper and garbage is dropped and spread for identification and separation via material handling equipment 1.e. Skid loaders Clamps and Articulating loaders. This gross equipment separation pushes the materials on to a separation screen that transports the cardboard as well as flats Dry wall and ply wood, etc away in one direction and allows the lose paper and garbage to fall through the screening rotating disks. Closer rotating wheels carry clear bagged office waste is carried in another direction. The bagged paper goes to a debagger and the dry waste to a boiler or gassifiers depending on the requirements of the municipality. And unworkable waste is transported by belt to an open top container for landfill storage. This is only for the first phase of the recovery center. Each phase eliminates more and more recoverable tonnage from final disposition in a land fill.

To the left of the tipping floor any trash is processed to an open top container and or the alternative waste to energy technology. Waste can generate steam for steam turbine generators and or be gasified to run internal combustion engines/natural gas engines, or turbine power plants to generate electricity. In either case the materials are hogged and prepared as fuel stock to power either or both of the processes depending on the community. The invention is designed to give municipalities choices in the way they handle their waste, produce energy, use energy and produce more employment locally through recovery manufacturing. And to allow these same municipalities to reclaim real estate that presently house legacy landfills.

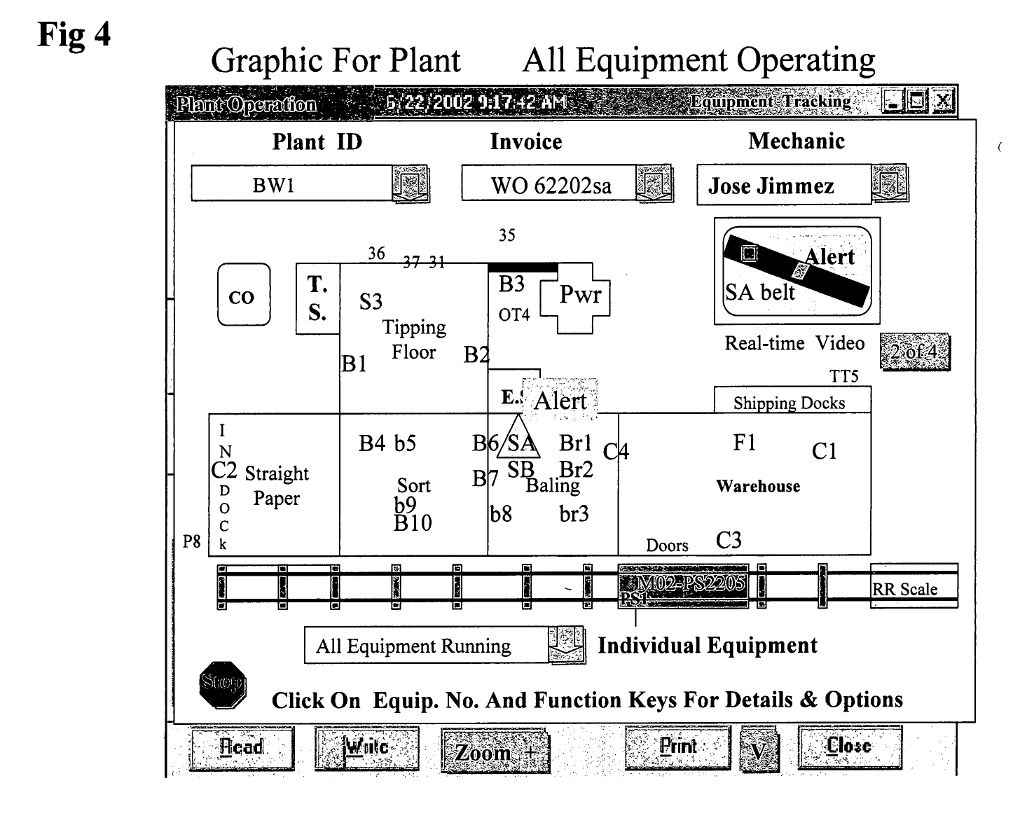

Loose paper is handled but a great deal of it is converted to electricity rather than being recycled as paper fiber at this point if it is dispersed. The bagged paper enhances the sorting process greatly and it is a simpler more efficient method than what is in use today to recycle office paper. The paper debagging process is more detailed in FIG. 4.

Due to new HIPPA legislation in the health care industry and the general protection needed for identity theft a new boost to separate handling of recyclable paper has sprung up. The waste material handling term is Document Destruction and involves insuring the customer that their sensitive waste and throw away data is not available to others. To handle Document Destruction the customer has a number of options depending on their needs. They can have special locked containers at their desks or centrally located in their office. They can have a security container locked and specially operated compaction and lock where only the center can open and unload the material. Special marked bags track the material through the processes and is posted on a customer website. Where the customer can print their own certificate of destruction as the material is destroyed. Or for the highest security the customer can have the document destroyed before their eyes and then compressed in a compaction truck sent around just for this purpose.

Returning to FIG. 1 the debagged lose paper travels over a series of sorting belts described in figure two and directly to the packaging process where it is baled. In some cases the paper is simply packed into a trailer loosely by a skid loader for trailer dumping at the mill. Or loaded on a walking bed trailer or loaded by forklift clamp machine as bales.

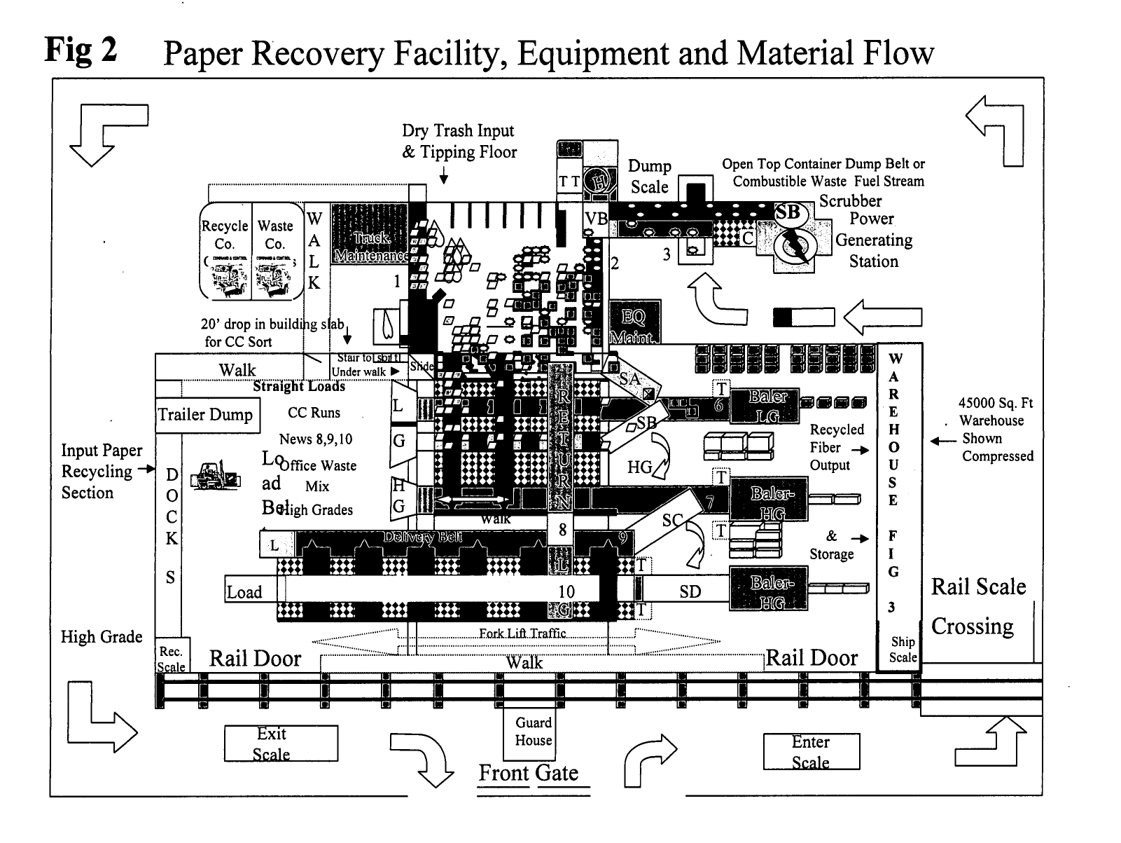

Shipping is by truck and rail service and the appropriate docking and road bed as well as product accounting is provided and detailed in figure two. This drawing illustrates the general flow of materials. FIG. 2 and the majority of the illustrations give description of the technology for a permanent or stationary plant The portable modular plant uses the same technology with the exception it is made in containers for mobile transport.

FIG. 2

The broad arrows indicate the traffic flow in and around the facility. Automotive platforms enter lower center right and pass over the entrance scale, which is electronically connected to the local scale house in the corner of the building. Additionally connected are the recycle company and or refuse company in the upper Left building in this figure. Wireless PFN units in the vehicles deliver load and route identifier information (customer data, truck number and driver information, etc.) to all locations. Sensed data; weights, type of waste or paper carried are down loaded as electronic invoice from the vehicle for the company doing business. This includes hazmat or vehicle alerts if such an event occurs during transport. Vehicle alerts are also transmitted to the Truck Maintenance Center (top center left) and any first responders if applicable.

Refuse vehicles carrying combined dry waste products and recyclable paper enter and circle around 180 degrees to the tipping floor (top center) then back in and drop their mixed loads of dry waste and paper. Straight paper loads circle are 240 degrees around to the straight paper input docks. All empty vehicles are scaled and weights are compared. New vehicles are assigned their tare weight and retuning vehicles have their weight compared to their electronic files stored in the tracking computer (PFN/TRAC System mass data and unit memory).

Note the PFN TRAC units in the vehicles are interfaced with the trucks E/E system and can report on fuel level, hydraulic oil levels, extra water or cleaning tank levels and any other weight fluctuation's.

Note: The related technology (The PFN/TRAC System) is well documented in the related patents and pending filings however, other electronic technologies could be utilize to do many of the same applications and therefore fall within the nature and scope of the invention if so applied.

Open top trailers after weigh in (tare weight taken/or on e-file), proceed around to the power generating plant (upper right) and turn in and on to the dump scale (left of power plant) to be filled from an overhead waste delivery belt, (Belt system 3). This overhead belt system first delivers dry combustible fuels to the on-sight stream power generating plant and a hogger and auger grinds up wet waste to be mixed the dry waste for the optimum BTU out put. This is done for both gasification and incineration. The mixing is monitored by sensors, video cameras, and software programs running in the control center at the power station. Excess and or noncombustible dry waste is loaded in to the open top trailers for delivery to the landfill or sold to other recycle and recovery applications. This process reduces or eliminates the need for outside electrical power to operate the facility further reducing Recovery Center cost. There is savings on fuel, wear and tear on vehicles, and less labor time to process the same volume of waste picked up.

Top Center.

Belt system 3 is fed by two sources. One is belt system two running on the right wall of the tipping room floor that delivers waste to a vertical ladder belt marked (VB) in the shaded square. On the back side of the vertical ladder belt is a hogger machined or grinder that chunks up the waste in 8″ pieces. The hogger gets it's material from the trash truck parked on the side marked (TT). Old carpet and furniture etc. are filled into the into the Trash vehicle or container and periodically compacted to break it up. Then the truck pulls straight out lifts the back door or rear loader section over the ground level hopper that slowly carries the waste into the hogger via a short delivery belt. This chunked waste can be routed to the incinerator/gassifier or to the open top trailer and the landfill depending on the material and products being processed by the Recovery Center.

Important Point

Landfills prior to this technology have been thought of as final resting places for the waste that society no longer wants. This invention introduces the use of a landfill as a temporary storage facility to hold recoverable waste product in a safe and stable manner until it is needed or found usable again either as a recyclable or recoverable sub-product to produce energy or for manufacturing. This fact changes the whole out look on dumps and landfills of the past. As stated earlier the Waste Haulers, Document Destroyers and recyclers have not taken a broad enough approach to date to meet most cities needs. Therefore the inventors look to municipalities and government to learn and license this intellectual property and revitalize their real estate, and populous through a quality clean up technology that yields, greater employment, adds revenue, and improves community services and pride in how the city handles its waste products.

TOP Center Tipping Floor

The trash trucks come from local routes after scaling in and proceed 180 degrees to the top center. They back in and dump their loads on to the floor under a 35 foot ceiling. Then they proceed around another 180 degrees to the exit scale and are weighed out against their recorded tare weight. Fluid sensors on the truck report levels and weight data to the vehicle PFN controller and the wireless link reports this data to the scale receiver PFN where software computes the data and records it as well as flags any anomalies. This is done for security as well. And the data is sent up stairs to the control rooms for the center. All vehicles are weighed quickly via an automated traffic light and wireless communication system controlled by the PFN/TRAC Management System. Data is recorded in an electronic file and mass data storage in the center control room and any other companies and or government agencies responsible for regulating any activities performed by the Recovery Center. This way all weight is accounted for in real-time for incoming and outgoing movement. This is done for the rail service as well at the rail crossing scale (lower front and right).

Separate Paper

Straight loads of recyclable paper weigh in and circle around 240 degrees to the paper recycling section. Here various haulers, recyclers and MRFs can bring straight loads of paper for sale and for further processing and proper preparation to market to specific mill specifications. The manual and automated mixing of paper to mill specifications can be made exact and a way for mills to insure they are getting the paper they need to produce their special paper products. Lon term contracts with mills are part of the technology to maintain a continual business for both the mill and The Recovery Center.

A historical tension between paper mils and refuse haulers that are recently developing recycle operations is to send the minimal grade of paper to the mill and classify it for the highest price by claiming the paper packed in a bale is a higher grade. Additionally, the paper market has always suffered unpredictable ups and downs in the value of paper. So when there is to much paper available the mills stick it to the haulers and packers (balers) by paying very little and when there are shortages the haulers and packers hold out for the highest price they can receive. Another tension is the need for paper overseas. When the need is great as it is today due to the industrial growth of China paper shortages become a great threat to domestic mills so they look forward to long term deals with floor numbers and ceiling limits for what they must pay per ton.

Once again with the industry and the market place left entirely on it's own this has caused both mills and recyclers to go out of business with great losses to communities and individuals. However, with Recovery Center Technology this Is not the case. The invention is designed to flexibly change production to the most lucrative product or to meet market demands and or keep economic and or environmental stability between virgin source products and recyclable products like paper fiber pulp to wood fiber for pulp. Whether The Recovery Center is licensed and owned by government, a municipality or a city, the public so to speak or privately licensed owned and operated, it has been conceived to serve the waste needs of a community and be a harmonious technology to better quality of life. The stability in essential market places like utilities and waste handling are the glue that allow communities to be strong infinite economies and creative when the economy is expanding. This invention is designed to bridge those gaps, so it is important for whom ever licenses and practices this technology is mindful of this value individually, corporately, and communally.

Top Center Tipping Floor

Is the beginning of the dry refuse reclamation process. Waste paper, corrugated and combustible materials are separated by spreading the load out on the floor and pushing the card board to the number (2) all the clear plastic bags of office waste to belt (3) running down the left side of the tipping floor wall. The throw outs like carpet are pushed to the TT truck or container. The rotating disk screens or wheels catch cardboard and flat items like drywall and push them along to the left while the space between the wheels and drive shafts allows the smaller waste to pass through into the pit. Where there is another belt that remove the waste to the hogger auger, waste to energy belt and or the open top trailer that hauls unrecoverable waste at this time to the landfill for temporary storage

On the Floor

Trash trucks tip their loads of transparent bagged waste paper (Office Paper) cardboard and trash. The compressed bagged paper is pushed onto a floor conveyor Belt (1) which transports the bags of paper into the debagger machine marked (BM on the left wall of the tipping floor). The debagging process is explained in Figure four and there are numerous de bagging machines taught in this specification depending on the application and amount of bags to be handled.

The bag is stripped from the paper and the paper is further transported to a sliding board, which dumps the paper onto the dual jogger feed belt under corrugated screen conveyor system across the front of the tipping floor. One, two or three sorting belts can be fed by the jogger belt and the speed of all belts are controlled automatically by an electric eyes and preprogrammed controllers to deliver a continual even material flow to picker stations (Either human or automated). Also the use of a trammel can be placed in this process and the rotation of the drum will achieve the same thing as the jogger belt for even flow.

The corrugated screen and conveyor system runs across the front of the tipping floor and delivers separated cardboard onto a lower conveyor feeding the Low Grade Baler marked (LG) located in the shipping and storage warehouse.

In the case where there is a lot of flat construction waste and drywall the baler would be replaced with an additional separation and sort area to minimally clean the card board and send out the construction materials sorted, or unsorted to another material handling operation, or dump, depending on the quality and quantity of any specific material.

Bales of corrugated cardboard are stored just above the LG baler. However sufficient docks and trailers (out to the right) are available to load all daily production. Clamp Forklifts grab the bales and either load them into trailers or stick them in the storage warehouse.

Another modality has the baler push the bales all the way into a waiting trailer on an elevator platform. The Docks and trailers will have dock scales (embedded-axle type) and or wheel sensors (wireless tire pressure comparators) to reliably check, verify loads for proper weight and position not to exceed legal limits, for security against theft, commercial analysis, and for general accounting and billing purposes. The data can be provided in real-time to the Recovery Center, Trash operation, Paper recycler, and government regulatory agencies as well as mobile units as desired via the PFN/TRAC Control System and Repeating Station.

Sorting Belts

At the center left deliver the mixed recyclable paper from the tipping floor jogger to two low grade belts from as many as 12 sorting stations to cover all the office waste options to accommodate the majority of paper mills not able to handle a mixed office waste. For mills that can process multiple office waste paper the belts dump all paper and just sort for a minimal contaminant. At the end of the two Sorting belts are picker slides for high grade material or a return belt drop for further sorting.

The Tipping Floor

On the right wall also has a corrugated screen conveyor with delivering cardboard to the right front corner for transfer to the LG baler, but its lower belt catches all the dry trash and transports it back to the Vertical ladder belt (VB) in the front right corner of the building and raises it up half the wall height (17 feet)(tipping Floor roof 35 Ft.) to a horizontal belt system that feeds combustible dry refuse to a fuel hopper for the boiler marked (SB) in the Power Generating Station (the T shaped building in the upper right). If a community will not allow any more smoke stacks even with scrubbers, The Recovery Center uses gasification as a modular replacement technology to generate electrical power. An additional drawing similar to FIG. 2 shows the plant with gassifiers.

In either case rejected or excess Dry trash is dropped into an open top trailer via an automated trailer advance and loading system. It uses video camera a software algorithm electric eye and preprogramming along with wheel sensors and embedded truck scale to insure proper loads and record any waste sent to land fills. There is a monitor and operator or manual override above on the final sort station to the power plant. The data is delivered to all control stations and mobile units and displayed in windows format with stream video and graphics where applicable and as needed.

After an open top trailer is filled it pulls off the scale and circles left 180 degrees and passes over the exit scale for a second stop and final weight check before exiting the facility to the right.

Security and operations are linked via a plant video system delivering real-time images and data generated from PFNTRAC units through wireless communications to a secure encrypted Intranet servicing the entire operation (invention) to include the facility, materials and transport vehicles at all times.

The Paper Recycling Operation (High Grades and Straight Loads)

Are at the left of the drawing and the input area has docks and a trailer tipping station. Many trucks from different companies will be delivering their straight loads of paper to this area. The trailer tipping station is for lose loads from area MRFs desirous of further processing and or baling of the product. At the docks paper is removed by fork lifts and clamp machines that weigh their loads via automatic hydraulic sensors and send this data along with the appropriate identifier data to the control centers for matching with entry scale weights.

Straight Belt Loading

Of lose material is done via skid loaders/clamps straight on to the low grade belt marked (LG) for straight through baling (card board, News, Office Waste, etc.). Trusted baled product is driven straight to the dock storage area or loaded on an appropriate trailer (down in front and to the right). Any load determined contaminated or difficult to process is degraded and sent around to the scales to be reweighed/video filed stored(digital image for E-mail in part or whole and sent back around to the tipping floor to be processed as a dry trash load.

High Grade Processing

Starts down in the left front and runs to the right with two sorting bins on the left. These paper piles are empted and loaded on to the two belts to the left (one labeled HG the other G) by skid steer to make specific high grade packaged products. Mostly clean material is loaded left on to the front left high grade belt and picked clean for other high grade paper products with a final contaminant removal at the return belt just before dropping to the High grade baler the contaminants or low grade paper product is sent back to the tipping floor for sorting or trashing This figure is an approximation. The configuration can change to meet the parameters of a building structure or size of operation and still remain with in the nature and scope of the invention, Additionally not all functions need be present at any one time and the full development of the recovery facility may be progressive per need and financial resource.

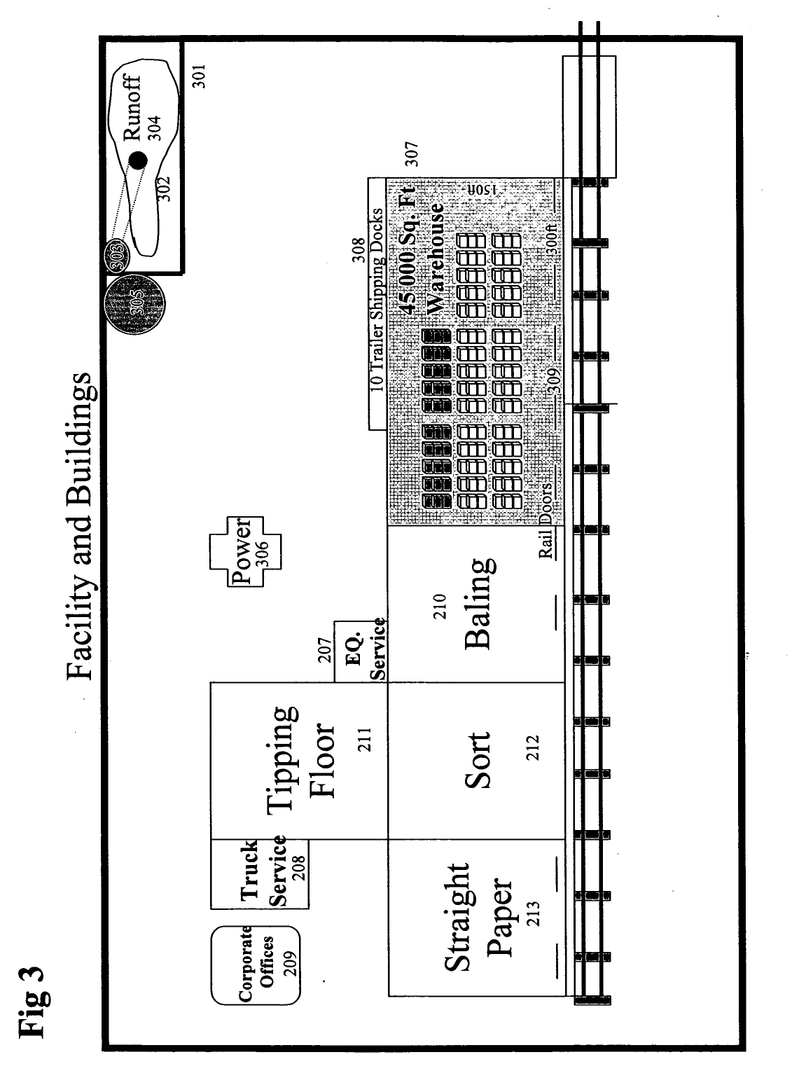

FIG. 3

Facility Buildings and Flow:

This paper recovery Center in this teaching is modeled on 8,500 ton a month of dry trash and paper mix, both carried in the same trash recovery vehicle. The facility is planed for 6 to 12 acres to progress from 8500 to 27000 ton a month, however the facility can be larger or smaller per the projected volume and anyone skilled in the art of engineering could make the changes necessary.

In the figure the Black line is a perimeter fence that has video and sensing technology to protect the public and secure the facility. The ground has sensors and receiving ponds to collect runoff and there are sensors to report on toxins from hazardous waste and standard leachate if not caught and processed into clean water and byproducts. These environmental sensors report to both corporate offices and security as well as, community first responders for public safety hazard awareness. 301 is an enclosure fence to allow for the drainage from the total complex to be retained in a rubber lined runoff pond monitored there and processed in 303 for separation and extraction for proper handling.

Surfaces oils are skimmed and barreled, sediment is collected in the pond an periodically hauled off for appropriate handling if not within the purview of plant operations. Water is filtered treated and used in the power plants boilers, where it is reclaimed in a closed system or further purified and returned to the environment. 302 is a 1 foot thick double wall waterproof pond liner (rubber/plastic) with embedded sensors to monitor ph acidity/alkaline, bio and chemical hazard levels and water volume with pocket elevation siphons to draw off contaminants at their specific gravity on a continual basses to holding tanks for further processing. 304 is a stands pipe to handle pond level and control the flow to the processing unit 303. Electrical power for the pumps in the processing plant 303 is supplied by the facility power plant 306. 305 is a pressure bladder or elevated reserve for gray water applications like plant fire sprinklers, truck and equipment wash systems and paper processing sprays for paper dust control and tighter better compressed bales and for the correct past consistency of garbage and waste fuel for the incinerators and gassifiers. 307 is a 45,000 square foot ware house for the storage of bale and paper fiber as well as value added products made on location like absorbents, kitty liter. All buildings will vary in size as per volume and type of waste stream in a particular municipality or institution. 308 are covered shipping docks for tractor trailers hauling bailed paper to the mills. The amount of docks will also vary for the volume of waste in the area. At the bottom 309 a number of dashes represent ware house doors to access box cars on the rails along the entire facility. 210 is the bailing section designed with 3 bailers to handle the 8500 ton and additional high grade paper recycling as well as, the volume of area haulers and recyclers needing to process their paper collections to meet mill standards. This section is discussed in detail in figure two as are the tipping floor 211, Sorting belt section 212 and straight paper receiving area 213. 207 is the Plant equipment service area and 208 is the over the road truck maintenance building.

FIG. 4

Windows Graphic for all Plant Equipment

There will be a number of figures detailing the software graphics that programmers and code writers will develop from developer kits provided by Ms Windows and other manufacturers that have already set up their data in to these formats. The commercial off the shelf operating systems used in the PFN relay stations will operate on Windows and Unix and special PFN/TRAC translation software will interface the data.

Figure four is the graphic for the facility and buildings in a windows format. Provided is the real-time position of all running equipment and personnel. The upper right hand corner has a miniature real-time preview of a trouble area in the plant. SA is swing belt (A) carrying the corrugated card board from the tipping floor screen to baler one. The viewer can click on the alerts either in the graphic or on the preview screen to enlarge the real time video and or click the number key next to the word video. This allows the viewer to enlarge the preview and or switch to any PFN interfaced camera reporting proximity views of the SA belt via software confirmation communication algorithms running in the various equipment PFNs and Video PFN units or system interfaces.

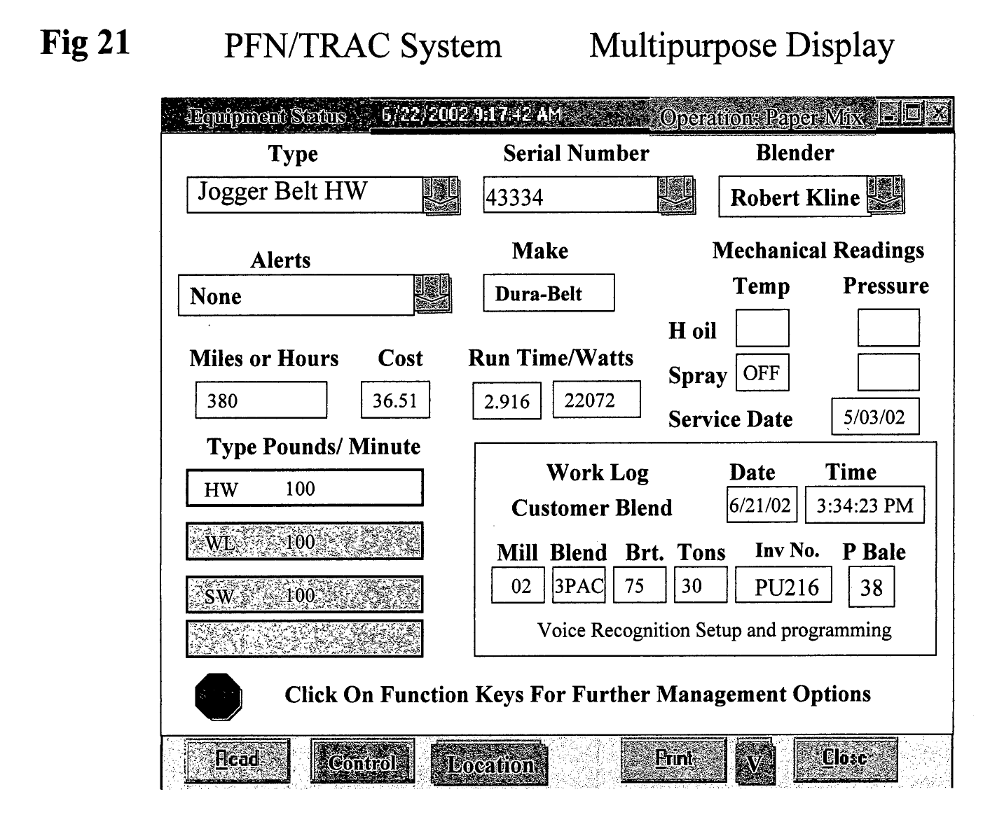

In FIG. 21 there is a description of the hard ware and software planed for the PFN/TRAC system and the application Specific Circuit or PFN ASIC interfaced to each piece of equipment. A generic windows program is modified as is displayed in figure four and because this is the first introduction to this application it will be used to describe the program.

The plant is designed to progress from man and machine shared control scenarios to more preprogrammed and robotics reducing the risk to personnel and increasing proficiency. The top gray border displays the location date, time and function of the operating equipment with all standard windows options to enlarge shrink, browse, switch to and or close the window. Directly below the Header is the equipment identification in this case the plant itself (Baltimore Washington 1) or BW1. Location is being used in the plant identity for the matching of recyclable products with mills that use them and for the final depository or second manufacturer, that can handle the waste by products and or by products for recycle or remanufacture. Next to the equipment Identification Window the viewer can call up any piece of equipment in the plant at the present time and all pieces of equipment are shown by their alpha numeric assignments on the plant operational graphic or pull down window. The viewer can click on any one via the specific window for the equipment and the data will be displayed with all real-time reported data being sent from the PFN ASICS on board the equipment. In and around the plant the information is sent by Dedicated Short Range Communications or DSRC wireless in the 5 Ghz range or 912 mhz.

Any specific frequencies can be assigned or used and they all within the nature and scope of the invention, as does any reconfiguration of the graphics done by those skilled in the art. The PFN/TRAC System™ and technology is well explained in 14 related patents and protected writings and only information provided in this application is to provide teachings and modality for those skilled in the arts to use in the construction of this invention a paper recovery plant powered by waste material and gray water (a environmental protective alternative to the present Trash Transfer Stations and landfills.

The invoice box in this case refers to the alert status of the swing Belt being down and the mechanic Jose Jimmez is on the repair. The viewer has the option to click on the down arrows on these boxes and pull up more work orders (WO classification of the invoice) or even jobs being handled in the plant for different mills or manufacturers receiving recycled materials from the dry waste stream. Likewise the down arrow next to the mechanic allows the viewer to pull up other mechanics and employees and to click on them and see their window of activities and location. The viewer also has capability to communicate with the person by audio and see them by any number of PFN controlled video cams reporting visual contact with the individual.

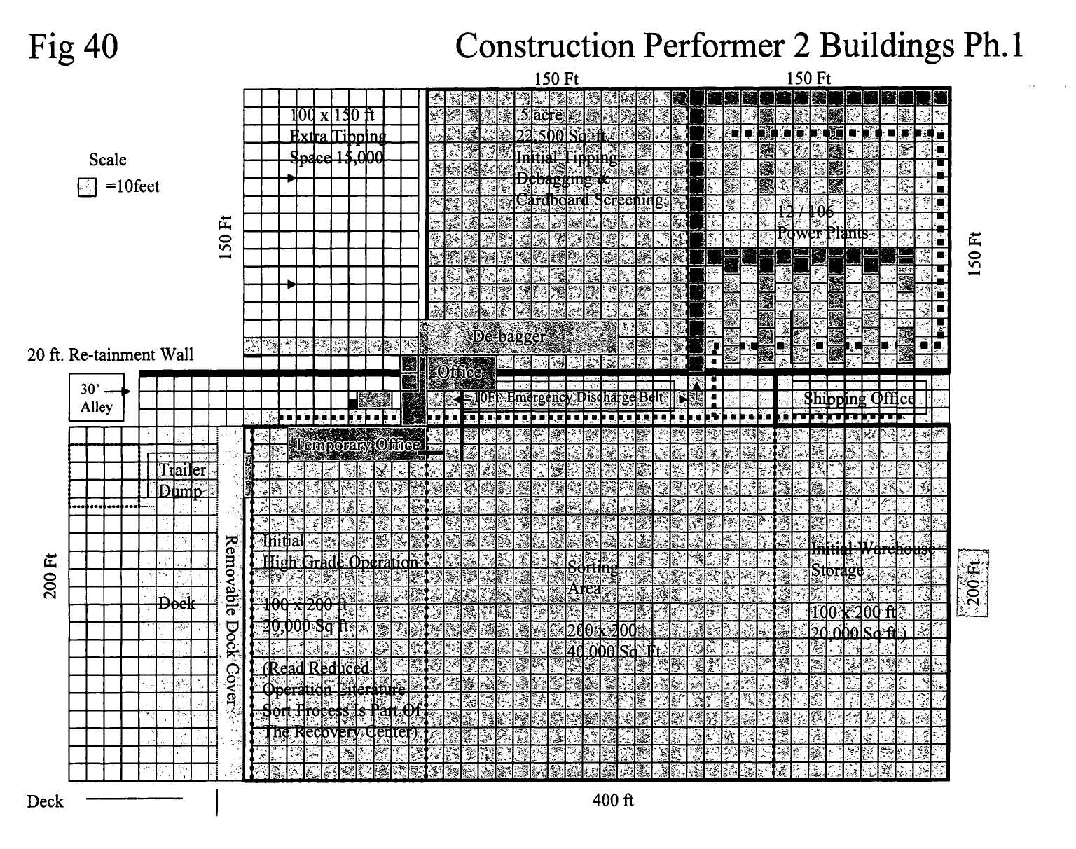

This is possible because all employees are wearing a 1P personal PFN unit and these units have a universal emergency stop button for all equipment running around them. Danger zones are calculated written into the software of the equipment PFNs and can be seen on a calibrated map in the control center of the facility as shown in the figure display and changed from time to time by reprogramming for plant changes. A sensor grid map is shown in FIG. 40 to indicate personnel and equipment in these danger zones and are factored in as part of an algorithm running in all mobile and stationary equipment PFNS. Any moving equipment, person or RFID material is recognized as part of a sensing web monitoring 1P personal PFN movement and Equipment PFN and material movement to include a PFN controller video recognition algorithm for PFN human and or thermal recognition sensing to locate presence in any danger zone before any completed operation by the equipment can be completed. Integrity checks of all sensors; infrared, electric eyes, video and descretes are all employed.

One example of the safety function is that any person within the safe operation circle of a piece of equipment can hit their PFN stop button and shut down that piece of equipment or those pieces of equipment affected by their close presence (This feature used on any other wireless equipment controls is considered to fall within the nature and scope of the PFN innovations and infringement if not legitimately licensed by PFN/TRAC System inventor Richard C Walker)

Location Technology

All equipment have PFN/TRAC controller/routers attached to their electrical/electronics systems (E/E). These PFN units have GPS receivers that receive data from global positioning satellites for exact time and geographic location (This is more important to the SV1 automotive applications to keep tract of the refuse vehicles in and around the city). The building is constructed to allow for these signals to penetrate the roof structure and where signal is compromised stationary equipment units have extern extended antenna through the roof and run a triangulation software algorithm computing mobile wireless signal position, which is then passed to through the system/corporate offices, maintenance and security. IP connections further deliver the same data to off location computer systems first responders and mobile units in the event of an emergency so all individuals are receiving the same data and images to coordinate their efforts. Planned procedures have to be formatted into protocols involving standards effort s with all stake holders for emergency event scenarios to be both written into code for PFN/TRAC System software and to develop the practice lessons for all responding people lean their functions.

The plant is designed progressively to go from a more labor intense operation to a more preprogrammed, remote control and robotics operation, both to protect and reduce humans at risk. Additionally, the sensor web is to detect hazardous and dangerous waste and toxins throughout the process to compliment and serve home land security and public safety. For this reason the advanced security is more vigilant at detecting these hazards and automatically alerting the proper authorities as well as protecting the work force from exposure hazardous toxins. Figure fourteen details a radiation detection modality designed for use in US ports, which is an intricate part of the PFN/TRAC security System™. It is design to alert officials to a container truck carrying a radioactive source at an alert level to public safety.

The recovery Center is designed to serve an important function for a city's security by monitoring the waste generated in that city. Because, the Recovery Center technology is set up to recover 90 to 100% of a cities waste stream process it and redistribute it via state of the art automation, the invention once again improves on the past industrial waste material handling techniques. The Center embraces working closely with all government regulatory agencies unlike the industry of the past where waste and recycling companies were cited for major EPA violations, as well as, their industrial customers when ever they were caught. The new technology will identify the hazardous material and track it better as well as provide improved processing to handle and reclaim the materials all the way down to the elemental level. And as technical advancements like DNA has helped solve crimes of the past so will the new Recovery technology. As the Invention numerous Recovery Centers reclaim and debris the landfills of the past they will unearth the buried crimes of past dumping to include individual capital crimes and corporate improprieties, that have damaged the environment that must sustain all of humanity. For this reason the inventors wish to see government and cities license the technology as they stand to gain the greatest return for the citizens they claim to protect and serve.

The relevancy in the recovery plant to this application is that the energy made to operate the plant will in part or wholely come from a power plant converting combustible waste to electricity via incineration to steam or gasification. This provides the opportunity to handle medical waste via incineration/gassification and the detection of gama radiation will be essential. Additionally, the paper recovery process will ship over seas by container and use containers that may have been contaminated from some earlier shipment. The plant has been configured as part of a movement management and security system that communicates with a government matrix of home land security Intranets as an example of all current and future industry development to extend our border security efforts internally and externally.

The PFN/TRAC system with FACT Security is the kind of vigilant homeland security the United States needs. PFN means Primary Focal node for wireless and machine messaging. TRAC is Trusted Remote Activity Controller for accountable remote control and communication routing. FACT stands for Federal Access Control Technology and provides a first responder matrix with critical data and information for an emergency event and a national security network of data mining service to assess material utilization and equipment use and movement. The PFN/TRAC system of security and equipment management reaches far past the waste industry, but is an instrumental part of how a city handles material movement and invaluable to set up a portable sensor network that delivers same data simultaneously to multiple levels of government and industry in real-time, with the real-time option to control that material movement or condition via remote control, robotics and or preprogrammed automation.

The buildings in the plant facility in FIG. 4 are identified identical to the lay out in figure two of the plant and facility. This allows for a quick reference to the viewer to locate all operating equipment and all trouble spots in the plant. Trash pick up trucks are represented by straight numbers. Plant equipment and over the road shipping vehicles are represented by capital letters and a number if they are in plant operation and they have a small case letter and number if they are reporting location and that they are inactive at this moment. On the rails below is a rail car with a PS1 load sensor suite periodically reporting it's load status and location is assigned by the PFN GPS equipped units loading the Rail car such as a forklift. The rail scale will weigh the final load and report it to corporate control and the PS1 reporting sensor suite will be updated with the data to include the invoice, mill zero two Paper Shipment 2205 M02-PS2205. The PS1 sensor reporting goes into sleep mode until a hand shake contact from the RR PFNS and or mill reporting system queries the unit and down loads the data and confirms receiving the material upon arrival at the mill. The PS1 can be used with RFID and or barcode technology or separately (RFID is radio frequency Identification technology manufactured by Texas instruments).

Additionally, sensing capacity in the PS1 is application specific. Much will depend on the level of security required to operate a safe rail system. The PS1 records location for local PFNS supporting GPS and PS1s will down load an archive file when requested. Security check points can be programmed at the facility and alerts or alarms generated when a travel flag occurs (an altered location from manifest or unauthorized entry to load). The PFN/TRAC System network with embedded units on various buildings and prime movers like trucks, trains and material handling equipment will receive and route any alert signal to control via wireless gateways to commercial telephony, ISP and high speed internet connections via IP protocols with application specific encryption. (PS1 PFNs are basically powered by battery and they were designed for personal carrying, however applications like rail freight cars do not have power, nor do shipping containers so batteries and solar systems need to be used in many cases or shake and or movement electric generators, where there are no other power supplies). PS1 in other related filings have specific series or model number e.g. HS1 is a mini PS1 wireless Homeland Security sensor suite that sends alert signals to E1 or equipment PFN repeater stations, which further distribute the data as to their preprogrammed routing of such data.

Returning to Recovery Center Applications

The individual equipment window allows for instant access to review all equipment windows for status report and to give remote commands or to send reprogram data to the E-PFN. The stop button for the plant will initiate the shut down sequence of the plant and send it into emergency mode and evacuation. This button on the other equipment windows will stop the equipment immediately or set up a shut down sequence with increasing control over the remote piece of equipment. There are security clearances that are individual for accountability and the need to set up protocols for the use of this function will require an on going evaluation process that also addresses Homeland Security. Much of this is well detailed in the incorporated 14 related patent filings.

The function Keys allows the viewer to read real-time data and update any cashe files if the data is suspect. The write key allows for reprogramming or editing however, all such entries require identification of viewer and equipment during communication. Video images or data text on secondary windows can be enlarged with the zoom key. The data can be captured for hard copy by sending it to a printer and a printer option window will allow the viewer to send the data to a distant printer or capture it as a PDF file and e-mail it to an address.

The V Key brings up the Video cam sequencer as a screen saver security function. The secondary video window will display all video cams in a thumbnail and text ID format for the viewer to review and click on for a desired cam shot. The opening video cam sequencer program is also to serve a progressive Artificial Intelligence (AI) function through a commonality algorithm. This software compares file stock of data and learns normal function images and data streams for equipment to include the facility's regular appearance. This function combines other sensed data to include sound and odor detection as well as application specific sensors like radiation and chemical to include explosives. This AI function of the PFN/TRAC System is set up to provide consistent quality and safe operation of the plant by acting as an early warning system for irregular happenings or anomalies during normal operation and for security and maintenance applications as well. The Close Button closes the window to the last task.

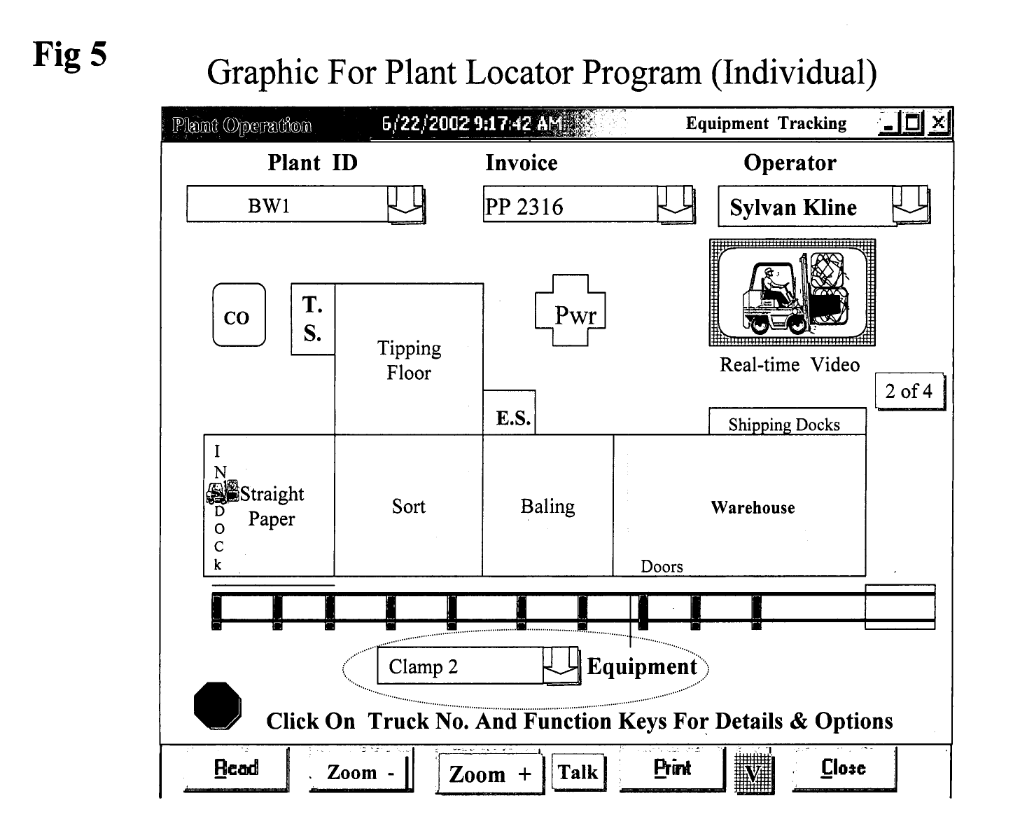

FIG. 5

FIG. 5 excludes all other equipment except what the viewer is interested in. In this case the viewer chose Clamp 2 by clicking on it in the plant display or entered it in from the equipment selection or using the search function in the software. The viewer chose to view the unloading of a paper purchase PP 2316 from printing house (customer), who's customer ID number is 52SG. The number is to give a progression to the customer base and the letters are the first two letters of the Customer name e.g. Systems Graphic Inc.

At a quick glance the viewer can see that Clamp 2 is receiving the SG Systems Graphic shipment PP2316 and that the equipment operator Sylvan Kline is handling baled paper by removing it from the truck. Lifting the bales individually activates the hydraulic sensor respective to the weight of the bale. The sensor is placed in the hydraulic lift circuit and the pressure difference in the fluid compared to a no load state is the means used to gauge the bale weight to fluid psi. The different pressure readings give a distinct current level and or digital signal. Both, conditions (load and no load) are sensed and sent to input pins on the E-PFN/TRAC processor where a software algorithm recognizes the signal and determines the correlating weight to the distinct signal or current reading Two modalities, transducer of pressure to current as a analog current value and or digital signal generated by sensor chip with a PN diode).

The plant ID is fixed in the upper window as the viewer could be in a remote location and the plants identification is crucial information as to how the center handles the material. Instead of a WO work order number as was present in the Alert example a PP number for paper purchase is the relevant data for this viewer. In observing the real-time thumb nail video in the widow the shaded button indicates the video is coming from the No.2 camera and the straight paper area and that there are a total of four cams reporting a view of Clamp two presently. One click on the thumb nail video will give a full screen view of the operator and clamp 2 and a click on the down arrow will give this option for 3 other cameras from which to Clamp 2 visuals have been indicated via the proximity triangulation or matrix algorithm processed in the individual camera equipment PFNS and reported to the network.

The stop button option on all the equipment has individual application specific preprogrammed responses to shut down safely any and every piece of equipment in the plant and in the operation. The protocols will be discussed in this application and the related applications and be forth coming as part of a continual development of the invention. Speaking generally, the invention is a progression of automated and robotics material reclamation technology and energy recovery that replaces the unsanitary, and unsafe technology of trash transfers and land fills

The keys at the bottom of the window allow the viewer to update the file by clicking on read. This key also opens an option window to review the machine's operating data, the operator's stats, and the work history or job record. The next two keys provide the zoom in or out functions. The center key allows the viewer to talk with the operator (audio and send a message to a display screen on the forklift dash). The audio system is monitored by a voice recognition algorithm to allow the operator of the forklift to edit and create hands free record of his work (e.g. record the type of material being handled, the customer and the load and place a verbal note in that file.

The time, date, location and weights are automatic by the PFN program running locally and the time and data is updated and synchronized with the computer system as the clamp PFN reports or on a regular timed basis. All PFNS have their own event memories and local clocks and synchronized time is made consistent via GPS and DSRC wireless (or any wireless desired or assigned as a standard or government regulation).

Besides the voice input the PFN can support other input interfaces e.g Barcode scanners video OCRs/video recognition algorithms and RFID tag technology, etc. Data recovered via these electronic means is processed by a real-time inventory control program running in the local equipment PFN. Some of the programs will be COTS existing programs and other portions will be custom-displayed in later windows format. Wireless routing software in most cases will be Unix programming with IP translation interfacing via standard developer products for the wireless protocols with various levels of encryption e.g. PGP for basic commercial privacy concerns. More sophisticated encryption is available for handling sensitive materials and controlled substances (e.g. Red bag garbage/medical waste (radiation). Vehicles handling these hazardous substances will have PS1 sensor arrays to detect radioactive materials and preprogrammed remote control and robotics responses of the material handling equipment (e.g. Clamp 2 are possible and probable to limit human exposure to these toxins if discovered in the waste stream or material handling process.

The print key allows the viewer to print a hard copy at any time and the operator of the lift can initiate a print throughout the IP network or the PFN can drive an on board printer on the Clamp machine, if desired or required or send the data to a base station in the maintenance or control room to print an operator coppy or multiple copies if desired or required by forthcoming procedures and protocols.

The entire day or weeks activity of the Clamp can be down loaded printed or viewed on an display interface either locally or through out the network. The system returns video image to the individual PFN for any event that triggered a recording. Both audio and video images as well as, all sensed data are saved locally and in the systems mass data storage for accountability (The control center or centers (as desired or required). This is necessary for the shared man and machine command and control, remote control and robotics progressive development. Both liability and accountability need this to determine responsibility and any culpability.

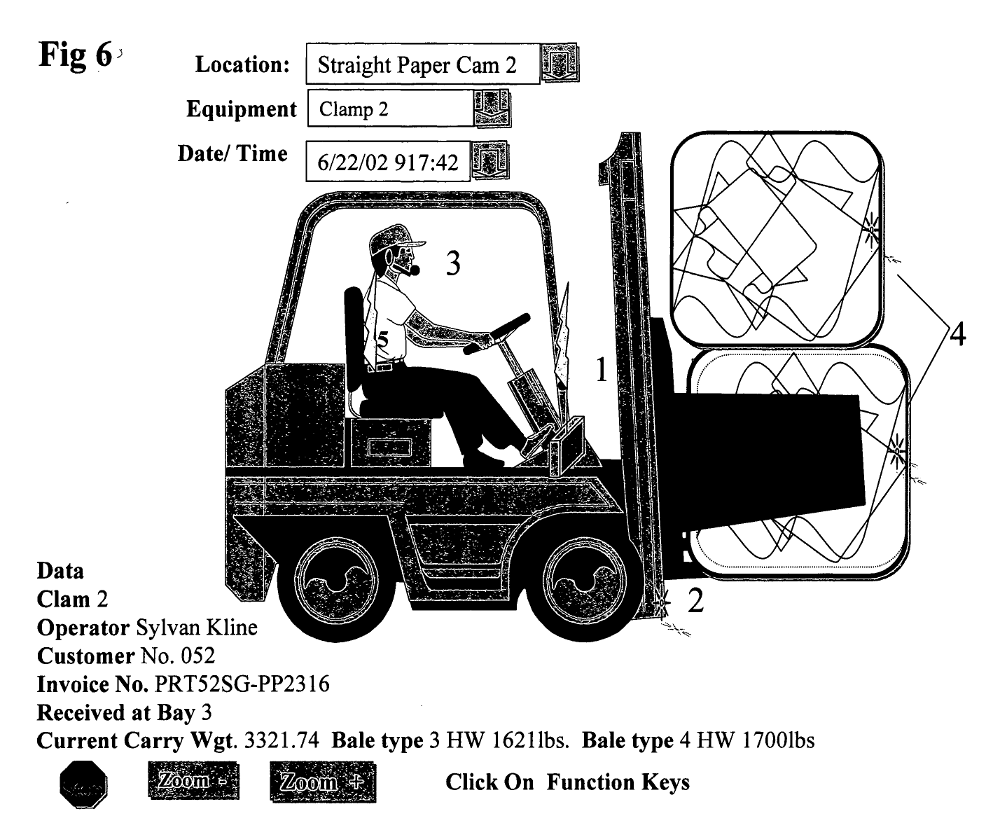

FIG. 6

Figure six is full screen view of the NO. 2 clamp and operator. Number 3 shows the audio and ear piece speaker for the operator to augment the electronic bill of lading file in the clamp PFN and the system centers. It also provides communication between the operator and the monitoring network. Above the clamp trucks is the image description. Location tells the viewer where the cam image is from including the Cam providing the image. The equipment window gives the unit being observed. The second window provides date and time. Buttons allow for camera shots to be changed and the equipment viewed to be changed. The down button on the date and time box allows the time to be changed to retrieve any digital snap shot or video of earlier events for review. These images are archived in the PFN event memory and in the mass data storage of the computer system.

Below the lift left is the data stream generated and running with the machines activity. The Operator is displayed and named in the information. This data is generated by a voice recognition algorithm, RFID readers, and or bar code ID recognition readers on the equipment or connected hand held wands or DSRC Blue tooth or 802.wireless wands responsive to the clamp PFN DSRC. Person 1P PFN personal units can further insure the correct operator is in the data file and operating the vehicle. If another personal PFN is located within an unsafe zone from the moving equipment the equipment goes into an immediate shut down sequence with warning horn and motion lock down depending on the proximity of the person. Also, if the legitimate operator's distance is to far from the driver controls to operate the vehicle, the vehicle is ruled running unattended and terminated. This process is monitored by the machine and the system for this unacceptable operating condition. Many other unsafe equipment operations are monitored and the operator is given a report of them at the close of each work cycle.

The customer number for the job being processed by the equipment is shown for the time the video has been captured. Also the invoice number and the receiving bay 3 are shown. Current load is indicated and the individual bales carried are shown with their respective weights and paper types. Number two in the figure is a weight sensor, either a pressure to electrical analog current sensor interfaced in the hydraulic system or a digital sensor chip converting hydraulic pressure into a digital signal uniquely representative of a specific weight carried. 4 shows some RFID tags that can be generated by a programming unit on the clamp machine or scale and attached to the bale so that an impregnated scanner can read the encrypted data or receive it and process it the interfaced PFN unit during other handling. This allows a system wide tracking of material from the point of entry into the system until it is delivered to the mill. For individual weighing by the clamp machine the driver edits his activities and entries of data via individual bale weighing and verbal comments. No. 1 is the PFN mounted on the machine and number 5 is the 1Ps PFN mounted on the operator Both, the machine and the personal PFNs have emergency Stop button capacity and the system can generate a shutdown sequence when a dangerous situation has been flagged via the vigilant safety and security program running in the local PFNs and system wide. The zoom key allows the camera to zoom in on sylvan tee shirt to see what he had for morning break.

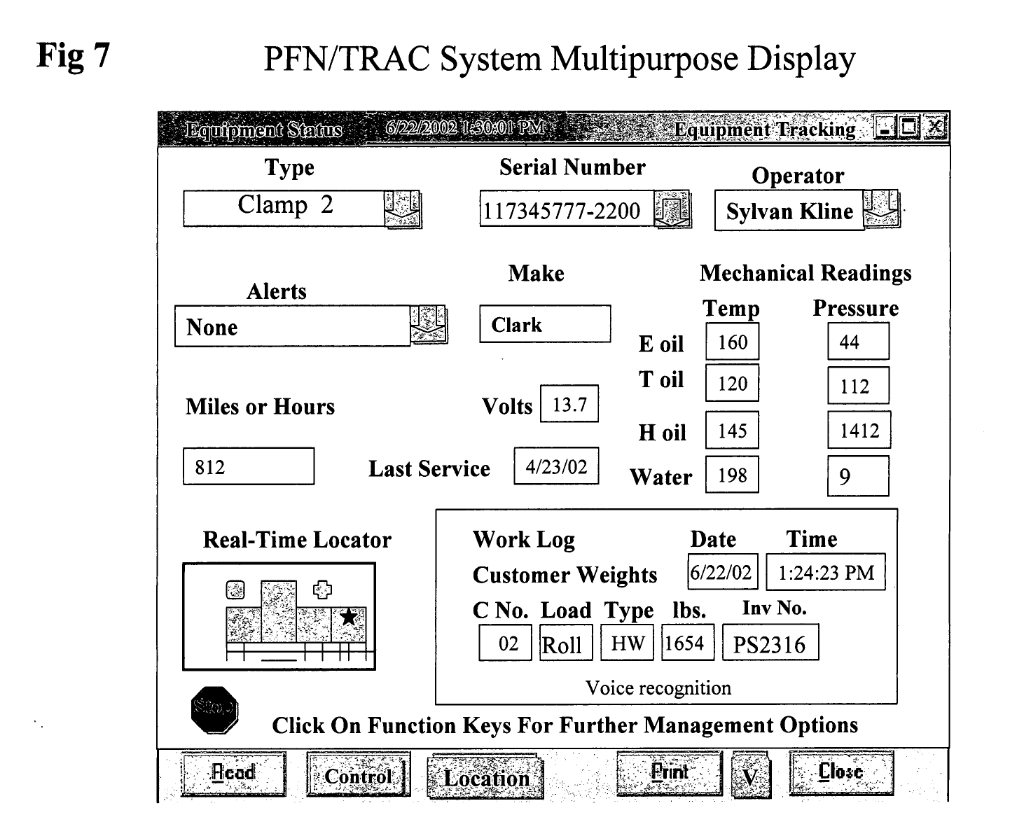

FIG. 7

This window captures the No. 2 Clamp at the other end of the facility in the Paper fiber recovery warehouse. The same operator Sylvan is working on a Paper Sale PS order 2316 where he is loading a trailer to Customer Mill 2 some recycled Hard white paper rolls that came in as straight paper. The roll is automatically weighed at 1654 pounds by the hydraulic sensors. This data is displayed in the work log and the log is showing that Sylvan is providing a voice description of the work he is doing. The real time located to the left displays where the Clamp is working and clicking on the image reverts to figure four but for this real-time video image of the work in the shipping warehouse. This screen shows that the lift is registering no alerts and this screen provides the mechanical data to the maintenance division.

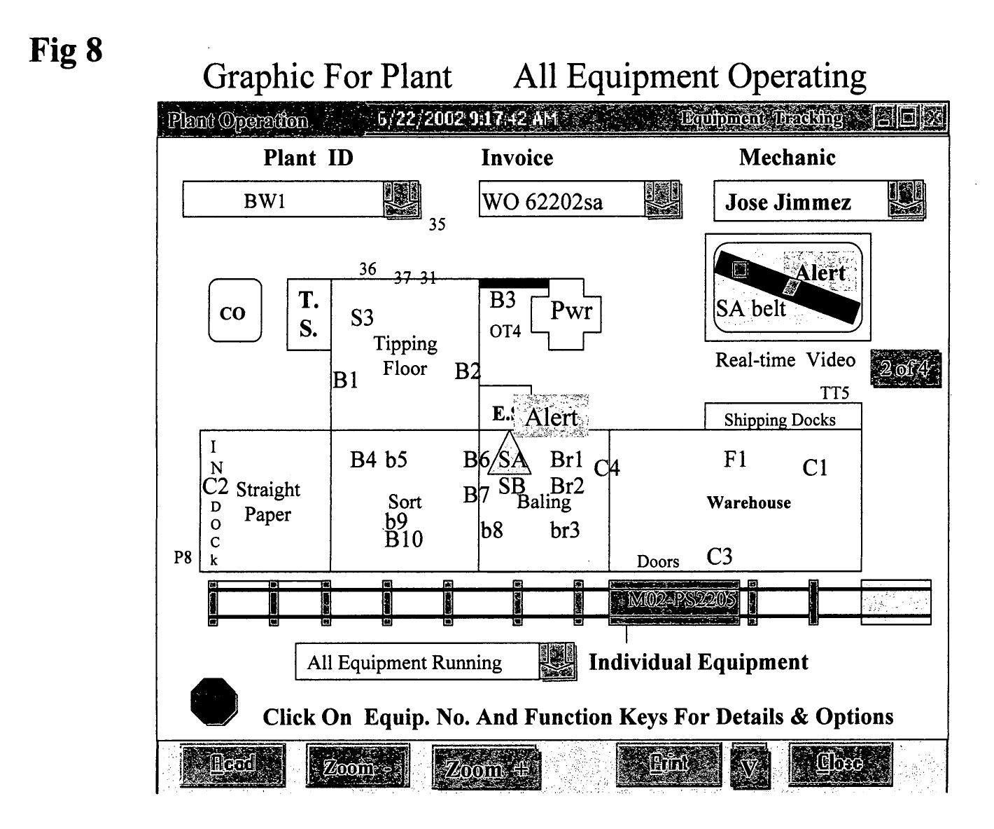

FIG. 8

Figure eight is the graphic for the facility an building in windows format. Provided is the real-time position of all running equipment and personnel. The upper right hand corner has a miniature real-time preview of a trouble area in the plant. SA is swing belt (A) carrying the corrugated card board from the tipping floor screen to baler one. The viewer can click on the alerts either in the graphic or on the preview screen to enlarge the real time video and or click number next to the word video allows the viewer to enlarge the preview and switch to other cameras reporting proximity views of the SA belt via software algorithms running in the various equipment PFNs and Video PFN units. In the personal PFNs and the specific equipment PFNs the authorized viewer (Plant operator etc.) can review the history of the event in text format and or audio and video to see where the repair work has been done and jump right in with current knowledge of the event without annoying the work in process by asking for information.

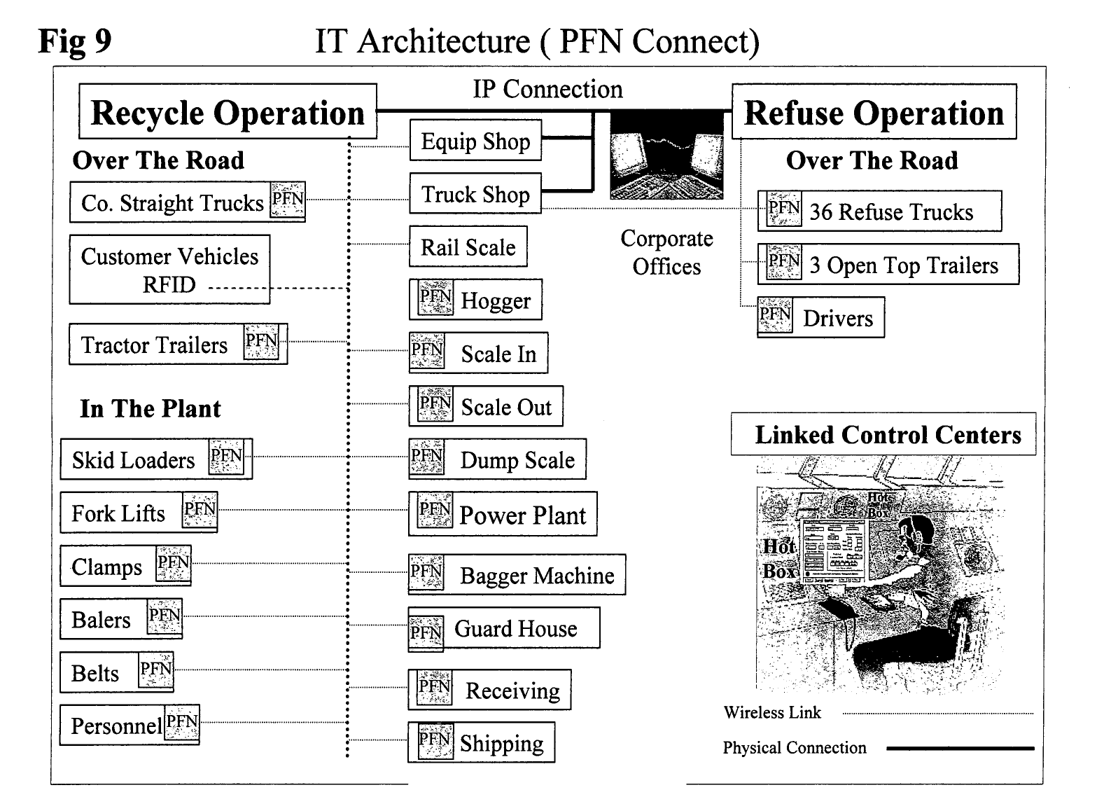

FIG. 9

This figure displays all the equipment interfaced with PFN Relay controllers both in the recycle company and in the Trash or refuse operation. The recycle over the road vehicles include straight trucks picking up straight loads of paper from printers low security offices via laundry carts, boxes and gay lords. This also includes; Office Destruction recovery and recyclables, where in one modality mobile shredders shred on location, lock down and carry back to the center, with an electronic file generated of all the waste disposal truck entries. A certificate of destruction and transfer is printed on the truck for each customer and the responsibility for material handling is transferred to the recovery center vehicle or trash hauler servicing both the customer and recovery center. Further with locked office containers and a secure personnel program to retrieve either locally pre-shredded or undestroyed sensitive waste in bulk from office space and load that waste into a secure hydraulic compactor container monitored and controlled by a 1P/E PFN unit controlling an electronic locking and sequence door, which also requires operator identity conformation and provides video surveillance as well as, generates a certificate for the secure handling to the recovery center. This way the most sensitive documentation can be handled by standard waste trucks doing normal pick ups and routes. In some cases other bagged garbage can be handled in the same container if the space is available. The recovery center is a licensed Office destruction center bonded and certified to handle the waste in the legal and appropriate manner.

Retuning the PFN/TRAC System monitor management screen tractor trailers both bring paper from big waste paper generating companies like printers and they deliver waste paper fiber to mills for the recycling operation or company, shown as a 180 degree operation through the plant in FIG. 2. These vehicles are equipped with the 1 SV PFNs that are interfaced with the trucks electrical CAN bus system (J1939 or later edition) and additionally supports various sensor arrays, plug and play scanners, wireless communications and vehicle controls. The trailer has a 1P Wireless sensor suite with its own Identity (ESN) and data storage record for loads. Entered electronically or manually by equipment operators via their personal PFN key pads their equipment PFN key pads or a connectable or wireless key pad/PDA (all of which are detailed in related PFN/TRAC filings. The PFN Trailer sensor suite has its own battery back up but also can be recharged by the trail's electrical bus.

The drivers also have an audio edit capability with the PFN and these PFNs communicate via cellular and wireless telephony to the PFN/TRAC system computer network (Any computer network set up with wireless responsiveness for secure and safe material via monitoring and automated handling is an direct infringement on the invention and its nature and scope). Truck drivers are wearing wireless biometric monitor systems responsive to their 1P personal PFN units and the surrounding data redundant repository files stored in the larger equipment PFN processors and data storage components. Emergency Action Messages and software flags can be sent system wide to all responding PFN units to download and respond for past present and future events. A system wide search can query all units or per an reply request sent out for information the individual PFNs can respond by sending data back to the requestor and the systems secure communications data bank in the center.

The personal PFNs monitor driver alertness and allow the driver communicate with his rig and the computer network tracking his progress. The drivers of the straight trucks can be equally equipped personally and to the right the Trash company or refuse operation are so equipped allowing for the rapid rerouting of vehicles to recover paper fiber more efficiently out of the waste stream. The open top tractor trailers are equipped the same way and the drivers are listed at the bottom. The Drivers are set up like the clamp operator where if they leave their seat and are more than the safe distance from their truck the vehicle shut down sequence will activate. This will occur with out an authorized operator at the controls.

(Full detail of each of the PFNs and PS1 sensor arrays are contained with in the specification and related patents. The use of the PFN TRAC system is restricted specifically to this recovery center application and also requires further licensing from Richard Walker).

In the Plant

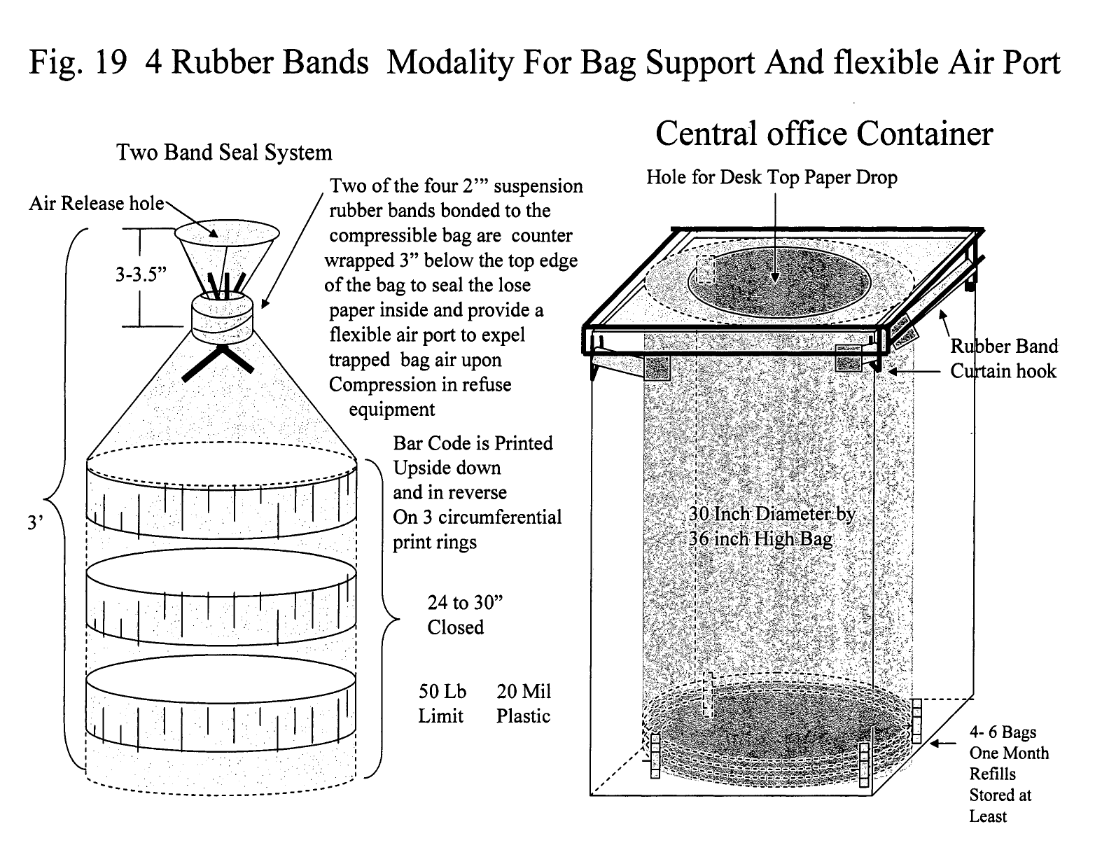

In the plant the skid loader, forklifts, clamp trucks all have 1SV PFNS. These are automotive relay controls and wireless repeater stations and are defined in earlier related applications. The ASIC shown and defined in this filing (FIG. 19). The balers, belts, scales hogger, pallet shredder, wood chipper, power plant, bagger machinery will employ equipment controllers like Westinghouse 1100, Brady Allen etc; they all have 1E PFNs interfaced with their factory controller and they have the same circuit as the ASIC in FIG. 19 which can be connected to, to perform new and or isolated functions on the host machine. The first vehicle units will use PC104 architecture and progressively develop to a minimal set of chips and finally to SOC technology or systems on a chip. All equipment is linked to the control center for their respective operations as well as IP linked in the desired network and for FACT Security if either standardized and or deemed mandatory for national security.

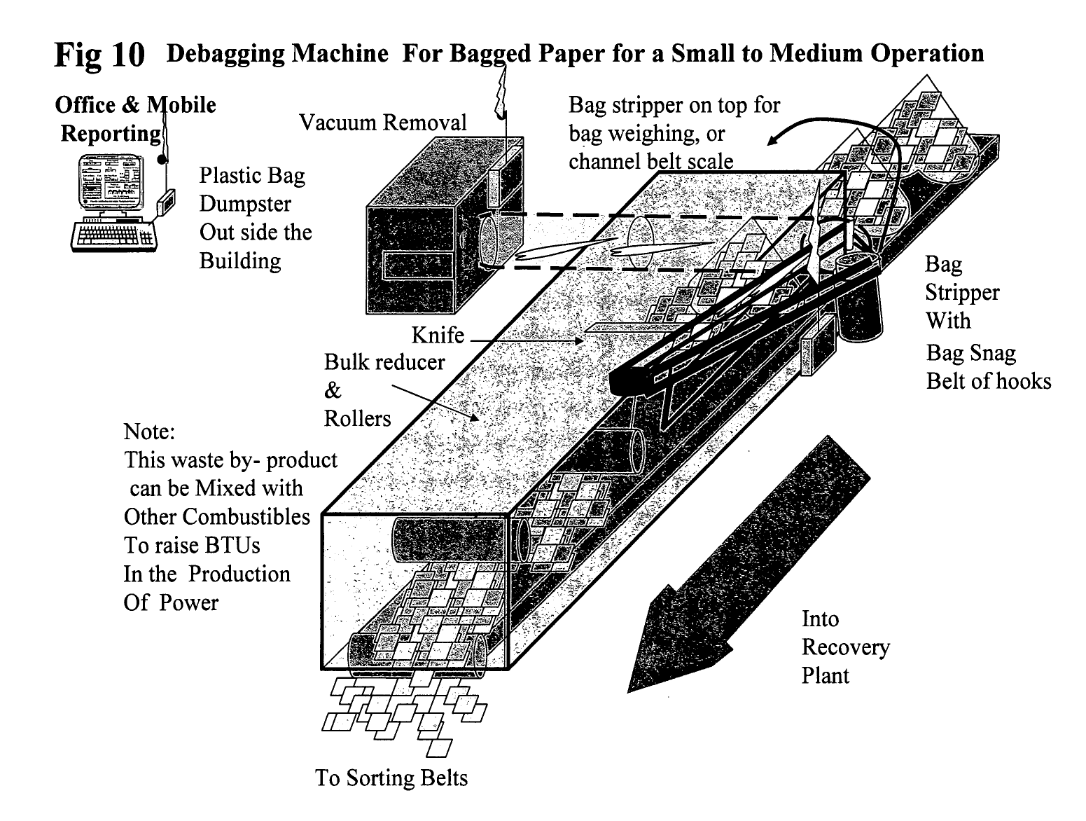

FIG. 10

This Debagging machine show in the next three figures is shown first in its complete form and then with its component parts. It is one modality to remove plastic bags from the office waste picked up with other dry trash from office buildings. It cuts and strips the bag from around the office paper and allows the paper to continue on the built to the sorting operation.

This paper is placed into the bag at commercial offices and thrown away in the trash so all the waste can be removed together. The bags are compressed and pop but the paper remains well contained and separate in the in the bag. The bags can vary in design and will be discussed presently. One bag design is made with quarter size holes to allow the air to escape when squished with out destroying the bags capacity to retain the paper separate from the waste. The holes additionally allow for easier tearing, grabbing and removal of the bag with the debag machine or manually. However, standard garbage bags pop and contain the paper adequately in most cases. This simplistic but unique application to separate and sort desired paper from the dry trash at the source is innovative and new for the application of acquiring office waste paper, as stated earlier most of this paper is sent as dry trash to the dump. I

The process will remove desk top containers and extra laundry carts for the building maintenance people to handle, with the exception of security waste that requires document destruction. In this case the sensitive waste will still require lockup and special building handlers. However, as explained earlier all trash can be thrown into the same dumpster (if need be a special compaction and authorized PFN controlled dumpster) so that the same refuse truck picking up waste can make one stop, saving operational cost and keeping city air clean of excessive diesel smoke.

This observation of traditional trash components for this unique application provides the basic diversion element for recovery and redistribution center to replace the dirty unhealthy Trash Transfer Stations and landfills as well as, the inefficient recycling operations and in many cases illegally run document destruction operations.

At the Center

The clear plastic bags displaying recyclable paper are picked and pushed out on the tipping floor unless they are marked with DD in gold. These bags are isolated out on a special belt that strips the plastic bag then grinds and or shreds the paper content immediately. then it can be fed as fuel stock to generate electricity or as office waste for recycling. It is not sorted for paper value first as do many of the document destruction companies do today. This presently places it in the hands of individuals to sort the paper by grade, and therefore is an unacceptable practice to secure document destruction materials. However in the future the recover center technology is preparing a technical solution via automated paper sorting and fiber identification and will submit an additional related filing to mechanically and securely sort this product by grade and then destroy it with no human contact.

In this First Modality Designed for Smaller Volumes

The plastic bags travel down the belt where they are slit by knives. A hookedor spiked belt to the right rotates in the reverse direction slowly via gear reduction on a drive motor so that as the belt is being dragged by the lower flat belt, which has little spikes like a cats tongue so that the paper contents are pulled and spread out of the bag. Where they are flattened and rolled out further on the belt then they are dropped onto the sorting belts. The slow moving hook moves backwards until the hooks/spikes travel up into a graduated slide sheath and the bag is release into a directed vacuum cup( so as not to affect the paper direction to the sorting belts. The vacuum is created by a reverse flow blower mounted on a dumpster. The plastic bags are stored in the dumpster out side the plant wall of the tipping room. These bags can be recycled with the plastics or used to increase BTUS for the steam generator creating electrical power.

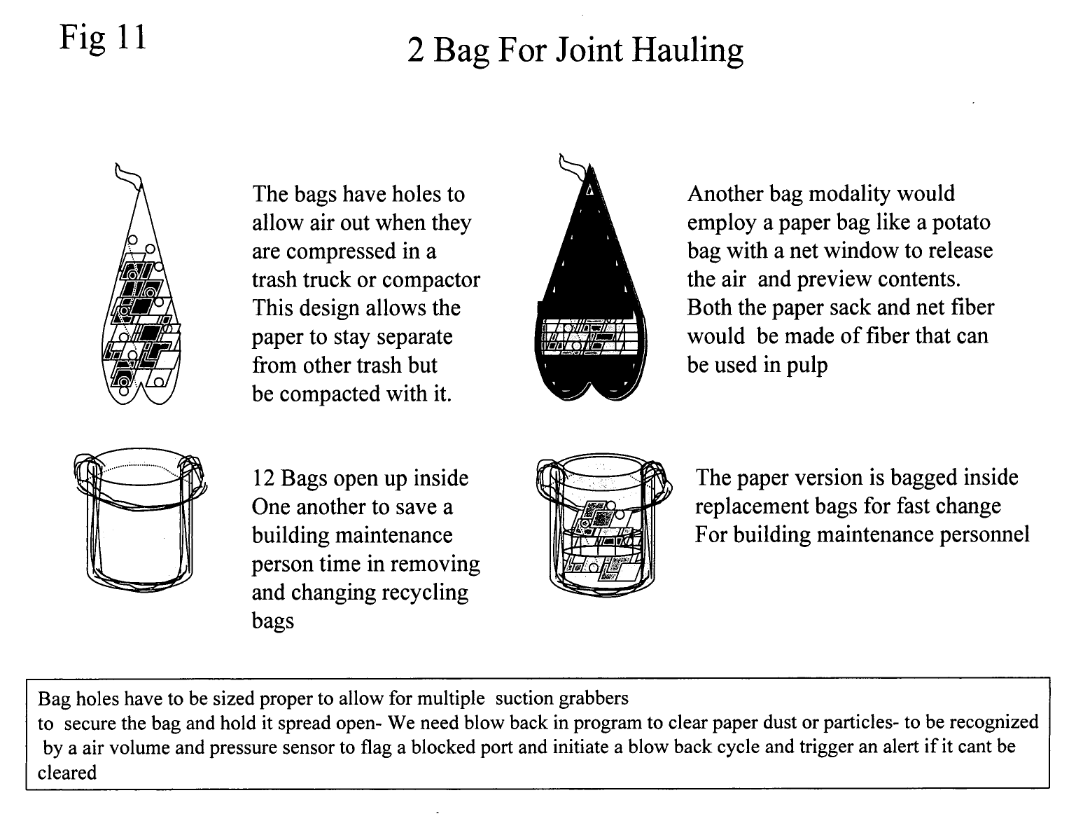

FIG. 11

This Figure introduces two new types of bags and modalities to dispense them for quick setups in a office container or waste can. Slide ten describes one machine modality to remove the plastic bags from the contents so that the plastic is out of the paper fiber and does not contaminate the paper pulp making process. The optimum plastic bag for this process needs to be manufactured in sets of 12 with the bags opening up inside on another concentrically when viewed from the top and inserted into the waste container. The bag is made with quarter size holes in the plastic to allow for the release of trapped air upon compression in a compaction process. This is done to avoid the unpredictable rupture of the bag when compressed by a compacter or trash truck. The plastic bag is to be transparent and of sufficient mil thickness and strength to support the paper weight when the bag is removed from the center of the bag stock inside the container. The transparent quality of the plastic is to allows gross pickers, the sorters and processors of the dry trash to quickly recognize and separated waste paper from the other dry trash and dark garbage bags. This allows the bagged waste paper to be compressed and transported by the same refuse truck as all the other trash, with the exception of the DD gold bags (or any color standardization chooses, (in fact any color coding for waste material handling that relates to the bagging of refuse and waste fall within the nature and scope of the invention as detailed in this specification).

With the ventilation holes and proper plastic thickness the bags will compress and keep the paper isolated from the other trash components. A second less desirable proprietary modality of bagging for isolation is the paper and net identifying window bag which would not require any debagging for office waste paper. The key factor here is to use a paper that is recyclable in the process and to keep the trash recovery process as dry as possible. Both of these bags are proprietary and a unique way to improve paper fiber recovery, separation and transport even though these 3 items have generally been employed in the business of handling trash for years. This unique modality and use to recover office waste paper fiber from the general trash stream saves the refuse industry billions in fuel, transportation and transfer fees as well as landfill dump fees. Not to mention equipment ware and tear the impact on city infrastructure and increased revenues via a combination paper recycling and clean energy recovery from waste through the center. The invention lessens the impacts on the environment and saves and protects forests as well as, reduces the cost to produce paper and cardboard products.

Present Recycling Process Technology and Draw Backs

Present office recycling separates the waste paper at the office in deck top boxes that require them to be dumped into laundry carts and transported by separate trucks. This means double trucking, more city-wide diesel smoke, air-pollution, fuel loss, labor cost, less fiber recovered, more congestion in building storage areas, greater fire hazards in the buildings, more material handling and increased choking of shipping and receiving areas, more containers, more traffic congestion and more companies to deal with in the removal of waste products.

Simple Easy and Unique

The recovery of the paper bags can be at the desk or central in an office area so that the building maintenance person can dump all refuse into one cart and the same compacter or trash container in the shipping area. One refuse company picks up one load of waste from the building for all the trash with unsecure containments if that is desired. If not the level of required will designate the types of containment needed and secure transport container to properly handle the Document destructive waste. Obviously red bag medical or chemical waste has to be dealt with in a separate isolated manner.

Possible Accounting Benefits

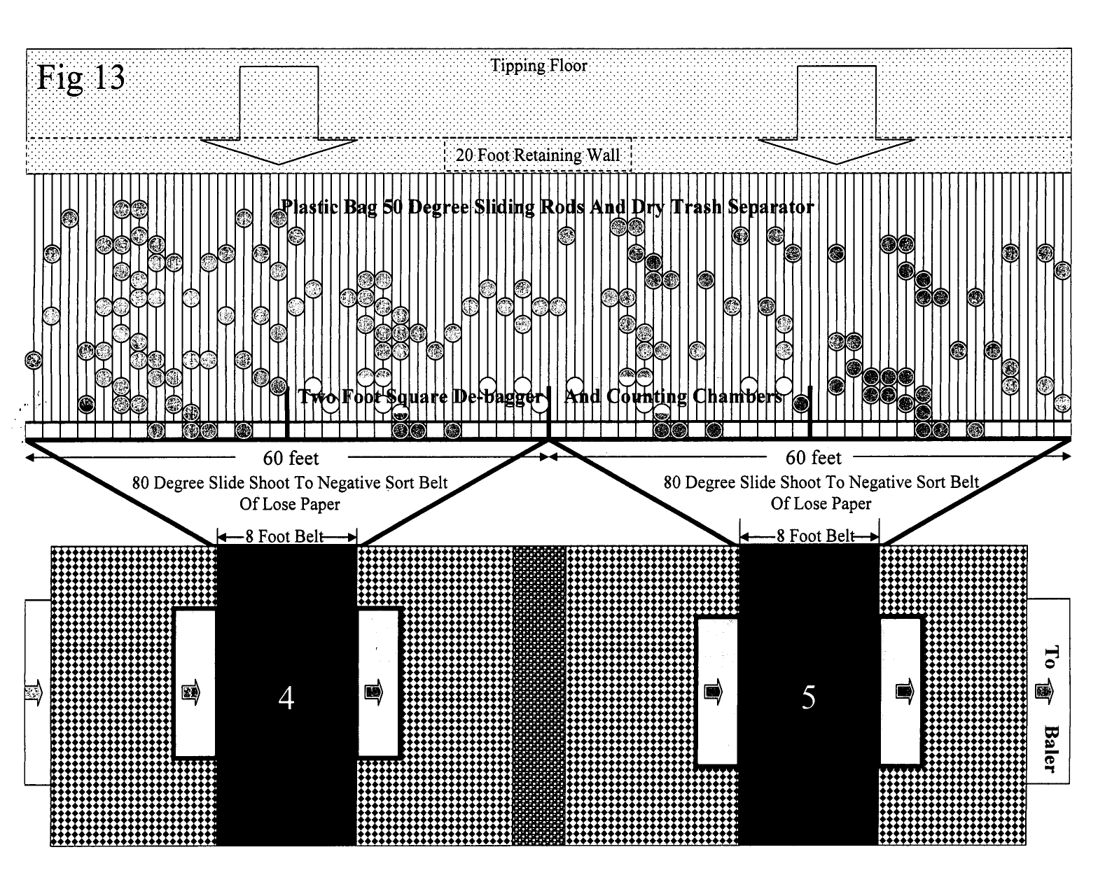

Bags can be bar-coded (big) and paper recovered accredited to a particular account if recyclable revenues are applicable to the commercial transaction. This process would begin with the container weight taken by hydraulic scaling sensed in the lift circuit of the refuse truck processed by the 1SV PFN software in the trash truck, which intern would report the data via wireless to the recovery center computer as the pull weight for the total load. Later, the bagged paper weight would be determined by weigh sensors in the belt and singly processed through a scanner en-route to the de-bagger machine, where they are scanner and recognized per account. The two weights would be used to credit the account for reusable waste paper and charge the account for the cost of hauling away the trash. An itemized bill would be generated and posted electronically on a secure website where the customer could follow the waste material flow and accounting process. The de bagging machine shown in FIG. 10 is for small volume applications. For urban major plant operation the mass de-bagger shown in FIGS. 13-17 is the way the plastic bags are handled. This kind of accounting and accountability also allows for the refuse and recyclable to be appraised for proper disposal and improprieties in the process which would be flagged by the monitoring software programs and captured on digital video for appropriate action. It is important to remember that the technology is designed to handle al waste material and to process it proficiently, therefore even the cost of handling and reprocessing hazardous materials is greatly reduced. So a no tolerance policy for illegal dumping has to be in place. This is another area where the waste and recycle industries have not policed themselves well in their service to the community, and why government and municipalities should embrace this technology.

Returning to the Container

The bags would be quickly installed into the containers and the exterior bag of the stack or bag stock would stick to a two sided adhesive tape wrapped around the circumference of the container (tape would be periodically changed). Note any multiple bagging or attachable group of bags for the quick preparation to receive and bag materials or items held in a containment fall within the nature and scope of this invention and any containment to control separation and transport of waste paper fall within the nature and scope of the invention. Further will be other office bag systems explained to be used in this application.

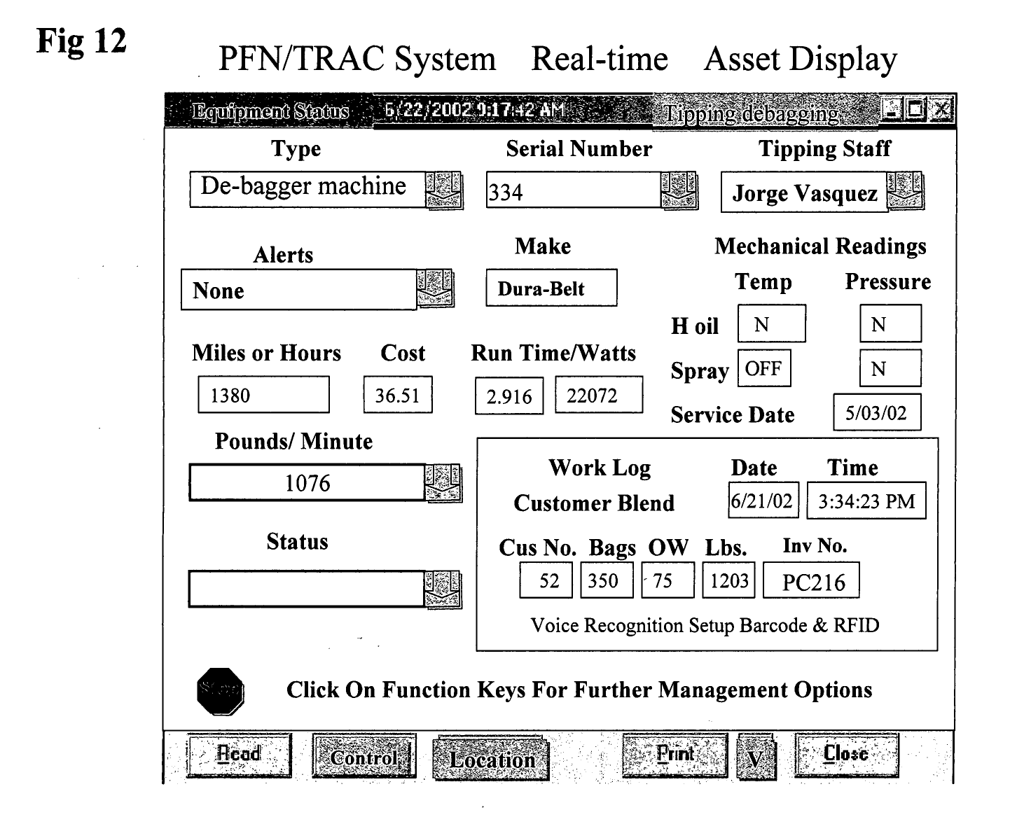

FIG. 12

This figure is a windows graphic to view the operation of the debagging process taking place in FIG. 10 and FIG. 11. The mechanics shop, the plant manager, corporate billing offices and or any number of desired IP connections are possible to include a near real-time supported web site with protected customer access to review the waste paper they have sold for credit and the trash charges they have incurred for un recoverable waste and or material handling that has been pulled from their site. All of this is within the nature and scope of the invention, including the PFN/TRAC management System™. The window above is primarily for the plant operators. However, this information and data would be distilled into customer windows applications, that require pass words and PGP encryption downloads to used in viewing daily transactions posted on the web site within the business day for the customers to access.

Entry into Plant and Monitoring of Waste Materials for Public Safety and National Security:

The tracking of waste materials provides a unique way to monitor dangerous substances and locate national threats and with the PFN/TRA architecture a cost effective way to take advantage of this opportunity. Trash and waste paper handling is a rough service industry and contaminants rupture under compaction allowing for the open air sensing of controlled an or dangerous substances not normally recognized and possibly being used negatively. This opportunity to sense ruptured containment may leave a contaminant trail of throw away components used by a terrorist or hazmat offender that is endangering the public. For this reason one of the first plant machines to handle waste product is the de-bagger and it will be used at this time to describe this PFN/TRAC home land security monitoring process. Because of the great need for the interoperability between the commercial sector and government to be able to use this data government regulation/enforcement has to be tempered in any over zealous revenuing activities (penalties and Fines) to get this very important information and data willingly. For these reasons the inventors suggest certain amnesty, aid and tax credit programs developed by government as commercial interests to maintain public safety standards. To maintain state of the art detection and handling both government and the public have to understand a commercial interest's cost factors and must be willing to invest in the proper advances and maintenances for the proper protection. With this in place communication should be open for the maximum use of the PFN/TRAC Movement management System with FACT Security to provide the nations protective agencies with the greatest tools to locate hostile and improper use of dangerous materials and equipment. More information into the PFN/TRAC System for automated material handling and secure movement management will be forthcoming to explain how each application of this technology is a microcosm of the federal access and control technology (FACT) which provides real Homeland Security with real civil rights protection and constitutional guidelines and restrictions to prevent technical and social abuses.

Retuning to FIG. 12

All data recovered in the sensing of the plant would fall with in specific tracking programs for the monitoring and management of materials. The hazardous materials can be reported automatically to the appropriate authorities and customer base responsible for generating them in the waste stream with the proper cost and controls put into place early to reduce cost to everyone. For example this bagging machine and transport belt system would have PS1 sensor array to pick up red bag and medical waste/Radiation and report this to the computer system via the PFN relay stations immediately, At public safety levels alerts would be automatic and the equipment operated remotely or robotically with preprogrammed responses to insure the maximum safety to the worker and the community.

The tipping floor and the debagging operation is at the front of handling waste product that could be contaminated with radiation bio and chemical toxins. PS1 sensor arrays for detecting these toxins can be mounted on the trash trucks the conveyor systems the sorting systems the packaging equipment and the material handling equipment to provide real-time detection of these materials for public safety and national security( many which go undetected by hundreds of workers each day on their illegal route to an improper dumping.

The normal operation and levels of toxins present in the waste stream will be entered into a lookup archival file identifying the types and amounts of their sources as well as their handling/processing and storage to create to monitor normal conditions to handle these materials in a known manner. This will be accomplished with an algorithm in the accounting software for real-time inventory in the system that requests updating and accreditation for material type, quantities/levels and handling process. This movement management capacity is made possible by the PFN/TRAC system™. In later figures it is shown tied into the Federal Access Control technology for the nation's homeland security involving intelligence agencies regulatory agencies and local first responders.

Returning to the Present Equipment Window.

The equipment PFN reports and or responds to the systems query to provide real-time operating data and the system provides archival data either from the PFN processor and or the system. Qualified maintenance personnel operators or authorized management can identify their access of the unit or system and edit data, however these events and changes are retained in memory. With this in mind this window viewed in or on the equipment display has its information generated accordingly and the same is true system wide and per the request options clicked on by the viewer.

The window displays the type of equipment, it's serial number, the make and provides essential mechanical data. Alerts are none, mechanical or safety in nature as detailed earlier. Clicking on the box opens a detailed window screen with options and descriptions. Below in this window further provides the viewer operational information, performance levels and cost. There is a real-time work log and the archive file for work run through the machine for the last week can be view from local memory. Earlier work can be brought up from the systems mass data storage. Automated data is entered via voice recognition of authorized personnel, barcode readers, RFID technologies, electronic signals analog and digital from sensors, video and keypads and magnetic readers

FIG. 13

FIG. 13 is a design to handle a massive amount of bags at one time unlike the smaller debagger discussed in the first modality. However, in the first modality multiple units can be used if the volume is finite and or growing slowly.

Looking at FIG. 13 at the very top there is a 20 foot retaining wall the top of which is the tipping floor; the bags are pushed from the tipping floor on to downward angled rods which appear as straight black lines in the illustration. The rods are 1 foot apart and the center rod is rotating to draw the waste bags into the square de-gagger gates. The two outside rods connect to each side of a 2+ foot square gate opening which is represented as a line of shaded squares across the top forth of the page. These out side rods serve as guides so the bags line up for a direct entry into the 2+ foot square gates. Garbage and trash loaded onto the rods the bags fall between the rods into a pit with a conveyor belt at the bottom of the pit. The garbage is then pulled away ground up into a paste and used as fuel for the steam generators and or gassifiers to generate electricity, which powers the plant, the excess is sold back to the area electrical grid. The little round circles on the rods represent the waste bags filled with office waste to include multiple paper grades and a minimal amount co-mingle recyclables. At the top of the figure the bags are pushed on to and spread across the delivery rods by articulating loaders and skid steer loaders from the tipping floor. The two triangles in the center of the figure are flat metal slides and guides that receive the un-bagged contents and deliver the contents to the two dark sorting belts 4 and 5 continuing down the figure. The large rectangular squares on either side of the belts are plafforms for sorters to stand an pick out material and drop it into the smaller rectangular openings with the arrows on the lower belts running perpendicular. This top view of a shoot looking down on belt 6 carries away material to the right or in a stationary mode provides a temporary storage bin before baling. Belt one and two continue out the bottom of this illustration and can be seen in FIG. 2, where much more sorting is accomplished.

The sorting stations are set up for manual labor at any time, but they are designed for automated identification and robotics sorting via paddle diverters, suction, air pressure, electro-magnetic/magnetics, eddy currents, hydraulics and clamping mechanisms. Progressively the recovery process is to become more and more automated for health and safety reasons.

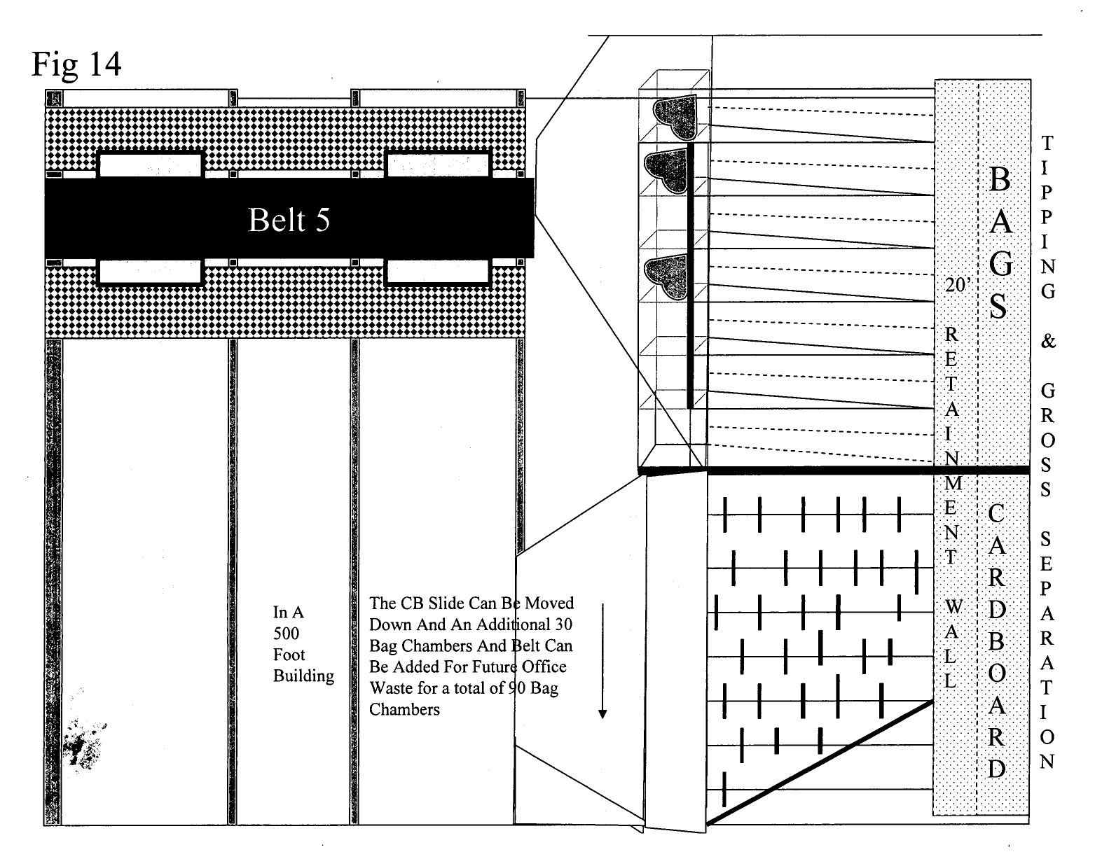

FIG. 14

This view shows the last belt or furthest most one to the right belt 5 in FIG. 13 along with the cardboard and flat screen section for card board filtering next to the debagging chambers. This section pulls the cardboard a way and allows dry trash and garbage to fall into the pull away pit, where a belt carries it off to be processed as fuel for electricity generation. The cardboard is supported on rotating disks that push it a long to a point where it is guided on down to a belt to the LG baler in this case belt 6 which is the corrugated belt. Other card board on belt five are sorted into shoots as well as straight loads from the left as seen in FIG. 13 are loaded on to belt 6. In the upper right hand corner an isometric rendition of the rotating rods pulling the bags down and into the bag stripping chambers.

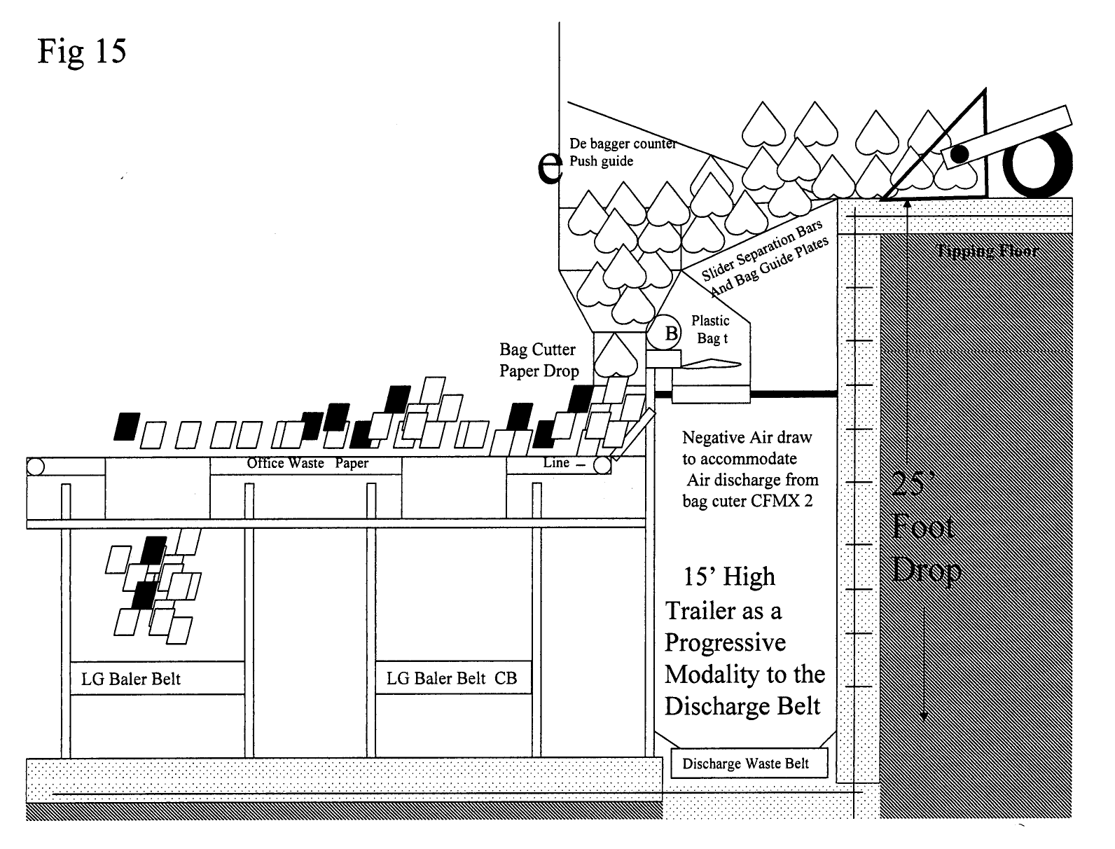

FIG. 15

This figure is a side view of the mass debagging machine on the edge of a 25 foot drop from the tipping floor. A loader machine is pushing the bags onto the slider separation bars allowing the trash to pass through into the pit where an open top container can catch all the waste not processed (in one modality). Or it can fall on a belt where it is pulled away and ground into fuel stock to generate power. These are progressive steps depending on the expenditure of the recovery project. As seen in the illustration the bags are guided into one 2 foot + chamber where it says (bag cutter paper drop). Here the bags are cut their bar code is read and they drop on to belts 4 and 5. On one side of the bag cutting chamber is a vacuum to remove the bag and drop it on a carry way belt in one modality where the bags are recycled and in another modality they are allowed to fall right back in to the dry waste and garbage in the pit to add BTUs to the waste to energy fuel made from the discarded waste. At least 12 feet blow belts six and seven are running perpendicular as the low grade belt system nadling cardboard and office waste generally. Further down belts four and five are higher paper grade belts. And negative air draw in the waste drop is a constant process with the air fed back into the fuel feed to limit smell. Excess air is scrubbed and atomized with deodorizers.

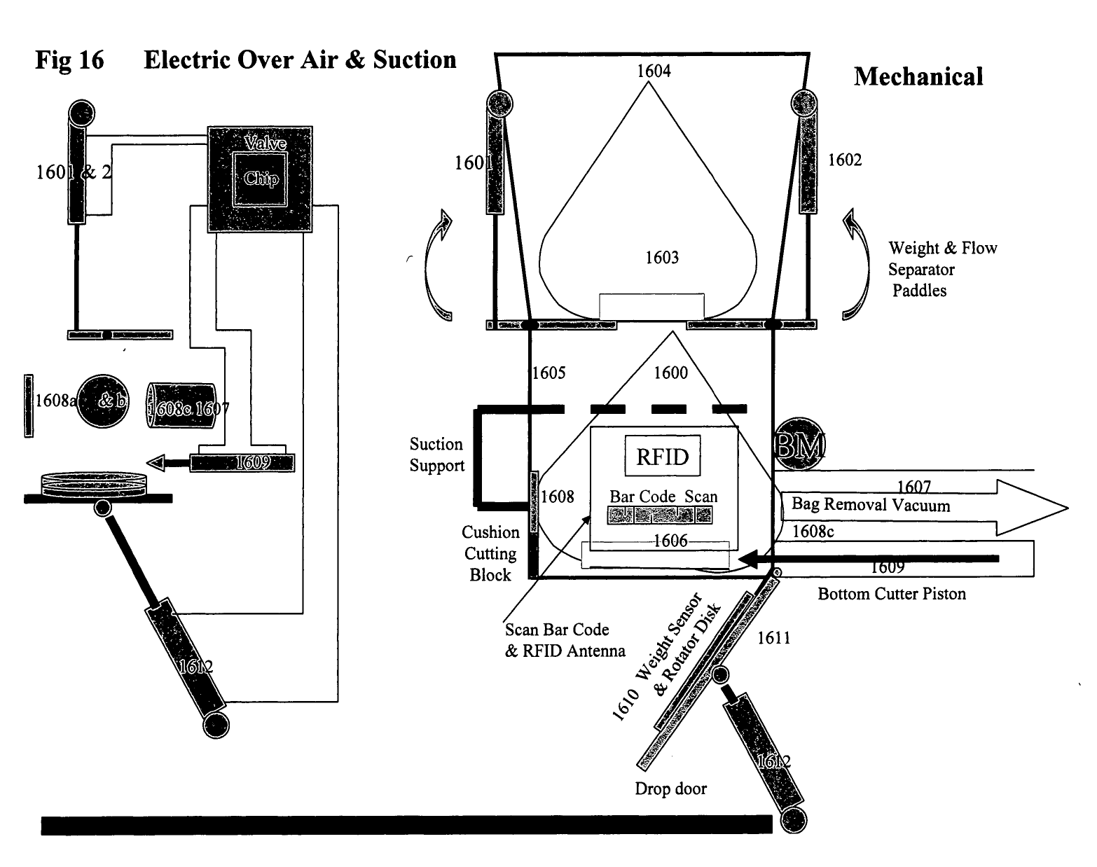

FIG. 16

There is to be initially 60 de-bagging sensing and weighing chambers like the one illustrated in FIG. 16. To the left is the compressed air system and vacuum system controlled by a microprocessor and electronic solenoid valve body. Each debagging chamber has it's own microprocessor and electronic flow control valve body with four bellows air pistons exactly the same size and stroke. While they could have been engineered more closely to application and stroke it was thought that if all the pistons were the same stocking parts and rapid repairs could be more easily performed and efficiency maintained.

Operating Specifications

The initial operating chambers are 60 using 135 feet of floor space with immediate room to add an additional 30 debagging chambers for a total of 90 debagging chambers. Initially, the two sets of 30 bag chambers will cycle every 15 Seconds which =240 Bags a minute weighed, registered, ripped open with their plastic bag disposed of, and their office waste contents spelled down a slide to sort belts 4 and 5. in FIG. 2. This debagging, scanning, sensing and weighing function processes 14,400 bags an hour and 115,200 bags per 8 hr. day. If a sensor flags a bag with toxic or hazardous material the chamber locks down on the contents and the PFN system is notified to include all employees and control centers and government agencies and first responders depending on the quality and quantity of the hazmat flag. The least severe events will allow the other 59 chambers to continue de-bagging. Immediate information as to where the bag came from is known. Sensing also includes materials that will damage the recyclable products or their reuse.

Figuring each bag weighs at least 5 pound that =72,000 pounds an hour 576,000 pounds a day or 288 tons of de-bagged and accounted for office waste per 8 hr. Day. With the addition of 30 chambers the facility can easily expand to debag another 144 tons for a total volume of 432 tons per day. And in a 22 workday month the recovery center would process 9,504 tons of bagged office waste not counting all the other waste tonnage converted to electrical energy and or recyclables or brought in as presorted or as straight loads The initial monthly debagged figure for 60 chambers feeding two belts in a 22 working day month is 6,336 tons of bagged waste.

Ultimate operating cycle speed per chamber is projected at 7.5 seconds yielding 180 bags for 90 chambers which =720 bags a minute or 43,200 an hour or 345,600 in an 8 hr day; With the minimum bag weight at 5 pounds that is 1,728,000 pounds a day or 864 tons per day to yield 17,280 ton of paper debagged in a 20 day working month, not counting any and all other waste. recyclables or recoverable energy weight.

The plant is designed to add more chambers and the working days can be longer as well as the amount of days worked per month

The above figures are just for the debagging of paper not including other waste tipped. If the hauler only hits his minimal paper requirement as paper fiber dumped there is an additional 40% of waste carried by his refuse trucks and handled by the Recovery Center through other recovery applications. So if the debagged office waste is at 60% totally 17,250 ton the Recovery center is still handling 40% more, another 11,500 tons for a total of 28,750 ton a month. A 60/40 cut is a standard contract with dry waste haulers, to tip their office waste for $35.00 a ton locally in the city for the recovery center.

The figure displays one chamber of the rack of 30 chambers. Each chamber is operated independent of the others. Because of timing the actuators to the individual flow of the bags entering each separate chamber is nearly impossible to coordinate for all. The brown chip is a microprocessor with programmable firmware hardware imbedded software. Any number of processors could be used for this application however the stamp II mini computer will be used. 1604 is the alignment and sensing chamber and 1605 is the debagger weighing and scanning chamber. As the two bags weigh down on 1610 the weight sensor and rotator with 412 piston extended in a closed chamber position trigger 16o1 and 1602 to extend and lift the upper bag off of the lower bag in chamber 1605. At this point the 1600 bag is weighed the scanner reads the barcode and 1609 cuts the bottom out of the bag while vacuum at 1608a, 1608b and 1608c hold the bag spread out to allow the contents to fall on the slide guide 1611 and down onto belts 4 and 5. 1608a and 1608b vacuum is released and vacuum is increased at 1608c to pull away the emptied plastic bag, where it either is sucked down 1607 and dropped straight into the waste pit for fuel stock or dropped on bag removal conveyor or suction tube to be processed for plastic recycling. 1612 is activated and extended to closes the weight sensor and rotator disk and the 1601 and 1602 contract, and left is a blower motor to create the vacuum and place positive air pressure on the bag release.

The soft ware is written P basic to this series of activities as just described. The hardware involves the micro processor I/O pins SCR circuits control current/high current relays and electromagnetic solenoids and connected valves (this technology is well detailed in the related PFN/TRAC System filings). Both weight and bag identity are recorded in the equipment PFN (normally) and anomaly events are recorded when they occur) for each rack of 30 chambers and in the control center, and contractual hauler, as will as, the server supporting the customer interactive web site. The energizing force is air over hydraulic to meet speed of function requirements, however hydraulics or electromagnetic force of which, all fall within the nature and scope of this innovation

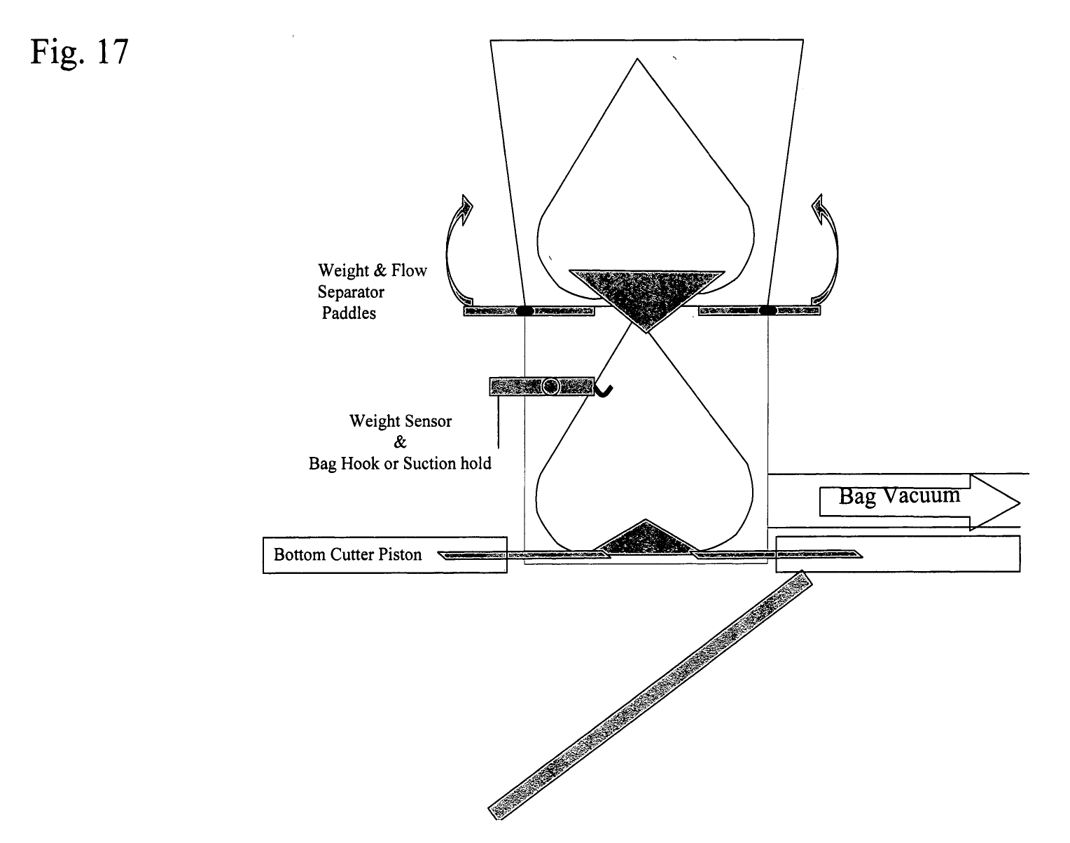

The operating component part list for the initial installed De-bagger machine is as follows:
A) 240 Bellows Pistons 2″Diameter by 25″ long with ⅝ ram USS 9/16 thread (This include piston positions 401, 402, 409 and 412)
1) 12 spare pistons are recommended as available repair stock or 5% of the total operating pistons.
2) Sheet metal development for the chambers is per waste bags handled.
   FIG. 17

A version of the same machine utilizing a catch hook to hang and weigh the bag weight as another modality or as another method to hold the bag up as two cutting knives remove the bottom and allow the contents to fall.

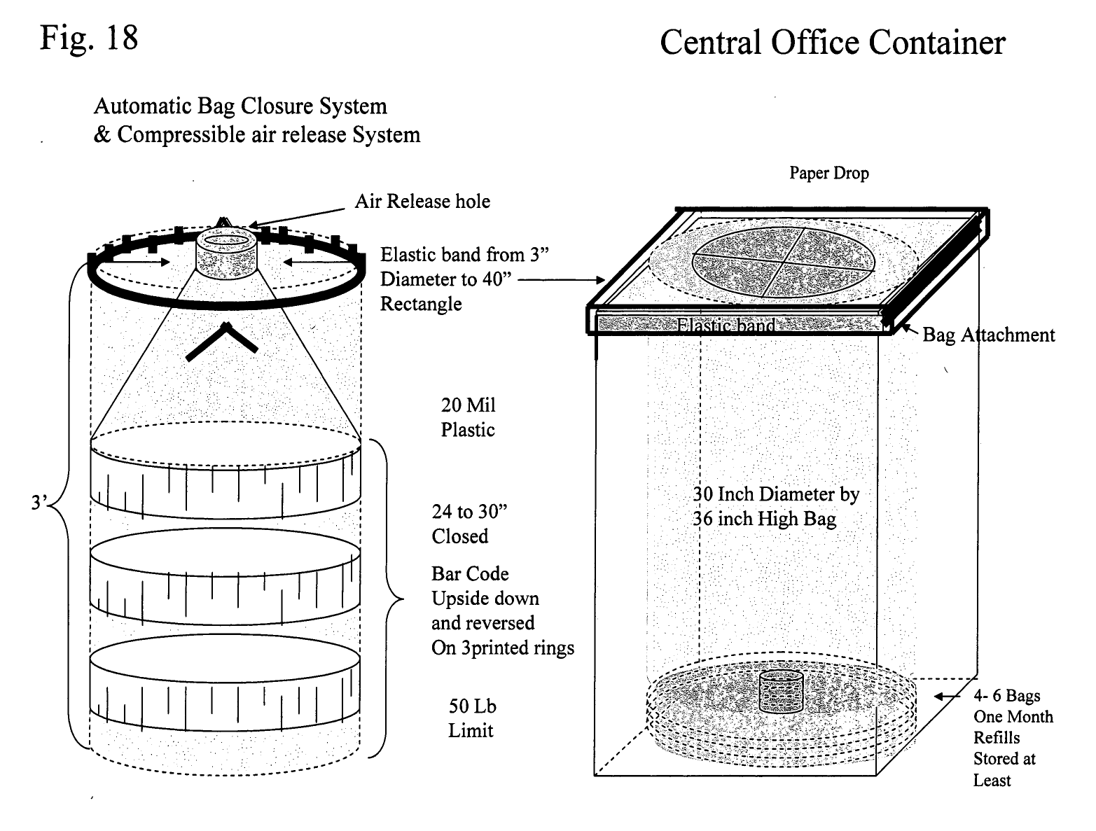

FIG. 18

This office container is shown for unsecured Documents in this illustration. The same bagging would be used for secure documents but the container would have a locking rim just under where the elastic band grips the container and the rubber center flaps for the paper drop would be a one way slot. This same bag could also be used with existing document lockup containers as well.

Looking at the left side of the drawing the bag has an elastic closure band that not only expands to hold the bag open when housed in the container, but also closes the top when removed. So when the bag is filled with waste paper the office cleaning personnel just peels back the elastic band from the container and pulls it out. The bag top closes automatically leaving a small air hole at the top of the bag. This bag needs no other holes to expel air through during waste handling compactions. When the bag is compressed the hole can expand a little moreto release air pressure and still keep the lose paper trash and recyclables trapped in side the bag. The bag has the bar-code repeated multiple times around it so it is easy to read it during waste material handling and machine cut sense and weigh operations. To the right shows the office center container with 4 to 6 additional bags at the bottom of the container for easy replacement.

FIG. 19

Another bag design uses a series of rubber bands, four to be exact first to secure the bag in a open position by attaching the four rubber bands to each corner via 4 u hooks that slid down the card board wall and position in the four corners of the container. In lockable containments four open end eye hooks with wood screw threads are to be secured in each of the four corners in side the containers to slide the rubber band over. To the right shows a container with the bag installed on the hooks and the 4-6 bags held in reserve. To the left shows the bag removed from the container and two of the diagonally opposed rubber bands have been wrapped around the neck of the bag 3 inches down to allow for a constricted flexible hole which allows air to pass out during compaction but no contents to escape. This bag also uses the circumferential repeating bar code to track the material from origin to its de-bagging.

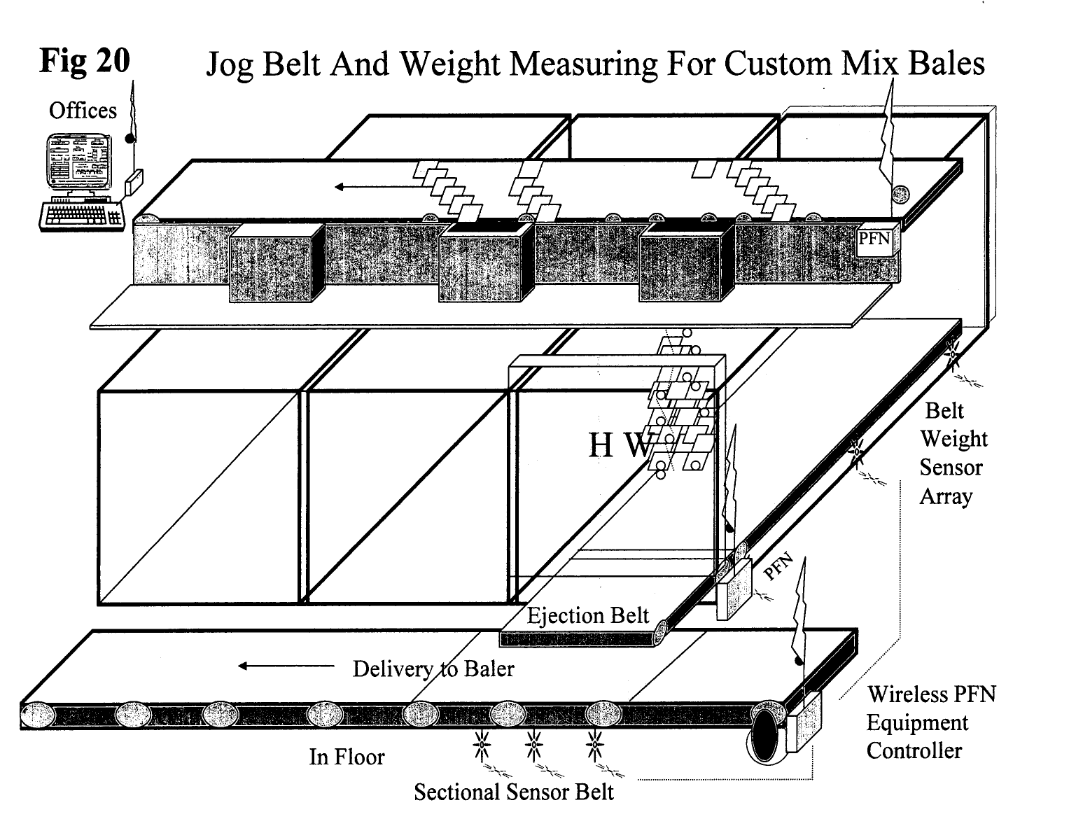

FIG. 20

The sorting belt and jogger mix system is designed to progress from a labor intense operation to an automated optical recognition robotics sorting system. Top section initially will have people standing and picking the paper products out of the waste stream and dropping them into the shoots along side their workstation, where they fall into separated hoppers or bins, and where a jogging belt at the bottom measures out specific amounts. The jogging belt has sensors under it to measure the paperweight in the bin and the ejection section has a set of sensors to measure the release of paperweight on to the delivery belt. In figure twenty one there is a Windows graphic to program the jogger ejection belt activity in making a specific mix of paper in a bale. The Hard White (HW) bin can have a portion of it's contents shacked with the other parallel bins having other grades of paper jogged out in measured portions in the same way to create the blend of paper.

In the upper left hand corner is a computer station in the corporate offices that is connected by wireless via the PFN relay controllers. The belt weight sensors can be hardwired or wireless to the PFN relay control stations shown on the side of the belt motors and drive wheels. The operation of the plant equipment and product production can be programmed form the corporate offices and monitored and managed from there. The PFNs allow for the safe operation by recognizing all employees 1P personal PFNs and where they are located as well as, other pieces of equipment via their wireless PFN links. The PFN movement management system develops it's own artificial intelligence in the factory with position and material awareness. Each personal and equipment PFN as well as, all windows provide the capacity to shut down the individual pieces of equipment. Manually automatically or by remote control.

FIG. 21

The bins in FIG. 20 all have jogger belts and program windows to operate their jogger and ejection belts. Electric eyes, weight sensors as well as video cameras monitor and control the front barrier gate elevation and the ejection speed as per the programmed directions.

In viewing the windows graphic the hard white paper pile jogger program screen is observed. By double clicking on the types and pounds/minute boxes of the other mix components the other equipment screens can be brought up. If one only wishes to change the mix the viewer can type in the pound amount to change the percentage of a particular grade in the mix and bale formation. To go directly to any specific machine control the viewer can click the down button. For example clicking on the Type down button provides all the equipment at the facility being viewed. To change operations and go to another facility or to find a piece of equipment or person in the organization the viewer can type the name or serial number or click the respective down buttons and pick their interest for a specific window related to the real-time activity their interest is employed in. In the work log box the viewer can type in a date and time or invoice number of a particular job or a customer ID number and pull up an archive file from the central PFN peta mass data system and any specifics held in the PFN event memory storage. All alerts or emergency conditions flagged generate a permanent copy of all related PFNs for a total record of the event in the mass data unit

In the window for the hard white jogger, the work log section tells the Mill the bale being made for, the blend, the approximate brightness, the total tonnage requested the purchase invoice and the projected bale being mixed by the Hard White Jogger Belt. The bale number and ID and specification information and data barcode is assigned on three sides of the bale at the baler, when the straps are applied. Clamp operator and clamp machine weighs and prints weight lable which is placed on the ID sheet Strapped on the bale already. The system is updated by the baler PFN communicating with the clamp PFN the bale data and the clamp downloads the weight information to the PFN control center and shipment data or storage placement information is sent to the clamp machine to generate the three stick on labels. The driver hears this from his PFN (audible and visual in the LCD screen) and can edit or change incorrect data or information by working with PFN control and shipping management.

This window 21 is to provide historical record of the settings and alerts if a particular bale's quality is in question so that problems can be identify and corrective measures taken. Some mechanical information is available in this window, but the equipment shop and corporate offices can query the specific equipment PFN for real-time data and the system archive file for further review and equipment analysis. Current and amperage readings are an example of the running information to project motor wear and schedule maintenance. COTS sensors and COTS equipment controllers like Westinghouse, GE and Allen Brady are interfaced with the PFN relay controller initially. (PC104 architecture) to handle motor starter functions and operational controls. The more sophisticated the operation the more operational interfacing. However, the first goal is to recover all data sensed and to enhance sensing to monitor equipment operations and to provide emergency automated and remote controlled safety functions.

Automated mixing and remote controlled operation of equipment for production is the third phase of the progressive development. Automation for safety, evaluate environmental impact evaluation and national security is another primary driving force to technically advance this invention (Specifically Fiber recovery center from the dry trash stream in major cities and ports to commercially provide the wireless network of the PFN/TRAC System and FACT security network).

The bottom buttons allow for the viewer to update the screen change the control functions of the machine, show location and obtain geographic coordinates, print this data on hard copy via numerous printers interfaced, click on a list of video cams and further click on them and obtain numerous real-time views or archival images and close the window and return to the facility home window with all the ID information and data.

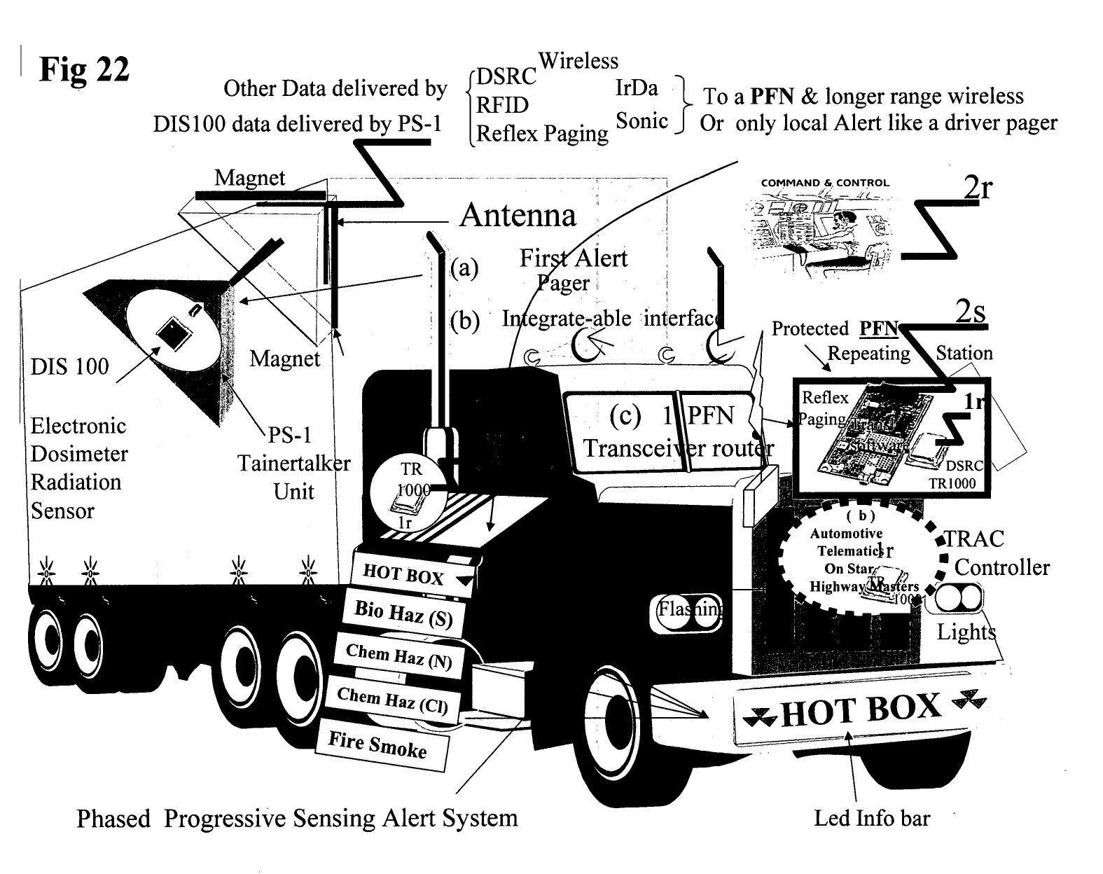

FIG. 22

Is taken from another PFN/TRAC System application and the reader is asked to understand the use of wireless communication and machine control employed of refuse vehicle and recycling equipment.

This figure shows the HOT BOX 1Ps HS1 “Tainer talker” unit in the container with the container on a transport carrier and a tractor pulling it. In this instance the radiation alert signal is delivered by a dedicated short range transmitter the Monolitics TR1000. Other technologies like RFID, Reflex paging, infrared IrDa and even sound, ultrasound or acoustic signal technologies could be utilized to deliver the radiation alert signal the short distance from the trailer to the tractor or to another appropriate receiving unit in the PFN/TRAC architecture (to be determined by Homeland Security/TSA).

In other filings there is a progressive commercial development for the 1Ps HS1 “Tainer talker” unit to communicate with the responsive counterparts operating in connection with the PFN/TRAC system to provide FACT access and sensing in closed containers. The three steps are done to expedite the deployment of inexpensive container sensing locally first at the prime mover level; the truck, the crane, the forklift and with the inspectors and workers (also prime movers in the transportation flow). And then expand the capacity of this same technology with out the need for complete replacement of products to achieve greater sophistication in remote reporting and the quantity and type of data recovered while expanding the distance and amount of remote sites linked to any specific FACT incident (as determined appropriate for HS).

Initially, the (a) lettered embodiment will utilize the Dedicated Short Range Communication DSRC Monolithic's transceiver component in both the container portion and the tractor or prime mover receiving section. The first version will transmit a simple alert signal triggering a flag in a basic program running in the STAMP computer (or comparable micro processor or mini computer and software) in the container due to the DIS100 sensor registering a radiation alert level. This alert signal is received by the pager or beeper located in the center of the figure by either a simple receiver or TR1000 transceiver. This first pager unit can have the same power supply and micro-processor with a red led and audible beeper to quickly meet the volume of containers, prime movers, in ports, airports and inspectors and machine operators handling and checking for dirty bombs.

Note: The above portion was written for Homeland Security and normal trucking, however the HS1 is a PS1 wireless sensor array for hazmat and bio-hazards as well as radiation. These sensors are planned for in the recovery plant and vehicles and for them to send their signals short range to the E-PFNs and 1SV PFN relay stations in the tricks or stationary equipment to report alert signals long distant to the various control centers both commercial and for national security or public safety.

Later versions will have a universal code word and symbol for a contaminated load and the nature of the contamination. This is part of a FACT universal Emergency Action message vocabulary (established in related PFN/TRAC/FACT filings). With a universal communication of (EAM) messages for first responders in the United States and around the globe a uniform inspection process and framework to structure first response procedures and protocols an be built to respond to via the PFN/TRAC system. Additionally, as discussed earlier the range of the wireless and the bare tipped antenna will provide a probe function for the hand held beeper to further discriminate the a specific contaminated container. As stated earlier the prime movers will have these small RF receiver or transceivers either hand held or interfaced with PFN/TRAC units to determine a hot load and the nature of that threat. Also along runways corridors and storage areas their will be receiving nodes as well as sensing nodes to sound local alerts.

These same 1Ps standalone units will be configured to be connected and interfaced with longer range wireless or land line connections for repeating via the PFN/TRAC unit units to report to the local TSA/FACT intranet and the nations Homeland Security Network of agencies for the proper response to a hot radioactive container, whether it goes hot 1000 miles out at sea, or as the crane lifts it to the dock, or during any storage and or delivery by trucks, or rail. The first and quickest products to market are the 1Ps 1Ps HS1 “Tainertalker” triangle for radiation detection and the (a) hand held 1Ps transceiver pager probe in the center of the page. No installation is needed, other than to place the magnetic housing of the triangle into the upper right hand corner of the container and wear a pager sensor or have one on the prime mover and the detection process is in place to screen for any irradiating materials in the container.

(b) The second embodiment, involves today's existing automotive telematics programs like On Star or Highway Masters for motor carriers or trucks. These existing tracking systems for transport already deliver two way communications and data telemetry and the PFN/TRAC system has been created to take advantage of these and other commercial wireless intranets like the UPS Diad architecture and Fedex package tracking and add wireless interfacing locally for TSA/FACT to protect these workers and the public from hazardous material shipments. Obviously, the (a) pager components can be immediately employed for driver and operator awareness of loads as is done for the seaports, airports, highways and railroad applications. In fact the (a) pager configuration will have a hard wire connectable access pin port for cable connections to attach to these different existing systems and down load this data to the existing telematics and shipping tracking systems. Adapters and wireless interfaces can be constructed for fedex and UPS and will have saddle sockets to connect up the receiving pager to their vehicle units and down load data long distant to there tracking and telemetry centers. This engineering for existing and legacy systems is how the PFN/TRAC machine messaging can support the federal access and control technology FACT with the network interfacing needed for national security and public safety. Ultimately, these components will be integrated and miniaturized into one transceiver section of DSRC and long range communications. This progression of integration with current vehicle telematics is the (b) version and the PFN unit and is termed the Driver Resource Center PFN or DRC PFN.from the 1sv or surface vehicle PFN (b) version is not only the miniaturization, consolidation and integration of these dedicated short range sensing products with existing tracking systems, but also involve a more sophisticated and accountable vehicle management with shared controls to include driver assist systems, collision avoidance, GPS timed movement, remote control and vehicle robotics performed via the protected DRC/PFN vehicle interface. This is a progressive vehicular development of the 1SV Prime mover PFN in private and commercial terrestrial vehicles. In the industrial applications it is the 1SV PFN for surface vehicles. They will evolve essentially the same in the processor and many actuator applications, but differ with wireless interfaces and the intranets they are responsive in. However, all will be responsive to the FACT intranets of Air, Terrestrial Land- Interactive

Note: The above information is more thoroughly detailed in 111248-2200 for those skilled in the art designing the accessories and PFN units for the waste and recovery application detailed in this filling. All industry and material movement has been considered to operate via the management of the PFN/TRAC System.

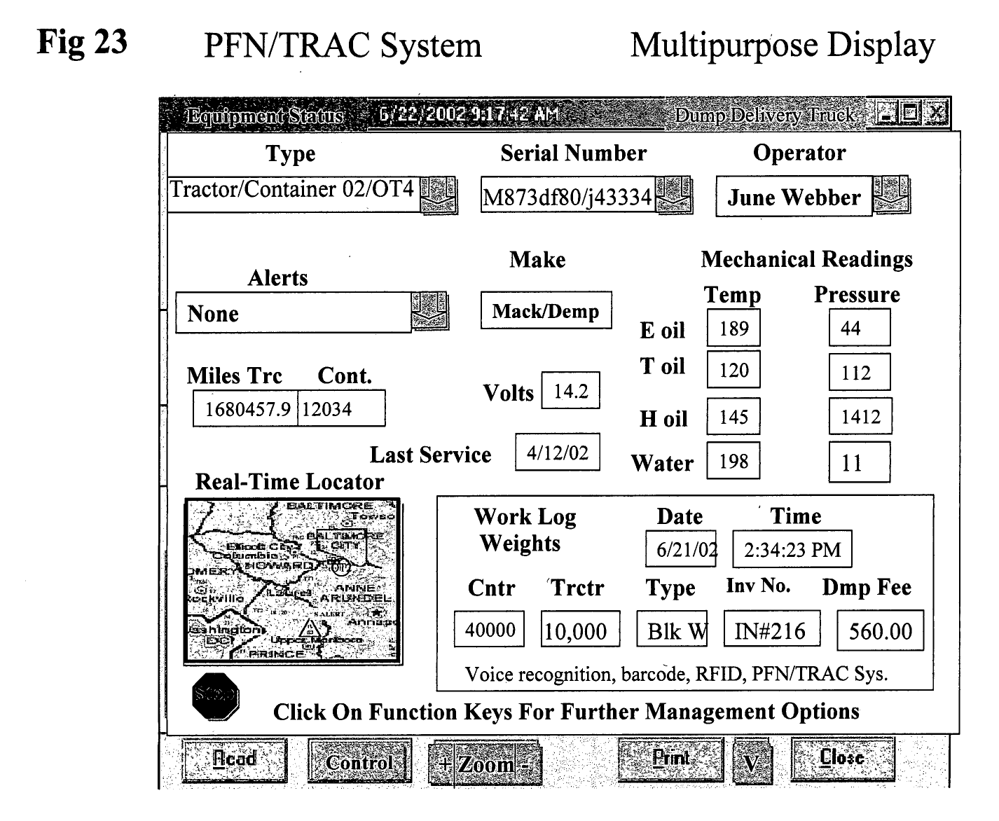

Highways & Telematics, -Rail and Sea applications, are discussed in FIGS. 23, 25 and 30 of this application for the PFN/TRAC system.

The center of the trucks radiator shows the (b) oval with a dotted line of protected enclosure. This is due to the progressive nature of the DRC PFN which will take time to commercialize and get accepted by the public and government and to structure the correct standards, law, rules and regulations governing the PFN/TRAC unit and FACT homeland security procedures/protocols for programming and use. This is well documented in nine earlier patent filings to maintain constitutional freedoms, freedom of movement and public safety with an optimum national security. The oval shows the TR100 transceiver interfaced with current telematics programs and they of course are responsive to the TSA Fact center at the Port, airport of secure facility. This is accomplished by the specific facility or area TSA FACT command and control center having each of these different wireless technologies linked, either as a on location substation, repeater, or a chipset of protocols in a universal antenna/tower transceiver with scanning and routing interfaced directly with the TSA/FACT Intranet local server at the facility or via adequate IP, land line, satellite, or wireless telephony links secure enough to qualify for Homeland security's TSA FACT program (to be determined and standardized).

Recovery Application and Purpose

Most of the time the reporting from truck and compaction container in the recovery center process will go to and stop at the recovery center and hauling company, but because of the design of modular development of the PFN/TRAC system of secure and safe movement management it is designed to interface and create a large portable network to honestly fulfill the nation's needs for transportation security. The recover center is considered an ideal prototype network in every major city that can be introduce with the PFN/TRAC system, and paid for through a city's waste collection and recycling efforts. The inventors believe that government and industry stand to gain as well as every individual citizen, by the development and use of the recovery system and all the related technologies. Once again all activity produces waste including terrorist activities, so the close monitoring of material handled will greatly increase the chances of uncovering undesirable activity.

Note to understand (C) modality: DRC is Driver Resource Center PFN and it is an evolution of the 1SV PFN. This PFN allows a driver to interface carryon electronic devices with the vehicle PFN, and deliver data throughout the PFN/TRAC system.

c) The 1SV PFN is the complete interfacing of multiple wireless technologies in cross applications and the management of their use in cross environmental applications. This application begins with the DRC PFN inside a physically protected docking interface which provides shelves and quick connects for carryon electronic devices like cellular phones PDAs, laptops and smart positioning technologies like GPS. These devices are interfaced via the DRC directly; or by wireless like Blue tooth or 802.11, DSRC(S). As stated throughout PFN/TRAC filings the DRC and the 1SV PFN will be performing drivers assist and vehicle robotics and the management of these carrion devices as a function of being primary focal nods or PFNs in conjunction with the operation of the vehicle.

With this in mind (c) step is the square above the truck's radiator and is that completely protected enclosure that will house both solid state or SOC technology and COTS carryon devices and be responsible for vehicle controls. These units can have the full array of wireless interfaces to receive DSRC communications and repeat that data to the appropriate commercial operational control centers and to TSA/FACT via emergency com-links and the intranet if in the port or airport or on the highways, when an event warrants these responses. 111248-2200 details out the PFN/TRAC system with the FACT federal Access and Control Technology.

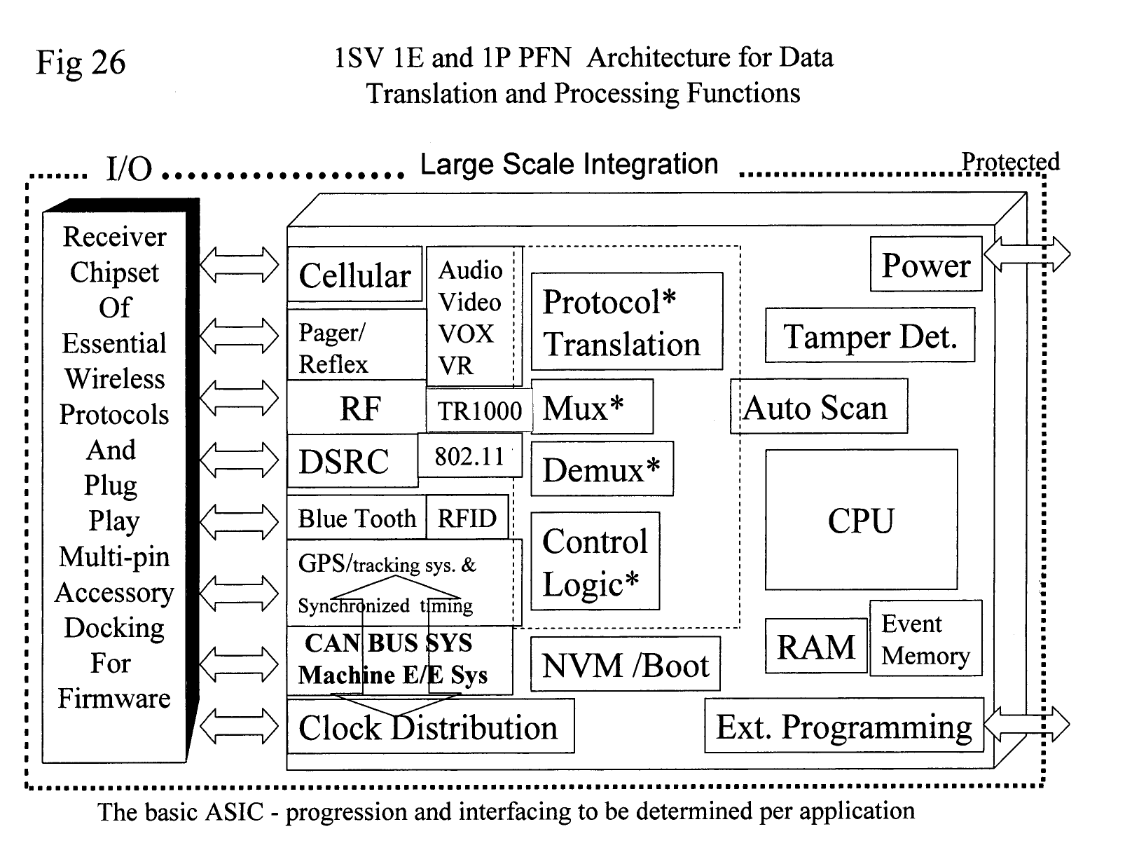

Note: The Primary Focal Node PFN/Trusted Remote Activity Controller TRAC and wireless routing circuit is illustrated in FIG. 26 of this filing for all the PFN units. The hardware architecture varies to accommodate legacy equipment to future equipment.

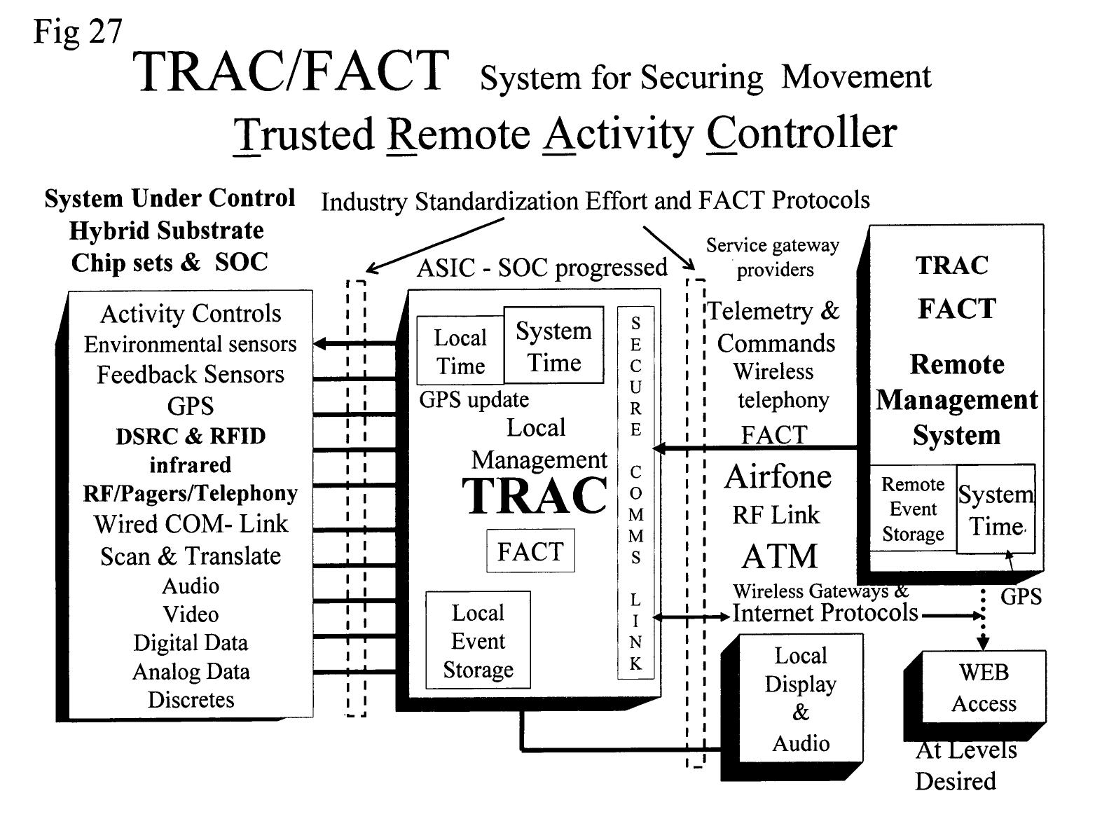

Commercially, the different TRAC intranets will be separated by functional commercial and governmental interests and service. Communication strings and billing are encrypted, private and secure to protect commercial interests, and are thoroughly defined in the various individual PFN related applications. This is part of the accounting and accountability properties that help to commercialize the interoperability of the technology to support a universal FACT matrix of intranets detailed in FIGS. 27, 28 and 30. Business is improved while business material movement is better guarded. And not just for national security, but to find lost or stolen shippments

The basic service in (a) 1Ps HS1 “Tainertalker” (the radiation sensor suit) to the (a) 1Ps pager is expanded to provide various real-time readings from the DIS 100 radiation sensor as shown in figure one's windows display. The cumulative amount of radiation, the time and date of exposure and even the location is recorded locally (via data sharing with the prime mover PFNs) and the TSA/FACT intranet is notified. In the waste and recovery industry the PS1 sensor array will be used to detect hazardous chemicals and bio hazards as well.

The program will provide a scroll function for the operator to read the LCD display on the local paging unit as the progressive embodiments become more sophisticated and informative. Looking down the rectangles of LCD pager alert messages is a bio hazard like salmonella, (which sends a direct alert to public health and CDC intranets as well as police—if this is determined to be a public safety hazard and not normal deciduous waste). The third rectangle screen is a chemical load problem possibly chlorine gas has been generated by a acid spill with pool supplies being shipped together. (In this case EPA and local Hazmat, fire, police, and rescue are all alerted and given the GPS coordinates and a list of all responding units automatically with direct connect communications). Or a chemical alert that detects atmospheric nitrates, saltpeter or sulfur indicating the possibility of explosives, which in turn would cause the prime mover or personal PFN to notify ATF in the FACT intranet and local bomb squad. And for normal emergencies like smoke and fire the 1SV PFN alert EAM would obviously notify local fire and police automatically.

Note: Prime mover refers to any transport or material handling machine such as Trucks, Cranes, Forklifts, Trains or powered rail cars. These vehicles have power supplies to maintain longer range communication technologies to operate the PFN relay stations.

Retuning to the figure, this special local pager will be able to quarry the 1Ps HS1 “Tainertalker” to cycle it's DIS sensor(or any sensors) and all the others interfaced sensors added to the tainer talker (HS1 or 1Ps), to take a new or current reading prior to any action and confirm the internal condition of the contents in the container (compactor or waste containment) prior to opening it or dealing with it. This will also be possible via remote connections and relay data to the prime mover PFNs 1E, 1SV, 1P, DRC PFN, 1A, and 1a,b,c TRACker units as part of the PFN/TRAC system for Homeland Security's via TSA/FACT Security program.

To review these more sophisticated transmissions for reporting throughout the system and delivering telemetry the reader is asked to view the figure and observe the signal (1s) generated by the 1Ps HS1 “Tainertalker” triangle unit antenna in the top corner of the container via the TR1000 transceiver and that this time the signal is received as 1r by the (c) 1sv configuration represented by the solid line square a top the truck's radiator. Inside the square are a IC board and reflex paging transceiver chipset and protocols in firm ware that are written to accept data generated from the DIS100 sensor and modulated as packet data on the DSRC TR1000 signal 1r to the TR1000 transceiver, which in turn is plugged into a multi-pin interface docking receptacle on the IC board to allow for the packet data to be processed by the microprocessor or mini computer in the PFN on this same board. (the board and computers will vary by application and as a result of progression) The signal/data/content message is either passed on, translated or sent transcribed respectively via the best wireless available in the interface with specific to address and route identifiers (TRAC/FACT sensitive) to maintain organization in the reconstitution of any signal. This process to manage all the various wireless communications is detailed in the related filings and the focus here is on the specific wireless sensing and FACT system embodiments needed to substantiate and describe the communication process.

At the bottom left of the figure is the proprietary info-bar that may or may not be utilized as determined by the appropriate officials. This innovation was introduced in earlier PFN/TRAC filings as away for proximity drivers to communicate on the road LOS line of sight. It is being updated to include lighting with leds for less current demand than the earlier scroll bar implementation. If determined advantageous to public safety this info bar scroll sign either driven by programming running in the PFN (micro processor) and responsive to the 1r signal would display the same sign as displayed on the operators pager for the local public to view and respond to. This could also be terminated from local or distant remote signals. (the use and application to be determined for this technology)

The protected prime mover PFN of a prime mover translates and repeats the signal from the 1r TR1000 transmission to the 2s Reflex paging protocols with the appropriate ESN identifiers from the PFN added to the new 2s packet signal configuration sent to both the local and remote TSA/FACT control and command centers for the specific Intranet and through out the Homeland Security matrix (communication Unix and PC based IP). This could also be sent directly to other TSAC FACT intranets like Air, terrestrial Highway systems, rail and sea for immediate response. Additionally, the appropriate first response personnel are alerted (the appropriate notification response procedures and protocols need to be identified).

Other RFID, infrared IrDa, laser, acoustical as well as reflex paging have been thoroughly covered in prior related patents. The signal generated by the DIS100 sensor employed in the 1Ps HS1 “Tainertalker” would have the appropriated transmission technology and the PFN/TRAC units would have the appropriate receiver/tranceive/reader/counter part to complete the communication link. The correct physical alteration would be done to the container to accommodate the operational use of these technologies and their components. Additionally, the I configurations illustrated and described are not the only forms the invention can take. Any necessary configuration in structure and electronic sensing technology are all within the nature and scope of the invention.

The box above the front grill is indicative of a physical containment and these application specific configurations are well documented throughout the PFN/TRA patents). In this case the 1SV PFN houses s a circuit board with reflex paging and the TR1000 transceiver shown to the right. The data signal is then translated via the interfaced processor and repeated by a longer wireless such as TDMA, CDMA or analog cellular pager technology or Radio technologies to the appropriate internets. This is illustrated by the 1Ps HS1 “Tainertalker”s DIS100 Data signal (1s) at the top of the figure being transmitted and received by a TR1000 transceiver unit as (1r) in the PFN square enclosure that is protected, specially sealed and secluded in the tractor portion of the truck. Initially, the gray square and all prime mover PFNs will begin with a local alert, that will connect into the E/E Bus system of the machine or vehicle transporting the container. In the case of the truck in the figure the 1Ps alert would make this interface with the J1939 automotive CAN bus via OEM software and connections to activate the emergency flashers sound horns etc, and light up the proprietary INFO bar visual message displays with different preprogrammed messages via firmware and responsive to the 1Ps HS1 “Tainertalker”'s signal. Additionally, the accessories could be directly connected to the mini computer like the STAMP I or II and or automotive processor (Motorola or Delco Micro processors etc, automotive hardened or rugged zed).

This local responsive 1Ps Pager alert, —option (a) in the figure is for the tractor prime mover visor or the driver to carry and for the technology to obtain immediate deployment of the 1Ps HS1 “Tainertalker”. Many first applications will be self powered and produce their own alert light or beeper sound and look like a beeper or pager unit. They will attach to a visor or be worn by the driver (The hypothetical unit is shown left of the in vehicle tractor.

These pagers can be plugged into the vehicle's power system to recharge their power supplies (lithium rechargeable or AA. Additionally, as a progressive interface they are forward engineered to connect up with existing telematics providers like Onstar and Qualcom to deliver their signal to remote locations, either by cellular, or RF isolated intranet ties into the FACT network or other PFN/TRAC products via direct connect and wireless readers.

The Recovery Center Application

While this description pertained to a container much more akin to the open top container use in the waste industry, the detection of hazardous waste has long been a public safety hazard for both the citizen and the refuse recycle worker. Therefore these same sensor arrays or ones close to them will be placed on the refuse trucks and prime movers in the waste and recycle industry. Because, all to often improprieties have occurred where hazardous materials and substances have been disposed of in the least expensive manner with little regard to safety. This is another example of why cities municipalities and government should license this invention and insist on waste and recyclers to operate under its guidelines and recommendations. The recovery center is the way to process waste material and recyclables, rather than transfer stations and landfills.

FIG. 23

This equipment status window is for an open top container trash truck to remove non recyclable material that has to be taken to the land fill (last choice and for temporary storage). The tractor trailer containers are filled by the overhead delivery belt system number 3 or (B3 belt) that delivers waste to the open top containers or the stream generating incinerator boiler. This equipment window gives the Type of equipment upper left and the specific truck number (02). If a trailer designation is different in the rig description the trailer container ID would follow the tractor ID. This holds true for all equipment windows when multiple equipment identifications apply or are necessary. First the prime mover power transport and then the carrying device.

The tractor Serial number is in the top center box and once again the trailer would be the second serial number ID. Clicking on the down arrows give truck and trailer options for the viewer to see maintenance, license plate numbers and essential data. Both pieces of equipment are to have PFNs which have their own power sources and are recharged via interfacing with the vehicle bus (J1939, etc.) and trailer connector. This allows the specific equipment window and communication with the specific piece of equipment and all on board sensors both OEM and add-on COITS and or proprietary to the PFN/TRAC System™.

This includes wheel scaling via the air pressure fluctuation from an empty state to a loaded state as a real-time axle and vehicle weight reading. These sensors have their software running in the PFN TRAC ASIC (processor) or the COTS processor is interfaced with the PFN processor to complete this function. Translation between the machine language protocols, wireless protocols application protocols and encryption software needed to deliver the data by wireless to the responsive IP computer systems takes place in the PFN processor (ASIC shown in FIG. 20). All sensor applications for weighing, explosive detection, chemical detection bio hazards, elemental mater identification proprietary or COTS is processed in the same two ways by the PFN processor. Additionally local PFNS can process other local wireless sensor technologies received via dedicated short range communications (DSRC).

Similar interfacing of pressure sensors in the hydraulic systems of prime mover equipment (trash pick up trucks, forklifts, etc.) generate signal that correlate to hydraulic pressure and are used to determine loads or weight when raised by these systems. This information/Data is displayed in work log windows. However, this window is displaying current container weight being readied for the dump. Weight data recovered from wheel sensors is run through a comparator program with the dump scale at the facility where the open top is being loaded to evaluate the accuracy of the wheel pressure sensors and slot them for maintenance, repair and or augmentation and recalibration. The later can be accomplished by wireless commands delivered in real-time while the trailer is being loaded on the scale. Other such data analysis takes place via remote control when comparison data is available and relevant. For example the wheel speed and odometer sensors are checked and processed against GPS speed and distance measurements via a comparison algorithm that also compare vehicle and trailer sensors for speed and distance. This comparator program takes place in the PFN and employs COTS programs like Delorme Street atlas or Mageliun, Hall effect sensors and IH interactive highway beacons.

Returning to Present Window View in FIG. 23

Mechanical readings are reported back to trucks service centers mobile units and the corporate offices. Mile of use for both pieces of equipment are available. Current date and time are displayed and any entry typed in by the viewer of a past time or date will present the archival data requested.

Both pieces of equipment paired up are reporting no alerts, the operator is June Webber. Any of the box down arrows can be clicked on to view more information and data windows. The manufacture for the tractor is Mack and if this box is clicked on the second tractor window would give service history and work history as well as, model type (F) etc. and the container information would be similar for service and performance with the manufacturer Dempster and the model and serial as well as, ESN if an equipment PFN is on a compaction container.

Open Top

The real-time located shows OT2 in at the recovery facility and clicking on the identified asset will zoom in on the container. The zoom keys at the bottom of the window can be used to locate an asset and further discriminate it and the location. Ideally a calibrated map is used like Delorme that zooms to 1/16^{th} scale and indicates per NEMA GPS received and PFN interfaced coordinates. This can be created via aerial photographs or satellite captured images APRS Amature Radio Positioning services or COTS like Delorme Government like NASA or US Mapping and graphics with calibrated maps. The first modality in PFN applications is GPS however, the PFN can use radio/cellular automated triangulation algorithms developed in earlier related PFN/TRAC filings.

The work log to the right gives current loading weight the tractors actual weight the type of load, bulk waste the invoice number assigned and the current dump fee per real-time weight.

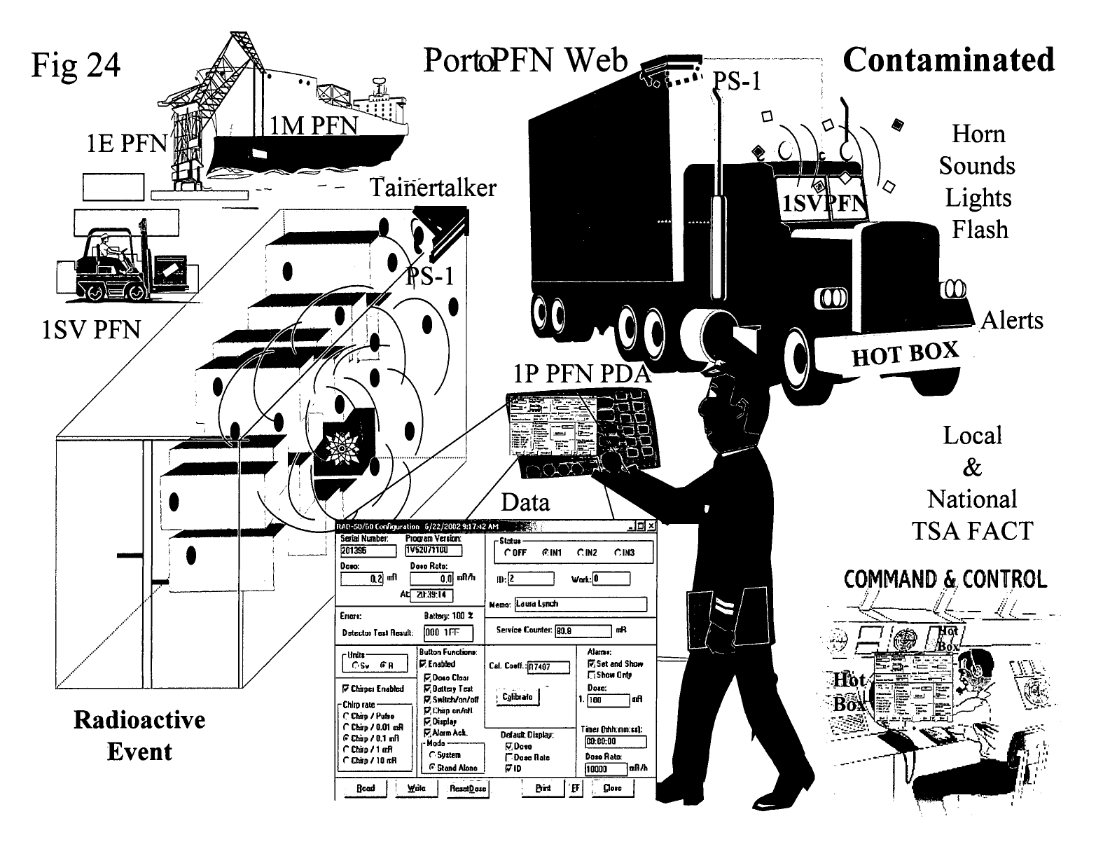

FIG. 24

Figure twenty four uses a port shipping container as an example. The container with this inventions wireless sensor array called the 1Ps HS1 “Tainer talker” HS1 a security version of the PS1 communicates the dangerous nature of it's cargo. A sensor has fired off a signal at a preprogrammed hazard level a public safety and or national security alert signal. This could biohazard, chemical or explosive or a nuclear radiation hazard. On every piece of equipment there is a PFN. A PFN is a specialized equipment controller, protected interface and routing unit (earlier detailed) of multiple wireless technologies to include GPS receiver interfaced to provide positioning data to the event. The many various PFNs use the equipment's electrical/electronics E/E system to provide stable power for the PFN to be a consistent repeater/routing station and reliable remote controller. These PFNS are Trusted Remote Activity Controllers/Routers or PFN/TRAC units on every transportation platform.

The boat in the upper left hand corner, the spreader or crane and the forklift all have different PFN trusted remote activity controller/routers. The boat has a 1M PFN marine unit that has all the marine wireless frequencies, satellite hook ups and smart position technologies like GPS, Lorenz and will ultimately be connected to perform automated piloting with collision avoidance (Detailed in a prior applications). This PFN also has a dedicated short ranged communication transceiver that is in communication with every container and shipping package on board the ship. The dedicated short range communication technology in each container may or could vary and be light/infra red (IrDA), sound/ultrasonic/acoustical, radio frequency RF, RFID or contact and can be supported by plug and play firmware chipsets in the I/O multi pin connector board of the PFN shown in FIG. 4. The obvious benefit to having the PFN architecture is that it provides an interface for all these short range wireless to deliver digital data to longer range wireless and in turn more remote locations with faster distribution. All these wireless technologies interfaced in PFN/TRAC units have been discussed in the ten prior filings. For this reason this application will focus on the dedicated short range wireless Monolitics TR1000 series RF products or comparables and a special modulated packet data protocol and translation process to Reflex pager protocols in the PFN/TRAC units for a terrestrial land and sea repeating and dat routing application. These same DSRC TR1000 data packets will translate to satellite telephony protocols for ocean transport and airborne applications. This filing is to specify a prototype 1Ps HS1 sensing platform using the DIS100 Dosimeter to sensce dangerous levels of radiation and meet the nations immediate need to detect terrorist dirty bomb material. Although the first prototype is for radiation detection it will be set up as a future interface platform to add sensing for bio and chemical hazards as the sensors and their electronic libraries are developed. They will be discussed completely along with the progressive processes to implement them.

The types of wireless are not limited. Other wireless translation processing between different protocols are also possible and within the nature and scope of the invention. Some will be discussed in this application and others have been addressed in the eleven related PFN/TRAC System applications with FACT security. It is possible for all vehicle platforms to communicate with a contaminated container and all will have numerous long and short range wireless technologies to perform this function. If a communication can not be established the container can be isolated for further investigation.

Figure one could be an airport with airport type containers and 1Ps HS1 1Ps HS1 “Tainer talker” sensor units. Or a shipping yard as shown in the figure, or any commercial facility, military base, embassy, installation boarder crossing or compound, where specific commercial and security wireless systems exist and computer intranets are established. These existing systems are incorporated into the PFN/TRAC unit local interface to deliver wireless data to IP gateways for these intranets and also to remote government agency intranets. As depicted in figure one these PFN track units work as a flexible web of security check points. Whether at the port, airport, or boarder a unique asset to the PFN/TRAC technology when in place on all aircraft, material handling equipment and vehicle platforms is that the inspection process, shipment monitoring, and equipment management does not have a chokepoint. Flow is continual with rapid response capability as inspections continue into the country and begin far out for the country's boarders providing greater security and freedom of movement for man, machine and material. Not only will there be PFNS on the boats but also on the crane 1E PFNs and 1SV PFNs on the forklift but also hand held units like the port inspector holding a 1P PDA PFN. Which also represents a display package planned product development for the 1P personal PFN interface belts for authorized workers and inspectors. Additionally, the truck carrying the container to the right will has a DRC or 1SV PFN in the tractor portion of the vehicle which is connected to the vehicles electrical CAN J1939 bus.

The transparent shipping container to the left is an illustration of a container that has gone hot with a radiation leak hazardous to public health. The smaller cousin to the PFN unit, the 1Ps HS1 1Ps HS1 “Tainer talker” unit has a radiation DIS100 dosimeter sensor in the upper right hand corner of the container and has just fired off to trip an alert (FACT Alert Federal Access Control Technology). The dosimeter is taken from a personally worn application for individuals working around alpha, beta and gamma radiation and is converted to deliver it's electronic digital signals to the 1Ps HS1 1Ps HS1 “Tainer talker”'s processor via the I/O pins. The RAD sensitivity is adjusted to a predetermined acceptable safe limit. Any RAD signal generated higher energizes the input pin on the processor in the 1Ps 1Ps HS1 “Tainer talker”—the little black triangle in the upper right hand corner of the shaded transparent trailer left. The mini 1P or HS1 “Tainer talker” unit is capable of recording the event and reporting this signal via the interface TR1000 transceiver to any of the prime mover PFN/TRAC unit's DSRC/TR1000 transceiver on the Freight forwarder's transportation vehicles and port material handling equipment for a longer range repeating process to all relevant monitoring intranets and the TSAFACT network of intranets described in FIGS. 27, 28 and 30.

In the more powerful PFN/TRAC units longer range transmissions are used to send this critical data to port authorities, or airport officials if at the airport, Customs agents, local Police/First Responders, local TSA/FACT command and control centers at the airport or port and the nation's TSA/FACT Homeland Security command center and matrix of government agencies. In the center of the figure a Custom's Agent is viewing a read out from the 1Ps Tainer stalker's second generation unit, a direct progressive improvement from the first simpler alert function. As seen in the exploded view in the forefront of the figure the DIS100 dosimeter's has a capability to generate a cumulative data log over a period of time. However, it normally delivers the data via a chip reader to a PC. In the invention this is possible in real-time and by remote activation to harvest the data via the PC based basic operating program in the 1Ps HS1 “Tainer talker” processing unit and sending it via data packets and TR1000 transceiver to the 1PFN PDA which also has a TR100 transceiver interface. The 1PFN PDA processor has been loaded with a dosimeter application program to drive the PFN PDA display to view the real-time contents of the container and a historical archival record for months of transport and storage.

Here the inspector can receive the archive file showing radiation exposure and exact time and location of any radiation event transpiring during transport, including all others who have inspected the container before. Additionally, the the remote intranets are receiving the same information via 2 way reflex paging. A PDA so equipped with 2 way paging an DSRC TR1000 can deliver data to an interfaced reflex translation program to deliver the data to the appropriate window on a desk top or lap top via code writers skilled in the art. By using and converting the dosimeter product to deliver its electrical signal via modulated packet data on the DSRC RF or in any of the communication mediums earlier mentioned, the exact sensor serial number can also be encoded into the packet, which identifies the transceiver by it's ESN to detect tampering. Obviously, any container not producing a signal or a bogus one is suspect and pulled from the normal material handling flow for further inspection with different security protocols.

In the lower right hand corner is a command and control center. Both, at the port or airport and at the nation's TSA/FACT command and control center. Or at any number of TSA FACT intranets necessary to support the various governing agencies responding to any particular event. The flexible TSA/FACT web is an accountable communication matrix of real-time responsiveness by every agency have first responders in remote locations to aid local first responder with the best and most accurate information. Via the PFN/TRAC system this is achievable for TSA/FACT Homeland Security no mater if the agencies are dispersed or centralized (further discussed and represented in FIGS. 27, 28, 30).

In the upper right corner of figure one is a prime mover truck receiving the signal from the 1Ps HS1 “Tainer talker” unit in the upper right corner of the container on the truck. The horns of the truck could be activated via an electric solenoid air valve on the horns and the lights would flash to indicate the truck is in an emergency mode and an electronic sign with light emitting diodes or led s in the bumper (or elsewhere) could provide an informative sign as to the nature of the emergency or FACT event. Or the truck's PFN DRC 1SV PFN could receive commands not to display a local emergency information and just report data and vehicle GPS location to the TSA/FACT centers.

The PFN/TRAC system FACT security response has been used as an example of how the PFN/TRAC network operates. On an everyday basis the extent of the data and information would be transmitted to the Recovery Center Control room and the major trash hauler operation's center and maintenance department The Recovery data stream would contain customer pickups or stops for the refuse trucks, with the weight hauled, the time of vehicle operated, the GPS path traveled, persons and PFNs logged in on the truck, video and audio recode and notes, vehicle trouble codes and fuel used. The Recovery center equipment will give functional production counts for application, material weight handled, and any equipment trouble codes as well as operators ID and PFN ESN with any data collected and recorded notes. This data will be processed in the same way to the commercial centers with PGP commercial encryption. If city owned or licensed the encryption commercial key codes may well be provided to national security agencies and first responders for all the processes. If privately licensed or owned standardization and home land security regulations would determine the amount of privacy allowed concerning the private handling of waste that may be hazardous as a national security threat or a public safety threat. Private waste handling and recycling has had a poor record for divulging improper waste disposal if they were going to have business slow down because of it and they have charged more to handle it and disposed of it in the regular waste stream as well. And many recycle companies have claimed to perform document destruction and just processed the material into their normal grades hoping that they won't get caught or no one will use the sensitive material. The PFN/TRAC System puts an end to all that impropriety via the material management and tracking from the source.

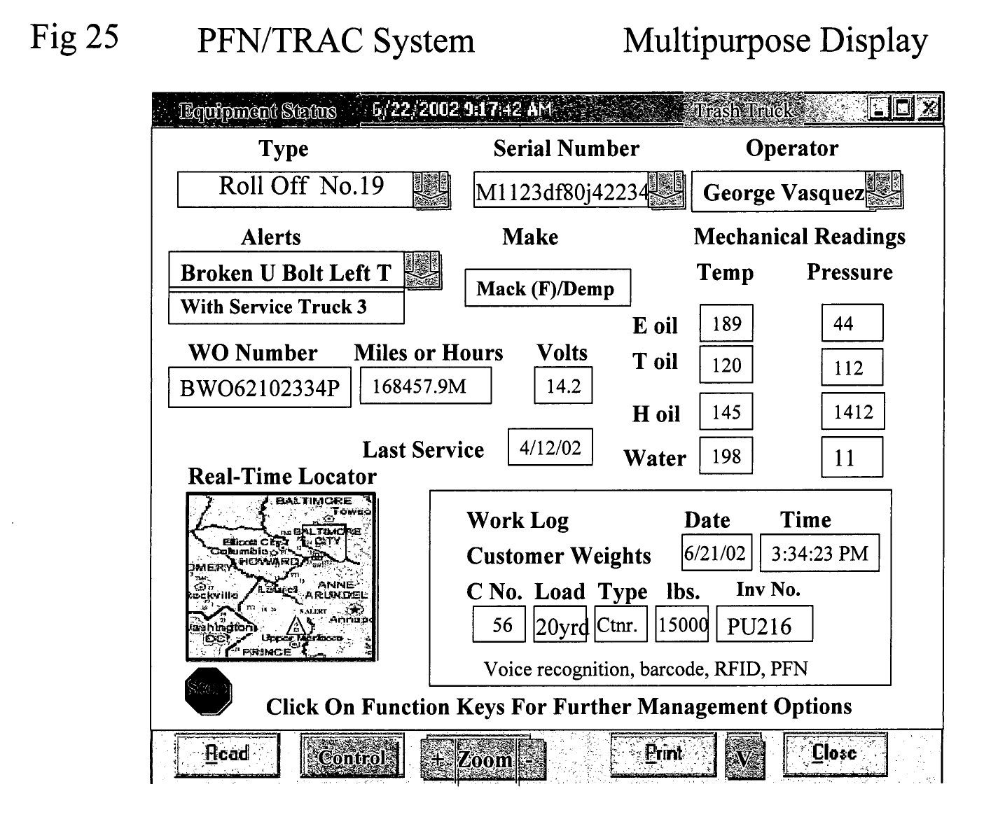

FIG. 25

This window details out the condition of the alert shown in the real time locator video window lower left. In the window for Plant BW1 operations this would be an alert for both, the refuse collection division, or company, but the plant would be advised as well. When this alert is clicked on or any element of this alert was investigated, for example the viewer wanted to locate the employee George Vasquez. The viewer might well have retrieved this window while perusing personnel information and hit the real-time locator window. Further clicks would give real-time views of Mr. Vasquez on video returned by cameras driven and processed by the service truck S3 PFN or the Roll off truck No. 19's PFN camera system reporting contact with Mr. Vasquez's 1P personal PFN locator/communicator.

This communication allows for the positioning of digital cams by the local personnel or remote control of the cameras via servo motors so that the shop and support personnel can assist the personnel in the field with information planning and decision making concerning repair and emergency service or hazardous situations. This Audio and video feed and sensed data streams will be deliverable to first responder networks, state and federal DOT, EPA and the entire homeland security set of networks.

All the boxes in this window with down arrows offer more data window options for the viewer. The alert box clicked down shows the service truck assigned to the broken U bolt and below the WO work order number is shown and entered in a permanent event file (System mass data and unit archival files—removable memory, disks and flash memory sticks etc. for special operational analysis and cost evaluation for materials repair procedure and or emergency response. The WO number is issued by the date and nearest time to the minute followed by the A or P for AM and PM. The first letter indicates the recovery facility and if responding equipment is sent by a neighboring facility the work order number stays the same but the vehicle from the other facility has the facility letter and there appropriate sequential number of the service vehicle.

Another situation is that a service truck may not be available from the refuse repair side so an equipment mechanic may be sent in one their service vehicles. The programmer and viewer will recognize this with the operator/mechanic ID and sequential truck number assigned from the plant equipment maintenance section. Also all vehicles for service and fleet are assigned RFID and barcode asset numbers and classifications as well as, electronic serial numbers and ISP numbers so that they can be read by law enforcement in government facilities and high level security applications maintaining limited and or controlled access.

Vehicle data like miles and or hour use is also shown in a box, and historical odometer readings or use time can be entered to bring up an archival file from past work activities and equipment performance readings. If the desired data is not ALERT event related and prior to the last 10 days the data will be retrieved from system data held in mass data systems (like Sony Peta Storage comparable equipment). All computer systems connected can be queried for the specific data by date and time and specific ID for man and machine. Other regular mechanical data is available for example engine oil, transmission oil, hydraulic oil, and water temperatures and pressures as well as, the last service date where an active archival file is maintained in the local truck or equipment PFN and stored in the appropriate shop and corporate computer systems.

In the lower left locator window the viewer can click and zoom 16 times to the exact street or geographic location with all other company assets or responsive system assets recognized and interfaced for the event, (for example reporting first responder vehicles, DOT, hazmat equipment, etc.) All will have there specific ID shown on the multi asset display for the corporation/service shop and equally represented on the multi asset displays for the appropriate governing agencies.

Operational Note for Government and Industry:

If this unified communication and data linking is deemed desirable and or appropriate with reasonable procedures and protocols to insure constitutional application for cooperation and understanding and not just used as a revenue club or mechanism by government enforcement agencies, then it is being applied as invented for the (PFN/TRAC System and FACT Security Program™). Credits as well as, taxes and penalties must be in place for industry to police itself and abate public concerns before enforcement policing is needed to correct public safety and environmental hazards as well as, provide for the common protection of the public in a FACT homeland security network matrix. While the waste industry has been notoriously corrupt so have government counterparts. The PFN/TRAC System provides a technology to eliminate these improprieties and have a joint effort to answer and solve these real hard hazardous material questions as a community. A community inheriting legacy industrial problems and stop looking to blame and make money on past actions, that have become violations today. With this straight approach, honesty will deliver many of these dangerous materials to the correct recovery process that can safe them and or reuse them in a safe manner or store them safely until such technology exists.

At the bottom is a red stop button that has preprogrammed shut down options for law enforcement and qualified personnel. This is Federal Access control technology provided by the PFN/TRAC architecture on each piece of equipment and controlled by the FACT linked computer network system via wireless commands special procedures and protocols, all of which fall within the nature and scope of the PFN/TRAC system and current innovative application for an automated waste and paper recovery process.

Returning to Figure

The function keys at the bottom are self explanatory and are similar to the proceeding window displays. Also the work log is the latest activity and the site of the U bolt break down in Upper Marlboro Maryland (Crain Hwy Rt. 301 and land over Rd 202 Customer number 056=Company 84 Lumber.) When the viewer zooms in this above location image is displayed with exact placement of the vehicle at the address. And like in FIG. 6 for the plant, video can be brought up by the involved vehicles and personnel so equipped and any interfaced system (for exam[le cameras PFN connected from the lumber company facility security cams etc.)

FIG. 26

This diagram has been used in all the PFN/TRAC filings to show the basic circuit design. It shows the standard wireless interfaces for all the surface applications to include 1SV PFN surface vehicles and the progressive direction of the DRC PFN interface program with present vehicle Telematics. Additionally, the 1E equipment for stationary machines and 1Ps PFN for standalone applications, and the 1P personal PFN processors all use this basic ASIC design. Even the 1Ps standalone unit could be as sophisticated and support as many multiple wireless technologies and route messaging and signal between them as desired. They are to range from the very simple tracking operations and ID telemetry to extremely sophisticated robotics processing and communication routing. However, in this application the focus is on their role as supporting substations or repeaters for the 1Ps 1Ps HS1 “Tainertalker” unit.

The ASIC in FIG. 26 may appear the same in wireless interface but differs by machine application and control function. A distinguishing characteristic is their power supplies. The 1E PFN/TRAC is energized by AC house or building current which is transformed to computer control voltages and service current to drive silicon relays, motor starts and high/low voltage solenoids or the PFN is interfaced with the host's electrical/electronics or E/E system to perform remote and automated activity controls. The 1E PFN controller routers are used on stationary equipment applications in and around the airport port, rail station, seaport, toll both, inspection station, boarder crossing, facility, installation, or base etc. To interface and control stationary material handing equipment like conveyor belts, gates, scales, explosive detectors, scanners, forklifts, cranes, escalators, elevators, lifts, compactors, scales, scanners, metal detectors, ID systems, card swipes, barcode readers, baggage handling systems, automated ramps, pumps, transport blowers or vacuum systems for grain, spice, powders or dry good, lighting systems, video units, digital and analog and also receive weaker signals from the 1Ps stand alone PFNs and other PFNs and repeat those lesser signals via the PFN/TRAC System with special priority and conditioning through resident FACT programming.

These PFN/TRAC applications are will documented in prior PFN/TRAC related filings. The circuits and the specific accountable remote control functions are detailed more extensively in the earlier filings. TRAC and FACT routing is the main focus for this application, along with minimal signal sensing and repeating. The figure has darker shaded squares and a lighter shaded larger areas from the center to the left generally. These darker areas are actually deep red in color and the lighter shaded ones are a powder blue. This is to emulate a secure communications characteristic much like that used for the military's high security encryption protocol DES, which stands for Data Encrypted Standard. DES circuits are what they call orange and blue or red and blue. The red is generally an isolated hardware circuit and with special encrypted software and the blue is for less secure data and maybe encrypted in PGP pretty good protection or with no encryption at all. MA military application PFNs are planned for and the actual decision for an specific isolated circuit and DES encryption per is still to be determined.

FACT software development will require ARL Army Research Lab and DARPA Defense Advanced Research Programs to be involved in the development of the Federal Access and Control Technology program. The implementations and process are taught in this application. But do to the sensitive nature and the hierarchy of government agency interaction DOD/Homeland Security—must take the lead with Congressional and Presidential approval and in conjunction with the intelligence agencies perform the final construction of the software program stacks for the FACT Application. They must assign the unique system identifiers for each agency, as well as, create the key codes and write the code in Unix and other PC operating software for the wireless routing to implement the procedures and protocols for specific agency interaction as will be determined for each FACT event. And these codes along with master commands have to be stored like the nuclear launch codes as they can control all the movement of material machine and humanity in the United States. This teaching and the ten related filings lay out the options and the innovative embodiments to implement any choice as well as, detail the hardware and software in existence and the progressions to combine the existing systems to maintain agency sovereignty, while developing a coordinated Homeland Security Matrix.

This discussion continues the progression to get there to implement FACT links for rapid sensing and to deliver rapid accountable remote commands back to the Prime mover PFNs. Not much time is spent on what automated response are possible as these have all been well documented in the earlier filings. The focus will be on this flexible circuit that may be completely created or just in part for an PFN application to complete a portable sensing network. A variation of the ASIC can be on any kind of prime mover or piece of stationary equipment.

A prime mover is a vehicle, boat, plane, person, animal, object or stationary piece of equipment. Other than a person, animal and some objects most of the PFNs are attached are powered by their host to provide a stable energy source to perform reliable consistent PFN routing Trusted Remote Activity Controls. To operate as a relay substation the primary focal node combines wireless technologies with translation modulation and programming between the wireless protocols. Where systems are to disparate and where more complete Human Machine Interfacing HMI is desirable or needed the unit can run the universal transcribing EAM messages(detailed in an earlier related filing). Obviously as the PFN/TRAC system becomes more accepted as an interface platform movement management and security will be more refined and defined into a standard for the two types of machine messaging TRAC and FACT. The purpose of the invention is to create the mechanism to evaluate and progressively achieve universal messaging across applications and industries in an effort to coordinate safe and secure movement of machines and people on or near the earth's surface.

Intercommunication

E.g. 1SV PFN will have all the same wireless interfaces to interact with the airport, 1P personal, PFN PDA, or 1P PFN Belts or 1E Metal detector PFN and these DSRC/Reflex Pager 1Ps units. Wireless will be linked in a geographic sub intranet specific to current management and security present which will include many inter modal transportation services as is the case in New York. Where the New York Port Authority operates all the ports, bridges, tunnels, light rail, to include Kennedy and LaGuardia airports. Initially, security, customs, INS and first responders/police/fire Port and Local with special expertise would be all linked via translating wireless in all local PFNS as needed via FACT programming. In figure four the RED blocks (left) for RF,the cellular CDMA,TDMA, iDen shareware and the DSRC blocks would be linked. DSRC or dedicated short range communication includes, light and sound technologies interfaced for signal translation in communication applications and to perform local remote control as well as the short range Radio Frequency (RF) like the TR1000 transceiver. Many other responsive RF units can be used and the Monolithics TR1000 transceiver for local remote control and sensing in this filing is used to demonstrate feasibility and teach the PFN/TRAC system. Additionally, both voice and data could be streamed simultaneously and TRAC/FACT communication routing would provide the translation or EAM transcription process between the wireless protocols (wireless Presently to be Unix based+the different wireless protocols).

Homeland Security

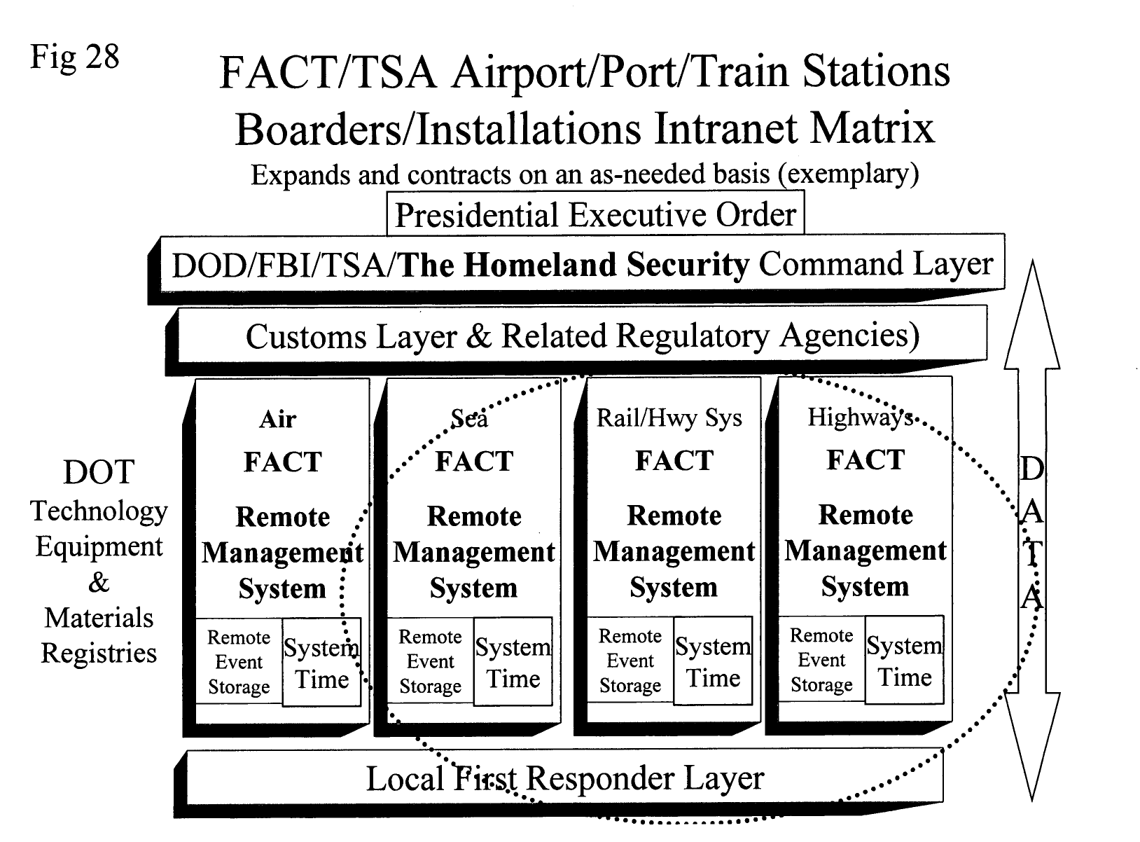

TSA/FACT control nationally could view a read out from the hot container in New York harbor and when Local fire, police and hazmat specialist were dispatched the DOE, NRC, and EPA specialist crucial to good backup would be immediately in the loop all able to view and asses the local response and condition and help locally and evaluate nationally the importance and significance of the FACT radiation event. This process is further discussed in FIGS. 27, 28 30

The Trusted Controller

Is a multi-pin connector/interface to connect the automobile CAN bus and drive OEM actuators and accessories, retrieve data sensed and provide service power to control activities on a vehicle. This is to be a modular programmable connecting of components via universal docking and processing firmware via hybrid chip set connections (shown left as a block in the drawing). This multi-pin connector may vary per application, but a general progression will be to accept these hybrid chipsets in a universal plug, play, and program modality. That is monitored locally in the ASIC's memory via FACT programming by performing periodic inventory checks of interfaced electronics and at the National level in FACT registries which is detailed in earlier filings. The firmware protocols for integration and interfacing between the various wireless will be Unix/the specific protocols programming with special routing determined by the FM for homeland security. Translation and routing stack for FACT to be instituted by the commercial wireless manufacturers and service providers.

FACT is to be a tax supported security system (like the present 911 public safety system or NENA program). Additionally, FACT will interface with these systems detailed and shown in FIGS. 27,28,30 and through out the related filings). Most all wireless devices at some time will be interfaced with PFNs during their service life. Also, Landlines and other electronics will be interfaced as well. During this process their interfacing will by recognized by the FACT system and these interfaces will be recorded in the local memory of a PFN/TRAC unit and intranet registries.

The cost of the FACT system is supported by sales tax on these devices for the life of the device, as they are interfaced with the system and by Homeland Security funding (This is discussed further in the earlier related filings). The regular TRAC routing is to be set up and paid for by the commercial service providers commercial pre-arrangements with customers. They will use the packet data to track their system use handling the transmission via applying proprietary code to the data streams and asses the value for use of equipment and service rendered (an automated accounting process). This begins with recognition software located in the local extended TRAC memory of the local PFN/TRAC unit (The lower right corner box labeled Ext programming). The data packets are conditioned with the appropriate codecs for the correct routing service program sold the customer and pre arranged lease agreements insure good wireless coverage and completed transmission (rates standardized by government and supplemented to insure good consistent coverage for FACT.

This process in at the distal PFN TRAC unit initiates the billing process and applies the billing protocols. Both, wireless and GPS timing are synchronized to provide accountable routing of communication and to coordinate physical movement can be managed more accurately from a stable protected interface platform like the PFN/TRAC unit. This stability for reliable service relies on stable power and emergency backup, both of which are inherent to the PFN/TRAC architecture.

Power sources, type, and transformation to energize the processor and recharge the emergency power vary greatly but all power requirements are designed for uninterruptible service and completed operations. This is necessary for the ASIC to be trusted and accountable in communication routing and command and control functions. These units on individual vehicles and equipment operate from a protected enclosures to provide the stable relaying platform to form a portable routing network for FACT. In vehicles applications alone power is to be transformed from 12 volts DC to 48 DC volts DC as a general rule to operate the PFN/TRAC processor at electronics at computer voltage levels of 5 vdc. The circuit concept is the same for the 1P and 1Ps standalone PFNs but the level of complexity varies immensely and is explained throughout the filing. The six squares to the left in the ASIC (or in RED) represent the interface protocols from the various wireless communication technologies that could be connected in a plug in hybrid substrate chip set multi-pin docking connection in the left block and can be changed to meet the application specific need of any specific primary focal node or PFN application and or by customer discretion However, all have FACT protocols and electronic identifiers (ESN, etc ) chips firmware or software programming installed. This includes all electronic devices and components, plus carryon devices to track wireless interfacing for a secure set or wireless technologies to operate safely and securely in the nation. This drawing is exemplary and is not meant to limit the amount or types of interfacing possible with in any PFN/TRAC unit. This is wire the minimal wireless sensors like the 1Ps HS1 “Tainer talker” are 1Ps Mini PFNs

This ASIC shows a CAN Bus interfacing. If used for automotives today this would include J1850, 1939 ISO interfacing and any of the other new LAN Vehicle Bus systems are included as well. Local clock time is updated by the GPS—Satellite and or synced with the interfaces communication technologies to insure interoperability in messaging and control of vehicles and machines on or near the earths surface. Tamper detection is an earlier FACT integrity check procedure detailed as a security protocol in earlier related filings and has been applied to these greater PFNs. All that electronic and physically detailed protective and tamper detection measures detailed in the earlier filings for these PFN/TRAC units are claimed as inherent to construct the same secure protected enclosures for these smaller less capable wireless sensing nodes.

Most all is self explanatory in the circuit design to those skilled in the various arts of telecommunication and computer design and programming. This figure is the larger more capable PFN/TRAC unit for wireless routing and machine control however, a PFN can employ all or a lesser amount of these wireless interfacing computer processing, memory storage, interfaced activity controls or accessories and be configured in any number of physical hardware configurations and be considered to fall with in the nature and scope of the invention. And the PFN invention can interface with other wireless technologies to complete the FACT Security matrix and perform commercial PFN/TRAC messaging. Additionally, It is understood that a system embodiment is to consolidate PFN hardware via SOC technology and this event is within the nature and scope of the invention.

Many types of encryption are available today (PGP, DES, the wireless payment industry has more as well. FACT is to be a security program format with special code to be written and the types of codecs and encryption standards for high national security, commercial interfacing and private security interfacing as well as accessing public statistical data protocols have to de determined legally first. Additionally, RF frequencies will have to be refined and defined for certain applications with an effort to maintain free enterprise and product choice to protect the public's interests. Much will have to be approved by FM and FCC law enforcement agencies and other crucial government agencies and departments as well as gain industry approval via stands efforts.

As stated, the technology is to be constructed as a multitude of modular configurations to support the necessary options for interoperability of normally disparate wireless communications and refine and define the best combinations of these technologies for specific applications to achieve efficient movement management that is safe and secure. A Most important characteristic of the technology is the capacity of the technology to interface with present, legacy and future systems and to consolidate combine and link circuits and systems to be refined into future SOC technology or systems on a Chip, more sophisticated, capable and miniaturized. The real-life COTS to SOC testing and immediate accountable use is another important implementation characteristic in this inventions design

Other Interfacing in Figure Four

RFID Radio Frequency ID technology like (EZ pass) can be used with the PFN/TRAC units to track the movement of materials by the prime movers. This technology has passive and active tracking products and their incorporation and interface is to provide the widest possible options for the public and still provide greater management in material movement, transportation management and security as fast as possible. Blue tooth is another broad band short range RF technology used to interface wireless telephony products with telematics. Both of are shown in the figure as possible interfaced wireless. The RFID would have the appropriate antenna configuration or special reader component connection with the appropriate firmware chipsets or deliver a usable signal (IP or standard wireless packets).

All these technologies wish to advance their application and use. They therefore offer experimenter/developer or prototype kits and product specification sheets for those skilled in the art to construct the appropriate hardware/software configurations to deliver any data to a higher level translation algorithm in the PFN processing stack to transfer messaging between the different communication protocols. Some programming is already written. This is wireless and cable standard packet data transmissions for fiber optics and hard line routing for IP data transmissions. These existing technologies along with the electronic payment industry and wireless data packaging can have their software programs interface at a higher application level with Unix software (one option) by those skilled in the art of computer programming. The resident PFN software stack and synchronized clocking offers a good environment to locally establish a common system harmony for data transfer. The PFN would reprogram it self via firmware installs (plug and play to communicate with the resident FACT/TRAC OS program and communicate with appropriate national registries upon login of new installs and periodic integrity checks) for approved use of any new wireless device or component. This would also set up the commercial TRAC communication accountable management program for wireless billing service. Create a is a protected local controller/router that is a universal interface platform for multiple wireless technologies and machine messaging protocols via the PFN/TRAC unit ASIC. Additionally, programming and then implementation installs a traceable routing of data messaging through the distinct command headed of the data packets. The command string program would track, identify route and confirm transmission to account for wireless use for automated billing and for accountability in sensing, material and equipment condition and controlling movement and use of equipment, to include people's activities in real-time. (e.g. aircraft and luggage in the compartments or containers on rail cars, ships and trucks.

Center Red or Darker Blocks Short Range Communication Functions

Each PFN/TRAC unit on any machine, vehicle/aircraft and or equipment will be master and control all other carryon wireless by design, Via DSRC, 802.11 or blue tooth

The exception is the carryon 1P PFN Belts or PDAs operated by authorized operators, drivers, pilots, sea captains, police sky marshal, customs boarder patrol etc. These authorized Personal 1P PFNs can control local wireless and communicate with all the equipment PFNs with special real-time authorization and procedures otherwise the control defaults to local robotics and TSA/FACT Intranet control/Homeland security Command and control

The PFN or series of PFNS on board a piece of equipment vehicle/aircraft, vessel would work in harmony to identify the carryon device's via (ESN recognition and look for alerts) as well as manage their use or restrict any such use to include cellular phones and other so equipped carryon wireless as determined best for flight safety. As part of this invention's nature and scope these SUC technologies and system's engineers would write code into their software programming to immediately transfer all PFN/FACT directives via access through any cellular service that the cellular phone service was part of for emergency action messages or EAM message delivery onto the surface IP/TSA FACT gateways as illustrated in earlier related filings. E.g. in an aircraft this could give a continual down feed of identifiable data packets and information for a troubled flight to surface receivers and event memory receptacles or satellite connected Air Traffic Management data receivers and data repositories for further resources flight telemetry in real-time and for later analysis via the TSAFACT intranet mass data handling and registry storage intranets.

The above paragraph is taken from an aviation application filed earlier for the 1A aircraft PFNs and the passive 1a TRACker carryon sky marshal unit. The wireless data links are different of course (CPDL STDMA VHF VOR and ATM programs) (Tracker also uses the GTE airfone technology to return parallel ATM data to the surface for the long distance transmission. But the TRACker and 1A PFN are designed to receive the DSRC, Blue Tooth transmissions 802.11 and RFID type communications for local sensing and to control wireless devices, while the aircraft is in flight and to take advantage of the carryon cellular devices to deliver as much data to the surface in a troubled FACT flight scenario. Basically, this ASIC PFN/TRAC platform is the same for all applications and performs the same kind of interfacing and routing function for wireless, the lesser standalone sensing nodes and serves to deliver accountable robotics and remote control commands to specific machine platform through appropriate programming.

Special arrangements with the wireless providers to operate secure gateways into this IP TSA/FACT security matrix for Homeland Security have to be arranged to construct the FACT system as shown in FIGS. 6 and 7. Additionally, the initial plan calls for the use of Motorola's Reflex paging protocols and heir service providers around the worlds for the basic machine messaging, both for updating the PFN/TRAC telemetry and tracking of materials and product and also to put in place special FACT security programming at all the levels processing the Paging data. In the local PFN, the local paging service server/routers at the towers to route GPS disperse the data to go to the appropriate first responders as well as, all the specific TSA/FACT related intranets both commercial and governmental. This technology is planed for to deliver much of the normal terrestrial land data to the different commercial businesses (inexpensively) and all those servers will have FACT programming loaded into their computer system. Figure six shows how all these intranets are tied together into a responsive FACT matrix. Every portion of the processing from the local PFN to any specific server is monitored for a FACT event. FACT events can be automatically initiated via preprogramming throughout the system and an alert can be generated by any authorized personnel. Either, government or private industry people, through out the process and function much like a fire alarm with the location given to First responders and national monitoring system matrix determined in real-time per the nature of the FACT event (the different government agencies needed). The FACT alert and what the alert is for is all delivered to all the appropriate intranets and terminals (agencies). Special procedures and protocols are then put into action in real-time (immediately).

The cellular services available will be known Immediately when a FACT event has been Flagged via the descriptive data packet transmitted through that message cycle. If cellular is an option, the cellular service will be utilized via direct connect with a handoff to first responders and TSA/FACT Security (Local, Regional and Nationally) from regular wireless and internet routing to be available for direct connect accountable remote control of the Prime mover PFN. (procedures and protocols need to be determined for each FACT scenario and the manner in which tic technology can best be utilized).

Cellular systems like CDMA, TDMA Nextel share ware, Motorola's iDen technology and service providers will be ask to provide proprietary key cods to ARL and DARPA as well as provide their security military contractor divisions to help set up the TSA/FACT routing stack for the their respective wireless protocols. The service providers will implement the FACT system programming either by installing download disks or IP downloads. All commercial intranets will receive government updates and agency alerts from time to time which intern are delivered to responsive PFN assets for that specific intranet. General alerts can be up loaded to the FACT layer in all wireless service provider's system servers and delivered to all individual PFNS as FACT alerts for rapid local responsiveness. e.g. FBI—sends out an EAM message of a package with either a; identifying bar code, RFID signature, or RF ESN, because it is suspect as a public health hazard—all automated transport systems and delivery companies as well as, companies with automated receiving and material handling equipment with scanner/readers/receiver arrays would compare all processed packages with in an arbitrary period of time and check the processed archive files of packages for the FACT alert Information and a match. Public media, the web and local PFN displays as well as system displays and public media would have images and text describing the hazard package in a windows format for human interfacing with this FACT event. This could be sent from the FBI terminal located anywhere and be delivered in every location in the country in less than a minute.

Agency Intranets

As already detailed the software and key codes will have to be constructed by the most secure of government departments (The Department Of Homeland Security and The Department Of Defense DOD for the DOT Department Of Transportation's Transportation Security Agency TSA). Other law enforcement and security agencies will have to be involved as well and this initial group must be determined. This National security task force via ARL and DARPA, etc will provide all other agencies in government; national, state and local with their agency identifiers and programming construct to enter the TSA/FACT general operating system for; roadways, railways, sea, and air. National to local structure is left intact e.g Justice department/FBI still operates their Uniform Code of Reporting UCR and their Incident Based Reporting System through the individual states and down to local police forces of a 100 or more, however the data is compared to Homeland Security TSA FACT downloads at each level to havest data that is relevant. (Earlier related filings describe the automation of the FBI's URC and IBRS in a FACT program termed Spider Eyes that automates the local reporting process directly in real-time via the PFNs 1P, 1SV DRC PFN interfacing with existing police computers and wireless systems. Data captured in real-time would include audio video, ID and sensed data that is affixed to the regular text reports in an electronic file. The text portions can be constructed via voice recognition to text algorithms with actual verbal and audio files generated processed in the responding PFNS that post these electronic files throughout the system. The report files would be immediately processed and available with controlled and accountable access and further processed with preprogrammed existing codes to be disseminated as non descript statistical data and or special public safety and alert data.

Other national agencies would also continue their existing network connections of regional/state and local operations, but implement their specific FACT programming with identifying encrypted monikers that would also be responsive to Homeland Security's TSA/FACT air, rail, road and sea intranets for immediate security operation needs. E.g EPA and local hazmat jointly and simultaneously respond while the Intranets evaluate the event and the response required for further safety and security implications. This is also detailed in previous filings as the “Green Eyes” program that employs all prime mover OEM sensors and special accessory sensors PFN interfaced and responsive to any of the FACT alert programs running in any of the units and detecting dangerous chemical, bio and nuclear hazards. All agencies like The Department of Energy DOE, NIST, NRC, EPA and CDC the Center for Decease Control, would have their interactive FACT programming evaluating data harvested specific in nature and generally that was specific to other FACT threats. The FACT Homeland Security Command and Control (civil operated along with DOD would process all FACT events and update real-time reports with a geographic and time coordinate map of current and relevant FACT events with additional agency codes and information added to all FACT intranet data bases like the automated FBI UCR and IBSR. Data packets and files are to be accountable down to the personal and agency level with the proper identifiers and agency monikers installed where data is originated, accessed or activity is implemented. This includes computer terminals and their ISP and all the PFN-ESNs or other wireless responding

Some responses to the FACT threats could be scripted and preprogrammed and others unknown would be programmed as they unfold with all the agencies interrogating the same data pool in an interactive process that continually up dates data. This process takes advantage of all data bases and artificial intelligence and human intelligence by presenting and quarrying the individual agency systems for specific threat analysis in their fields. Other stations would quarry other interfaced data bases for probabilities. All access is tracked via the agency ID code and the specific authorized identity and integrity checks done in real-time down to an individual level.

The information on the PFN/TRAC ASIC with FACT security applications are instructional as to the most ideal modality that could be employed in the optimal handling of waste and recoverable materials. The PFN/TRAC System technology to be employed as a national system or governmental system requires special licensing by the inventor Richard C Walker, however any part or portion of the management and or security system used in any form to perform the processes detailed in this filing requires special licensing from Richard C Walker and any other electronic IT and or wireless data recovery system or interfaced systems fall with in the nature and scope of this invention and the PFN/TRAC system invention and Requires special licensing from Richard C Walker.

FIG. 27

The Trusted Remote Activity Controller/router begins in the PFN interface and initially provides local vehicle or equipment control with event storage relative to the specific equipment it is attached to and memory storage for FACT events. This automated process can be the initiated from a local PFN that flags a FACT event via resident preprogramming that has been installed locally and physically or via IP and wireless packet downloads (All changes have to receive system integrity checks before local programming will accept installs as valid and complete programming or authorized changes). A local record for all FACT events is kept until the governing agency and or Homeland Security deletes it or recovers it and stores it in a number of ways through out the system. The recording process is redundant via reporting to the remote management system in real-time or near real time as well as recording the event locally as illustrated from the center to the right bock in the figure. The local PFN/TRAC routing unit just discussed in figure four and interfaces any number of RF, wired or other wireless mediums to include one and or two way paging systems (like Flex, Reflex, RIM and ERMIES) to deliver data to the remote TRAC and FACT monitoring systems. Some of the more sophisticated links possible are analog and digital cellular CDMA and TDMA

STDMA (aviation specific) all the PCS (Personal Communication Systems) or application specific wireless RF, and DSRC RF, RFID, IrDa and acoustical technologies. These numerous communications interface at the second or third level in the present commercial cable and wireless OS routing stack for packet data and via a resident PFN translation program with algorithms to harmonize the different wireless protocols at a higher application level route signal further across a myriad of wireless options in each of the PFN/TRAC units. Routing for FACT is divers and dispersed and confirmed as a general rule to insure data delivery and is coordinated with the system clock synchronization standardized by LEO satellites (Like GPS) (Construction of this software program is done by those skilled in the art of telecommunication routing via the developer kits available (This process has been detailed through out the related filings). At the local level regular routing is determined as per the nature of the messaging. For an example; standard operational TRAC messages are handled in regular industry specific formatting that is relevant to the commercial wireless providers normal accounting and communication control pathways as predetermined by commercial agreements for equipment, material management and necessary human machine interfacing. However, if a local PFN FACT program flags a FACT event the communication links are direct to the first responders, and FACT specific intranets (The relevant government agencies best suited, trained and equipped to deal with the event).

Typically, a Remote Management System or specific PFN unit could initiate a TRAC or FACT function (bi-directionally locally and via the PFN/TRAC/FACT system). On that might result in the unique controlled shut down sequences (Detailed in related filings) such as; an automated guidance control, slow, stop and secure sequence involving terrestrial vehicles, machines, ships, material handing equipment and aircraft on the tarmac. (which may occur from simple single page commands delivered to a local PFN unit, or as a result of complex data processing either by local PFN controlling PC or any of a number of authorized FACT system intranet servers and terminals interfaced. The signal or command is to be received securely and encrypted then either decoded by TRAC commercial programming and or monitored by FACT and decrypted by federal access and control programming if the message has any special encryption (e.g. radiation alert sent by the HS1 1Ps HS1 “Tainertalker” units). Obviously, the slow stop and secure robtics would take into consideration where the equipment was and what the operation was. (e.g. truck and container in a tunnel or aircraft in the sky. (Another PFN SAFE Base proprietary robotics program sequence for FACT event troubled flights). Robotics systems generally handle the safe operation with direct remote control and the best actions would be a combination of preplanning, training preprogramming as well as, real-time RC handling of the equipment and situation (Ideally, locally monitored and managed but also with the option of greater real-time robotics and satellite RC links).

TRAC The PFN Trusted Remote Activity Control

Optionally, local displays or audio speakers may provide local status of normal TRAC and unusual/FACT functions (to be determined) as these functions are. being executed, to provide a local operator feedback relative to the progress of the function. In performing the function, all activity controls are initiated by the TRAC and monitored by the TRAC from start to finish (This is normal TRAC management and why the FACT security program marries so well on the PFN/TRAC System™).

This is accomplished through feedback sensors. Additionally the TRAC interfaces with plug, play and program connectable technology to drive and system process other sensors and other wireless communications to include audio and video. Sensors may be electrical, mechanical, fiber optic, infrared or other technologies. Since the function being performed requires a high level of accountability and trust that the sequence was in fact executed properly, every step of the process is monitored through appropriate feedback sensors and programming to attain the reliability and trust required for system acceptance by all stake holders(for normal functions but especially for FACT related activities). This positive feedback in the TRAC is the key feature which distinguishes the TRAC from other electronic or software controllers; making it a fully “trusted” system for the task being accomplished. Additionally, all events and status relative to the function are recorded locally in the local event storage (With respect to TRAC and FACT functions).

This is part of the resident system functional database. This level of redundancy in storage of functional data and the level of feedback and checking required to verify the activity or function has been accomplished to directly and properly relate to verification requirements to make a trusted and accountable system. These requirements may be regulated and approved by local or federal law enforcement or insurance agencies, the World Bank, EPA, ICC, SEC, FAA, FCC FBI, DOD, DOT, TSA, DOE or other regulatory agencies. FACT event recordings have a permanent functional data base record until the unit is retired in an investigation and or replaced either entirely or in the secured memory portion by authorized personnel. These local PFN/TRAC processors and data storage receptacles offer a means via a trusted secure accounting process to make acceptable the use of remote or shared equipment controls through responsible and discrete data acquisition not normally tolerated in a free society. Identifiable data packets (wireless/IP/encrypted) generated by the routing program in a TRAC unit are held in local in memory buffers and each buffer of every server in a FACT network for a time (to be determined by network engineers per and legal codes rules or regulations). Standard processing and packet tracking for completed messages (IP) will be employed with the exception of data storage of transparent messaging being securely stored at all levels until authorized FACT termination of data directives have been received to clear buffers. A secondary backup processing program at the appropriate application level to recover data will do a near real-time integrity check on data received via other dispersed communications connected. This is to be engineered to be a very robust process for confirmation and authentication. All real-time remote control wireless communications are dedicated and real-time sensitive by the synchronized clock time locally and systemically (GPS across the nation and around the world). There is a number of developed algorithms and software technologies being developed for this function and will be needed in TRAC RC processing of programs to determine exact position in space and time with respect to other known objects and their movement. Real-time dedicated communications with local robust robotics are to be priority governed by real-time assessment programming (Collision avoidance programs etc) and default to these operational backups or failsafe aspects of the TRAC technology. These to control models are to be Used together With local human control (The exact relationship and programming to be determined specific to application and event by those skilled in the art of safe equipment operations in each of the respective fields).

Processing Confirmation for Accountability

Interim progress of the sequence, activity or routing function may be optionally transmitted back to the remote management system through a 2-way phone, wireless, RF, or paging link. This may occur as the function is executing or may be programmed to occur after completion of the sequence, with accumulated data.

In the case of billing for service data routing will be stored locally in some cases and downloaded to wireless mass data wireless billing centers in off hours depending on communications traffic. Or may be transmitted in real-time command string in the headers of the data packets, and directed for operational billing programs running in the commercial service provider's infrastructures. Additionally, these practices may change and will be determined by providers and their business requirements and protocols and any standards efforts rules regulations or law. In any event, local, redundant storage of both types of events is always contained within the PFN for subsequent or simultaneous retrieval of event information and proof for accountability purposes. The PFN enclosure and TRAC monitoring with tamper sensors guarantee the information has not been compromised and can be TRUSTED. These physical protections and electronic protections are detailed in related PFN/TRAC filings. Other types of information include System Function Data (SFD file), which may be stored in the TRAC local event memory for analytical or investigation recoveries. Other Data may include digital or analog data not directly related to a function being monitored and executed by a host machine. Information gathered via authorized sensing technologies or accessories interfaced with a PFN/TRAC unit will include the wireless interfacing and repeating of HS1 sensor data. And, when recovered the PFN will add time date and geographic position to the data packet recoded locally and reported as a FACT file automatically to the FACT intranet upon the recovery from the HS1.

Additionally, this may be for the purposes of evaluating and determining legal liability or be a useful tool for the collection of evidence or to recover impact data on the environment by the machine hosting the PFN TRAC unit. The public and their legislators will determine what, how and when data can be recovered stored and used: The industry standards efforts and government agencies will adopt public policy and develop, standards, code rules and regulations. System analysts and integrators, the component engineers, the programmers and code writers will finally design the hardware software and construct the architecture, the public desires to implement. And the courts, justice department and law enforcement (specific to application (e.g. DOT/TSA) will professionally police operations to insure the will of the people is maintained in the implementation of the TRAC and application of FACT.

Public Monitoring

Examples of public monitoring include road conditions via surveillance audio and/or video, bio and chemical toxins, explosive detection and radiation etc and not just on the nations highways but in every aspect of life that there is movement (Transportation). All of which can be supported via interfaces with the PFN/TRAC unit and PFN protective structure for data recovery and storage. The use and application still has to be prescribed as stated in the above process. This critical point is a most important embodiment of the technology. This security and integrity capability of the unit and whole of the PFN/TRAC system to detect tampering and access and determine the impacts of actions can serve to make perpetrators and misuse of the technology accountable. Additionally, the invention and other technologies impacts on society and societies infrastructures as well as the world's environment and resources can equally be evaluated. Any injurious practices can be stopped or augmented in programming downloads in near real-time. To complete this task monitoring and management operation must be broad and professionally accomplished with the proper respect for privacy and personal injury. This can not be over stated if this technology is to find use in a free society like the United States and should be applied and understood by all the stake holders and areas of interests. This is why it is threaded into the inventions specification and technical fabric. Part of the technology of any invention is the technique to operated it and what to expect from that operation. Most invention specifications are far to irresponsible in this regard (E.g. cloning)

Data Handling and Storage

Special standards efforts involving those skilled in the legal arts and constitutional law to frame issues for public deliberation on personal and statistical data acquisition, handling and storage is an intricate portion of the invention's (La Technique). As mentioned earlier, to be trusted and accepted by society The TRAC has to be subject to review from it's inception and continually while in use. To include any process used to handle and store sensitive data for legal use. E.g. The discovery process and procedures to insure evidence is properly acquired and not compromise and kept pristine until court convenes.

Other Issues: Different Handling of Statistical Data vs. Personal or Private data Handling.

Statistical data recovered without personal identifiers being used by the public for better public management. E.g. a 1P PFNTRAC unit, a personally worn device performing biometrics reports on an individual's heart rate at the top of a long subway stair well via a DSRC signal as the individual passes a 1E PFN on an escalator out of service, because of a research program being run on cardiovascular research. This program may also ask for the persons age, sex, race, nationality, any weight data, and any known medical conditions or medications data stored in the 1P PFN memory or limited 1Ps monitor unit. However, no personal identifiers like name, social security numbers. health care or insurance data, address, phone numbers or email can be accessed or delivered.

The data recovered is to be specific to statistical research to better plan a safe and healthier environment and warn citizens at risk of over taxing conditions from a movement task in their environment (like the stair climb vs an escalator or elevator for those cardiovascular persons compromised. The monitoring is done first to research real-life situations that might be hazardous to ones health and then warn them in discrete ways of the danger with general public notices and or through a earpiece attached to the 1P PFN or 1Ps minimal units and deliver in an audio message to a particular person relevant health and safety data. A similar statistical data recovery for automobile use and highway system evaluation may be used with warnings of dangers in traffic movement. Then a 1E PFN driven sensor might pick up unusually high levels of gamma radiation and quarry all area PFNs and video attached systems with and without other radiation and explosive sensor arrays to sample data and respond.

Employing new technologies like the Noise, an odor detection technology that can detect odors at the molecular level some 2000 times greater than a human's noise. In this latter case the Local FACT event programming is initiated and personal PFNs are quarried to see who is in the area and what does the telemetry and video time synchronized images look like for the flagged radiation event being tracked. Telemetry like, what is the intensity of the radiation and what is the geographic position with audio video a list of PFN/ESN and remote control assets and human intervention assets like police special first responders all on one screen with individual screens being specifically monitor in TSA/FACT command center. Both of these scenarios are good reasons for acquiring data for public safety and national security.

Inventor's Insight on the Impact of the Technology

How will it be used and how can we make sure the accountability of the PFN/TRAC system serves the public good to protect our freedoms and does not invade them or harm us. This is the hard part to get right, the human machine and human interfaces of the technology. One obvious suggestion is Civil Liberties should weigh in early and as an on going in process through the court system. But this alone does not keep time with the real-time nature of the invention and other IT technologies today. Other groups should be sot out and funded to put a permanent public review process in place to feel the publics pulse and advise law makers on change of use issues regarding the invention as conditions warrant. Groups like The Charles F. Keftering Foundation specifically The National Issues Forums Institute—NIFIG. Org with their deliberative process on national issues Another organization is Public Agenda, they to quarry the public to help determine public policy. Additionally, local efforts that seek to gain public opinion in shaping national and community oriented public policy need to be funded and put in place. Programs run by universities and community colleges like Maryland's Montgomery College's “Center for Community Leadership Development and Public Policy with their NIF deliberative Format and other human resource services. All portions of the public should weigh in together as much as possible on policy implemented. The invention it self can function to quarry the public on issues and even set up issue framing data from logged comments and perform initial survey programs via unit and system programming and people participating in the process. E.g. One issue could be what are acceptable levels of police video monitoring to provide national security?. The Reason for this question—Is to determine the correct procedures and protocols for the use of the PFN/TRAC/FACT programming to match the national color codes and how to inform the public of their diminished rights of privacy and how they should be aware of this trade off for increased security efforts.

To Answer How Does the Above Fit in the Recovery Center Technology

It is important to keep in mind that each PFN in any industry could drive its own audio and video capture program and store it. So, how should that material be treated. Like today where we catch a crime on an ATM or convenient store video. Or as a fishing expedition where law enforcement or government or some commercial enterprise sells a city or agency a money making proposition where they can access and query wirelessly all cameras in a geographic area to see if someone broke a law? The public has to weigh in on what they want from this technology and others like it, not just the revenuers in our lives whether they be government or industry interests.

Important to remember is that the use of the Nose and or advanced sensor technologies may take some time to develop the electronic libraries to detect the various bio and chemical hazards. The 1Ps HS1 sensors arrays are to be small and use little current therefore they will carry specific data signatures to look for a specific contaminant, requiring more than one unit to cover the gamete of hazardous materials. A specific physical configuration may used to capture a specific molecular chemistry and that may be only to sense it and generate a discernable signal that still must be relayed to a remote processing computer like a PFN/TRAC unit or main frame computer in the FACT system to completely identify detected substance as known or suspected hazards. Some preprogrammed recognition patterns will be burned into HS1 & PS1 Flash memory to cause an alert response when identified, other times preprogrammed known components may cause an alert signal to be generated from known molecules or identifiable components but further investigation is required. As the molecular library is developed more accurate and quicker identification will be possible.

IMPLEMENTATION

TRAC implementation may be accomplished in many ways, depending on space or funding constraints and level of integration required for the system to control and to route. A PC-based system may be in the form of a desktop system, laptop, palmtop (PDA) Personal Communication unit (PCU) or (PC 104) or embedded system with a dedicated DOS or Windows based TRAC program, consisting of machine language, Basic, C, C++, Visual Basic, Visual C or C++, or other high level language which accomplishes the TRAC function through software control. Interfaces to the System Under Control (SUC) may be accomplished through appropriate I/O cards, either analog or digital, plug and play chipsets with protocols in firmware. Or PC compatible Modems or Cellular phone interfaces (or chipset) provide the interface to the Remote Management System (RMS) and for routing options. SUC and RMS interfaces may be in the form of ISA, PCI, PCMCIA, VME, Compact PCI, Future Buss, or other commercial interfaces compatible with the PC-based system used. More compact and custom implementations of the TRAC may consist of dedicated state machine controller implementations in which TRAC functions are executed through embedded firmware These implementations may incorporate multi-chip (or Hybrid) solutions using EPROM or EEPROM interfaced to Arithmetic Logic Units (ALU), I/O ports and discrete memory elements. They may also be microprocessor or microcomputer based. A large variety of board level products are commercially available for such an implementation. Single chip or high density implementations might consist of Field Programmable Gate Array (FPGA) or Application Specific Integrated Circuit (ASIC) based devices and Systems On a Chip or SOC technology. Additionally, wireless router functions and signal relaying (digit peating) might be accomplished with the different wireless protocols in hybrid chipsets and firmware on Plug and play (PC104) interface board or I/O cards and would be developed from developer kits provided from the 18 most frequently used wireless telephony protocols. The same process (developer kits) would be used by the skilled in the art to develop a universal routing software program (Possibly Unix based) termed (TEAM translation software) to provide flexible Translation of Emergency Action Messages (or TEAM messages) for FACT Security communications within the PFN/TRAC controller/router architecture.

Universal Communicator Program

This master routing/translation software package is to processes same content message data between disparate wireless protocols via a universal library of specific emergency messages and repeat them through out the PFN system as preprogrammed routing dictates. These universal messages are to be translated into all known human languages. This program is to have a voice recognition algorithm to identify languages spoken and a universal audio and video set of pictures to accompany these TEAM messages that are physically translated by signal. All TRAC implementations may incorporate all sequencer, firmware, I/O and storage functions on a single device and would provide the highest level of integration and smallest size. Display, Video and Audio (Auxiliary Data) for the TRAC can be in many forms and types. These may range from analog systems, in which tape or other magnetic media store the analog signal, to digital systems in which data is stored on hard disks, EEPROM or RAM. Data format may be modulated through FM or AM, compressed, packetized or otherwise encoded for reduced bandwidth or for transmission over the Internet (packet audio and video). The vast amount of possibilities and form for the TRAC are deliberately designed for the PFN interfaces to be application flexible a continuing effort to be as inclusive as possible of all technologies to provide versatility and universal connectivity for the public and the free market system. Varying degrees of size and sophistication in the various PFNs and 1Ps or HS1 plafforms will exist at any given point in time and this is meant to be to provide an inclusive system that takes advantage of all the technology past, present and future. There will be Complete PFN/TRAC units with multiple wireless interfaces and routing to include long distant communications that will be smaller is size than the more simpler 1Ps wireless sensor platform that talks to a PFN/TRAC unit. Complete secure accountable connectivity for human and machine messaging is the goal of the PFN/TRAC System and Federal Access Control Technology to improve public safety and national security is the benefit

Hardware Implementation are to be Progressive and Flexible

Trusted Remote Activity Controller (Generally) will be COTS Based PC-Programmable Controller (PC104)-Custom Logic Sequencer mP (Micro processor) FPGA (Field Programmable Gate Array) Custom Gate Array (ASICs) to include Systems On a Chip or (SOC) technology ultimately constructed with room temperature super conductors (plastic) with greater computing speeds and less current demands. It is because of this capacity for growth and accommodation for existing COTS and legacy technology, that software function not specific programming are the chosen teaching technique for the implementation and processing throughout the diverse PFN/TRAC architecture. The laborious work of the programmer and code writer for the specific existing hardware will be a massive but shrinking challenge as platform architectures become more standardized through out the applications. This is demonstrated in the many prior related teachings for the separate industries to be PFN/TRAC linked.

TRAC Features

Industry Accepted and Trusted System
Uses Industry Standard” Interfaces
Provides Accountability Requirements
Aggressive Remote Control Functions,
It is Programmable & Modular,
Scaleable
Provides Level of Redundancy,
Event Storage,
Algorithm Type is Dependent on Application Accountability Requirements,
Resides in PFN (PFN must have Physical Security)
Remote Management Command Authentication,
Local System Control and Event Storage, Software/Algorithms Bank/Stock
Exchange Transaction Products & Algorithms
RPV (Remotely Piloted Vehicle) Technology,
Security, Commercial: 128/64 bit Encryption (Web Transactions), Military: DES (Data Encryption Standard or present Military Encryption as required ) & all the FACT Program functions programmed in with any special/different software protocols to operate in local hardware and PFN/TRAC system architecture as dominant and required
   Interfaces
Any Applicable Commercial 2 way RF wireless used for city industry and or government connections desired or required.
Any FCC designated frequencies
Automotive Industry Standardization Efforts,
IEEE Standardization efforts,
Avionics Standardizations efforts,
Rail Standardization efforts,
Marine standardization efforts,
Electronics Standardizations Efforts,
Computer Standardizations Efforts,
H-Rel Connectors,
Actuators,
Sensors,
Signal Levels
   Wireless Telephony and Data Interfaces
Digital Cellular, PCS,
56K Modem, Faster
RF & Pager Technology,
All the approved aviation wireless technologies,
All marine,
Interactive Highways
Any Applicable Commercial 2 way RF wireless used for city industry and or government connections desired or required.
Any FCC designated frequencies
All DSRC,
All emergency frequencies
AIP Airline Control Protocol,
   Program Considerations for Wireless Routing in Air Travel Industry for HS1 Data Packets.

Data link layer polled protocol that runs in full-duplex mode over synchronous serial (V.24) lines and uses the binary-coded decimal (BCD) character set., Airline Product Set ALPS circuit, And a communication path across a TCP connection between a host reservation system and an ASCU. When MATIP encapsulation is used on an ALPS circuit, it is equivalent to a MATIP session., ALPS Tunneling Protocol airline protocol, Generic term that refers to the airline reservation system data and the protocols, such as P1024B (ALC), P1024C (UTS), and MATIP, that transport the data between the mainframe and the ASCUs., Airline X.25
Dynamic Host Configuration Protocol (DHCP), [RFC-2131], a framework for passing configuration information to hosts on a TCP/IP network
Time of Day Protocol [RFC-868], to obtain the time of day
Data or network
Edge or access router
DSP medium
RF medium (coax, modulator/demodulator, antenna)
RF management software
   Wireless Standards Effort

PFN/TRAC units will provide a less expensive, more comprehensive, secure and stable mobile platform for the development of wireless routing and interfacing with equipment, via the portable WLAN network created. The system is to start Internet data packet routing at the earliest point data is generated and apply this technology universally across the wireless spectrum. The system will always remain diverse and need planning to insure enough of the properly programmed PFNs or more universal PFN units are present for adequate coverage of all types of wireless and to maximize the recovery of HS1 or operational PS1 data. The process will always be an evolving one of forward and backward engineering. However, the flexible interfacing via Plug, play and program architecture at local routing interfaces (proprietary to the PFN/TRAC system) will aid immensely in this process. With more dispersed maintenance to include the individual public to lower industry cost. The PFN/TRAC System was invented to be the machine messaging system for the United States to automate all equipment controls. As standards emerge and technologies merge the specific technology will be refined and miniaturized into SOC configurations. There is always to be a flexible plug, play and program interface capacity to grow and keep current with new technology and accommodate legacy technologies in the PFN/TRAC System and FACT security network. The FACT network via it's industry specific registries must be programmed and agency staffed and capable to recognize all new interfacing and system augmentation and provide a review process and integrity check; both at the local interface PFN/TRAC unit and system wide to check for alerts or anomalies. Either because of FACT programming, or to write code to flag events as FACT alerts and upload any critical data to all effected PFN/TRAC units for the most real-time preprogrammed responsiveness. At least 18 different types of wireless are in commercial use today. Therefore, as PFN/TRAC technology becomes more mainstream, many of the applications will migrate to specific architectures and product interfaces. The different types of wireless are quite unique to each other on numerous levels, and require specific types of expertise to deploy, use, and maintain them. Like every access medium or technology, wireless has its pros and cons. The pros include:
It's much less expensive to deploy than hardwiring.
It's much quicker to deploy—.
Wireless can go in inaccessible terrain.
it involves an inherent high degree of security, and additional security layers can be added.
Wireless provides broadband mobility,

PFN/TRAC wireless link will be a fully featured router, which means that it must provide VPN, enterprise toll bypass, and MDU/MTU access services where these are not present by commercial providers and interfaced into local PFN/TRAC units to include with cross protocol Translation and routing. These PFNs will retrieve the HS1 sensor array data and deliver as a gateway to the various IP addresses. The fundamental elements remain relatively constant between the wireless providers allowing PFN/TRAC router access to translate between the protocols retrievable at Layer 2 of the wireless protocol stack for the most part with the data packets and universally synced timing. The majority of wireless vendors access the wireless stack at layer 2 and some at Layer 3 like Cisco Systems routing. Depending on application any specific PFN/TRAC unit would have programming at least for one maybe both accesses layers to the stack with unix programming at a higher application level to perform the translation algorithmic functions. And through out any specific TSA/FACT intranet (e.g. FACT/TSA airport terminal a PFN/TRAC unit in the matrix would have the capacity both access long distant communication links both wired and wireless and digi-peat packet messaging from the HS1 to the appropriate IP addresses for TSA/FACT Homeland security

A Data Handling Modality Example for Wireless PFN Machine Messaging

The protocol stack implemented could be based on the DOC SIS standards developed by the Cable Labs consortium. The principal function of the wireless portions of the TRAC unit is to transmit Internet Protocol (IP) packets transparently between TRAC controller/routers in the FACT security control matrix via direct dial ups or through wireless gateways in the FACT and commercial TRAC intranets. Ideally, certain management functions will be impregnated via IP to include spectrum management functions (for identification, addressing wireless accounting purposes) and software downloading. Both ends of any wireless link are to be IP hosts on the network matrix, and they fully support standard IP and Logical Link Control (LLC) protocols, as defined by the IEEE 802 LAN/MAN Standards Committee standards wherever appropriate (for wireless telephony (HS1 system interfaced via PFN/TRAC units and PFN/TRAC system terminals). The commercial servers generally support the IP and Address Resolution Protocol (ARP) protocols over DIX and SNAP link layer framing. The primary function of the wireless system is to forward packets. As such, data forwarding through the commercial servers is done with transparent bridging or network layer forwarding such as routing and IP switching. Data forwarding through the PFN/TRAC system could be accomplished with link layer transparent bridging based on IP. Forwarding could be similar to [ISO/IEC10038] as per any applicable DOCSIS specifications. Both ends should then support any spanning-tree protocols to include capability to filter 802.1d bridge PDUs (BPDUs) with out loops in specific intranets and support for Internet Group Management Protocol (IGMP) multicasting. FACT and special encryption applications would be above the network layer, This transparent IP capability will be bearer for higher-layer services. Additional translation programming between protocols should run at these higher levels. Use of these services will be transparent at the unit level unless the unit. is running these higher program applications by authorization and identification (e.g. DES or special TSA Homeland security programs setup as PFN/TRAC (Possibly DET) terminals or protected and secure at the same level, In addition to the transport of user data, several network management and operation capabilities are supported at both ends of any intended messaging To the PFN/TRAC unit platform. The Primary Focal Node access wireless architecture as a router allows it to serve as a hub or mini relay station serving other nodes (PFN/TRAC units and the many 1Ps HS1 sensor platforms in a WLAN (portable network). In the above described application. It is a point-to-multipoint architecture in the sense that the entire bandwidth on the upstream and downstream is shared among all the responsive PFN/TRAC units from the individual HS1 sensors. The protocol stack implemented to make all this work is based on the DOCSIS standards developed by the Cable Labs consortium.

This is but one proposed modality of routing via the PFN/TRAC controller/router to construct the flexible web with current hardware and software available and the HS1 and or PS1 sensor platform proposed to meet today's Homeland security threats from toxic chemicals, biohazards and nuclear waste as well as, whatever industry operational sensing that is required of the PFN/TRAC system

PFN/TRAC Unit Characteristics in a Recovery Center Network as an Example

They have local event memory storage in protected containments. Report to mass data management and storage centers in the Trhe Recovery Center and related companies and government agencies. They can have wireless and wired connections to sensors and sensor platforms (PS1 and HS1; and, Multiple communication technologies and protocols in the PFNs. They have automated radio frequency scanning and translation between different wireless protocols. In addition, PFN's have back up power supplies. They provide the means to add electrical functions to legacy equipment; and Interface separate equipment operating systems as well as existing security systems into one management system The PFN/TRAC system with security and national security via the FACT program with Homeland security matrix. The PFN/TRAC System responds locally and to repeat messages and signals to and from each other as well as, To other remote monitoring;

The PFN/TRAC unit provides its physical location (GPS or recoded fixed address) with the data. They report; and can drive audio and video equipment and other data recovery devices; They can operate automated robust actuators and equipment controls; They perform real-time remote control with accountability; They perform their own integrity checks and of any assets interfaced and or inventoried with them; They can perform self maintenance checks and diagnostics; and affect repairs automatically and remotely; They can detect tampering; and operate with encrypted programming PGP and DES; as well as, complete operations independently preprogrammed and robotics functions; They can operate electronic payment industry programs and ID programs; and drive Card swipes; Explosive Detection Equipment, and all sorts of transducers, sensor arrays; PFN/TRAC router functions—Network data flow to the remote management system and provide local robust broad spectrum data and communications routing

Elements of a Total Management and Security Network Solution for Transportation

Premises networks (PFN portable network) e.g. airports, ports, rail terminals, Installations, boarders and everyday industry (e.g. he Recovery Center)
Access networks E.g. primary intranet FACT/FAA/TSA terminal command center and national Air travel
Core networks DOT/FACT/TSA National Mass Data handling and storage matrix of intranets for air, land, sea, boarder customs, national security agencies home land security
Network management PFN/TRAC System and FACT program.
Billing/OSS PFN/TRAC system, electronic payment industry, etc. A fully comprehensive wireless solution must also include the issues of deployment, maintenance, legacy, migration, and value propositions. The scope of what comprises a fully comprehensive solution is addressed in this filing and the related filings.

Note: This process in aircraft is greatly complicated with a more robust three dimensional environment, he diverse air fames and the speed at which planes fly. The avionics details for the TRAC processing and progression of system under control SUC to perform robotics flight and remote control flying and landing are addressed in two other prior avionics filings. This figure is to show the general architecture of TRAC/FACT system of reporting and responding message routing. The drawing explains the properties of accountable robotics, remote and shared machine controls via the TRAC design. Earlier related filings serve those skilled in the arts of electronics/wireless and computer networking to construct the various PFN/TRAC unit and system with FACT Security. The figure displays a scalable and modular technology from local and regional wireless remote control to national and global IP management as a network of interfaced FACT Intranets. This includes all the sub set local intranets at each of the 429 airports and hundreds of sea ports, rail stations boarder crossings and Highway check points and toll booths as part of a greater PFN/TRAC System which connects the above and the following via telecommunications, cable, satellite, microwave and fiber to FAA/AOC/Port authorities/customs/FBI state and local law enforcement though TSA/FACT intranet centers and IP connections to be developed with Air Traffic Management and NORRAD air operations) in Herdon Va. and Colorado and all the appropriate authorities ad agencies for the other terrestrial traffic management, material movement and policing operations needed to have a responsive TSA DOT Homeland Security today. (E.g. A base for the FACT/TSA Aviation intranets can be created by incorporating the present 200 AOC centers and combining /TSA terminals across the nation with these FAA/AOC air operations in Herdon Center as detailed in earlier related filings. Whether for Air, land or Sea movement each terminal is responsive in the matrix of TRAC intranets for FACT security in a Homeland security network. A greater portable network that is flexibly connected to each passing aircraft across the nation for downloaded real-time transit monitoring via the 200 receiving TSA/AOC handling centers displaying 1Ps HS1 sensed data from the cargo compartments containers cabin and flight deck. The same would be true for Interactive highways, waterways, railways ports and boarders with all the containers truck boxes and packages etc, not only rolling in and out of the boarders out rolling on the roads on the seas and rails. The inspection process is an ongoing real-time free moving process never ending. Further, The TRAC acts as a mini hub for routing data and will send data packets via diverse communications determined by local routing algorithms (discussed through out the text and related filings). These software routing programs are to run in the local TRAC processor, which are stored in the protected PFN interface. The PFN TRAC units receive stable power from every piece of equipment interfaced with a PFN unit and each unit maintains an emergency power supply for (completed operations). This helps to make it reliable and trusted. Figures twenty six and twenty seven further describe the system architecture and gives various transportation examples for the application industry specific intranets in matrix together to serve Homeland Security with FACT and also the normal TRAC operations for commerce and free movement management.

Obviously the last two pages focused on the electronic management ad security aspects of the PFN/TRAC System and FACT security for homeland security. That technology was designed as a secure movement management system for the Department of Transportation as early as 1997. It is explained fully here so it can be reviewed as a way to move forward with all transportation needs to include every industry. For the United states to be safe it must have vigilant security of all materials in transit and not just when it crosses the boarders. The reader can easily see with the PFN/TRAC unit in every vehicle and machine all movement of material and substance is monitored by a technology that con control movement in real-time. So this detailed electronic description is provided in every commercial, governmental, private and industrial application.

This recovery Center invention is a combination of numerous technologies taught here to be operated synergistically to conserve energy and produce sub products rather than just transport and store waste material. The process is made most efficient via the PFN/TRAC management system that yields flexible equipment and material control and product processing to meet market demand for individual product on a daily basis. This proficient use of waste material to value added product manufacturing can reseed job market needed in the waste lands of cities in the Northeast and Midwestern United States. And through more proficient industry that provides state of the art homeland security, where no other industry has emerged.

FIG. 28

This figure details the FACT security system further specifically how many of the different industry intranets and individual PFNs use the internet in their normal operations and how they are responsive during an emergency event with agencies, industries and first responders.

In FIG. 28 the FACT Security Program has layers of redundant reporting from multiple pathways that are time and geographically synchronized as well as, identifiable in nature, origin and communication path through out a Homeland defense/security matrix. The very top bock is only exemplary of the security agencies network via IP at this level. The list is to long to include all but some are NSC,NSA, Secret Service, CIA and the special security responsible components of the three branches of Government Executive, Legislative and Judicial. (possibly a new judicial function into the procedures and protocols for an interactive accountable use of the FACT security program as discussed earlier for reasonable and legal search procedures with the technology. At this highest level procedures, will need to be determined and agreed upon to maintain the balance of powers and protect the public's interest. Accountability personal and agency identifiers with traceable data telemetry for system access, use and commands will be reported and recorded through out the entire system, and this should include the highest national security FACT Command control levels. The access to this data will be denied and transparent system wide when classified Secret, and Top secret and or to include any of the appropriate terms used for such classified data. Application viewing and access to data can be controlled via personal ID clearance and Data Encrypted PFN/TRAC interfaces to specially prepare terminal protocol or PFN Display (This to be determined and approved by each security agency for agency specific data as a data handling software directive and added to the data packets.

SEAM

This message program is to provide guarded mobile and flexible access to the highest level of security from almost anywhere via running FACT programming and throughout all of the PFN/TRAC system™. These program messages will be termed SEAM messages for Security Emergency Action message. They of course will be transparent in the system and use compatible wireless transfer and translations to maintain accurate and complete content delivery, when messages are passed through different wireless protocols. ,No transcribing through the universal TEAM language libraries, for this application other than to advise an individual of a SEAM message waiting at a terminal that can identify and authorize the delivery to the correct person. However, there will always be real-time total access to the universal communication program if security command agencies require this to complete operations.

Generally, planned is a central homeland security command, but this could be modular and or transferable to different locations as well as the master control staff changed or jus t be a dispersed system. General to the central command interface for Homeland Security would be Echelon (Total communication monitoring), NORAD combined with TSA AOC and Emergency response.

Center(s) or dispersed. Procedures and protocols need to be determined and these protocols need to remain top secret to include, all the necessary encryption algorithms for coded commands from time to time and done with integrity checks before activation of any changes. Integrity check protocols will need to be determined as well. TRAC/FACT is all about accountability to be trusted and respected by the public. National Security has to act responsible to that ideology and way of life we share; above all, professionally and respectfully as a member of our public. With that said, the individuals performing these tasks deserve the highest respect and appreciation for their efforts to protect the public and the nation.

Freedom of Information or FOIA is a special attention issue for the release of any data that could be used to place judgment on the individuals serving the nation and the public at these most difficult levels in the FACT program. Improprieties such as negligence and any deliberate intrusion of privacy with out cause or for personal reason or gain should be intolerable and criminal, with criminal and civil penalties. Risk management studies must be conducted to determine actual risk, liability, and accurate insurance costs to determine fair rates to provide indemnity for those persons performing these inherently tough tasks and making these decisions. Additionally, rational limits for damages have to be determined and standardized for real-life accidents and unforeseen equipment failures and acts of war from which we are all under the same threat.

The second block termed “Customs” layer is an example of all the individual government agencies law enforcement and security departments interface Layer. The flow is interactive and multidirectional throughout all the layers and all the directions through all that is integrated. However, there are responsibilities, procedures and protocols to be determined for this interaction. The four big blocks below the second layer are the basis of the TSA matrix to monitor and mange movement. These intranets for the FACT Security matrix are only indicative of all the intranets public and private that are to be interfaced.

Transportation applications have been chosen because the management of movement is basic to security to push back our borders and internally continue to enforce border policies. This is a flexible and doable architecture for Homeland Security. The concept being good efficient traffic management in all the choke points frees movement which helps the economy and provides the infrastructure to support seamless security throughout the nation.

All agencies intranets are to be responsive in the FACT security matrix by supporting a FACT registry operation applicable to their appropriate government duties. The four intranets shown in FIG. 28 are displayed here for illustration purpose not to be considered a final inclusive design, but pretty close to the industry areas. DOT alone with FAA, NTSB AOC, etc would be just some of the agencies for the AIR FACT intranet displayed in FIG. 28. All these separate agencies or responding sub set intranets would have message capacity to the other agencies in the other blocks. Additionally, these areas are also chosen for their basic commercial and industrial design to be the basis of support for the hardware interface platforms (PFN/TRAC router unit) at the component level. The local first responder bar or bottom block is part of this local WLAN or portable network that is receiving automated FACT event alerts do to preprogramming in the individual PFNs. In the prior drawing the wireless clouds for Radio technology, Cellular and paging telephony have an immediate first responder protocol that will connects to the emergency responders in FIG. 8 in a GPS response of geographically sensitive loop. Additionally, the IP network for the four transportation industry Intranets are appropriately linked to appropriate commercial and agency data bases via internet protocols. The wireless links initiate the interet connections via the individual PFN/TRAC units flagging a FACT event. The four different TSA/FACT intranets are for the most part created virtually via a FACT software construct program through out all the individual intranet daisy linked through the wireless clouds running the same FACT software (Probably Unix) being responsive to system quarries to transmit data packets

They are also receiving data from FACT TSA Security command. Specific scenarios and responses have to be projected and determined in an on going process to develop the most optimum and consistent results and use of the PFN/TRAC system and FACT Security program.

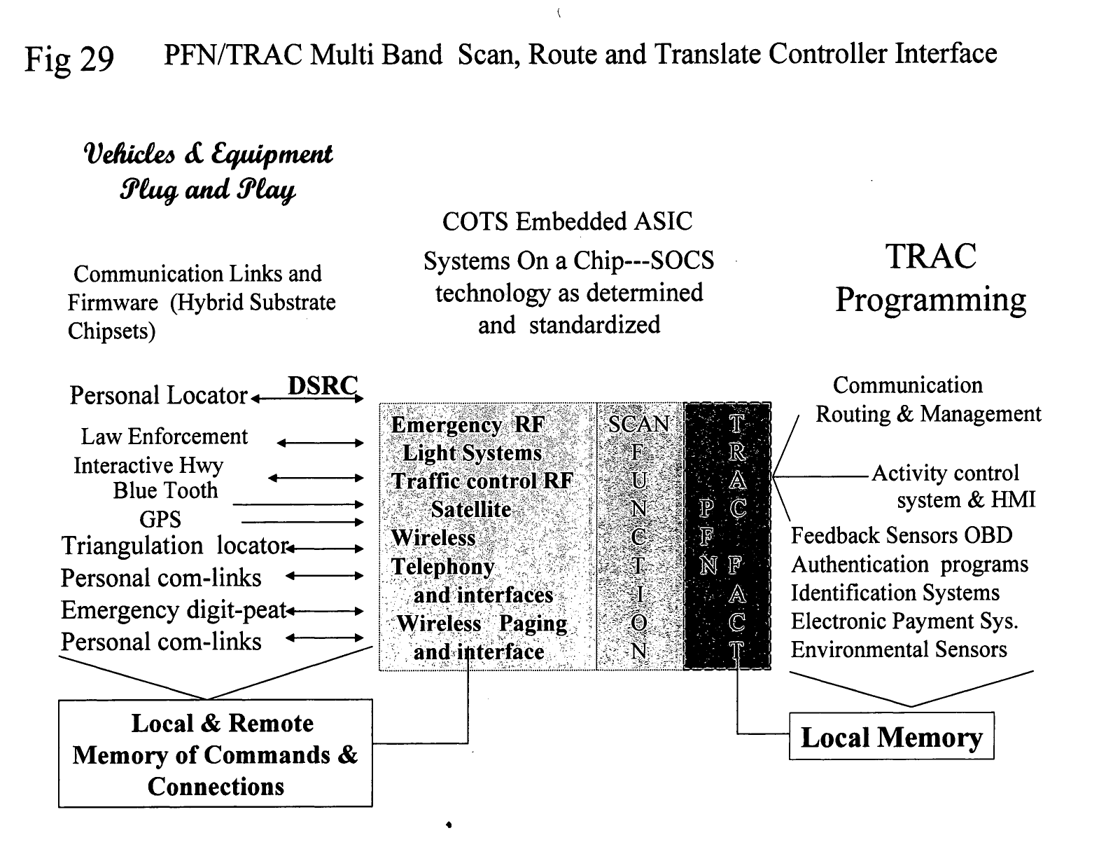

FIG. 29

The drawing 29 illustrates a multiple receiving scan process. As stated in earlier figures a multiple of wireless protocols are interfaced to the TRAC processor in a number of ways depending on the nature of the hardware and development of the technology. Basically this scan process is the first stage of the PFN receiving wireless communications. The PFN/TRAC unit is configured with the appropriate antenna to accommodate all the wireless interfaced at anyone time, and in some cases a broad spectrum antenna for counting frequencies. A scan program either running in the transceiver circuit section (e.g. chipsets or TRAC processor section interfaced or integrated recognizes messages in a frequency band of one of the wireless interfaced in the PFN/TRAC unit. If the signal has a particular address not relevant to the unit ESN or ID it scans past to the next activity.

One function of the scan process is for the unit to do environmental EMF and EMW surveying for security control and management of remote control functions and to do environmental research on areas to maximize and organize transmissions and reception and to address health and safety issues regarding electromagnetic fields, presence intensity and any PFN correlated sensed facts as to their effects. This data is to be maintained in a buffer and memory storage or the TRAC PFN processor or extended memory receptacle.

Another function of the scan process involves a TEAM messages which could be received on one or more wireless technologies actively interfaced and with simultaneous signal reception one is stored in a buffer for near-real-time review while the best signal is processed immediately.

Universal Communicator Program

This master routing/translation software package running in the TRAC processor but augmented by with TEAM programming in the wireless software interfaced in any particular PFN/TRAC unit processes same content message data between disparate wireless protocols via a universal library of specific emergency messages and then routes or repeat them to another wireless interfaced to complete the translation process in and through out the PFN system. These same universal messages are to be translated into all known human languages as well and available to the appropriate persons along with public TEAM messages. This same program is to have a voice recognition algorithm to identify languages spoken and a universal audio and video set of pictures to accompany these TEAM messages.

And be delivered by these interfaced accessories

A third function is the portable network. Part of the FACT function is to inventory interfaced components and to maintain a working inventory of associated materials. In this case the PFNs are mini repeating stations to those agency intranets in FIG. 28 support FACT registries for every electronic component that can be interfaced with a car, plane, boat, train, machine or piece of equipment. This is true for 1Ps standalone PFNs as well. This is the basis for the traceable portable network a machine messaging matrix or web that is flexible and mobile. For example a number of materials could be transported across the country and their preprogramed imed communications would quarry each other to see if they were in the same area and recognize when the wer not and report it back direct to the FACT control center for that intranet. This data woud be re transmitted to all the intranets by IP and all intranets would up load this data to their PFN asets so when a scanning PFN identified the lost signal it would report the interrogating PFN GPS if the signal did not provide tracking e.g an RFID interface not another short range PFN.

Forth is locating program for non GPS units. The scan process would have an algorithm that recognized time reception of the same signal and strength and be able to apply it's known position history (fixed address or GPS coordinate) with other PFNs in the WLAN and determine position of the non GPS asset (automated triangulation algorithm running in the scanner program and driven by the wireless receptions and frequencies counted.

Fifth Scanning Routing Function with FCC FACT for System Integrity and Proper Use of the Airwaves

The Federal access and control technology—specifically FACT/FCC will need to approve this PFN/TRAC scan function and employ it. All PFNs or TRACker routers could be configured to scan for all sorts of electromagnetic frequencies and EM wave propagations/transmissions or random oscillations as a precursor and maintenance procedure to safely perform wireless access and control of communications and machinery to protect the public's safety and national security. With terrorist looking for ways to harm the united state we have to safe and protect our remote controls and airwaves. The PFN/TRAC system is all about protection and detection and this scanner function is but one electronic policeman on the job looking for unwanted and unauthorized transmissions. By design this is to be part of the FCCFACT regulatory process and their registry program for the communication commission to review data generated by their FACT program when making licensing decisions or enforcing it's regulations. PFNs could deliver clear evidence of over saturated areas with high noise and help the FCC delineate how best to license the airwaves and protect and mange this public asset

Additional Scanning Program

The Technology plans to explore the use of the deep space radio telescope signal search program to discover intelligent life in space. The average public was asked to help provide processing power (PC Based software) to run the software algorithms. For the PFN/TRAC system this would be reduce or customized with known transmissions filtered out in some cases and only looking for unauthorized or never detected occurrences (or special FACT event anomalies).

The reader is reminded that the FACT program in the PFN/TRAC system operates off the same communication structure that provides operational data in each industry and or operation. The fact that the hard ware can be in place to support a national security system to such an extent is a blessing. This double function is a cost savings to support such a technically advanced national security system. And the improved data acquisition, dissemination between branches of government and the overall notification of the same material to all levels of government and industry helps safe more Americans than ever envisioned.

One unique aspect is that PFN/TRAC system has been designed to utilize technology that is in place today such as COTS wireless communications, Nextel phones cellular phones, commercial two way systems, paging technology and broadband wireless, etc. and couples them to a mobile computer/data base that functions as communications router/controller of machine controls audio and video systems and interfaced sensor arrays to form a portable sensor and data retrieval network; which additionally performs real-time remote control over the machines interfaced with a PFN/TRAC unit. Because this capacity exists for the operation of individual machinery in application specific industries and can contribute to a national security matrix for government and industry it has to be thoroughly detailed in each of the PFN/TRAC filings so those skilled in the art can give this great possiblity the type of consideration needed to develop the proper government and industry standards.

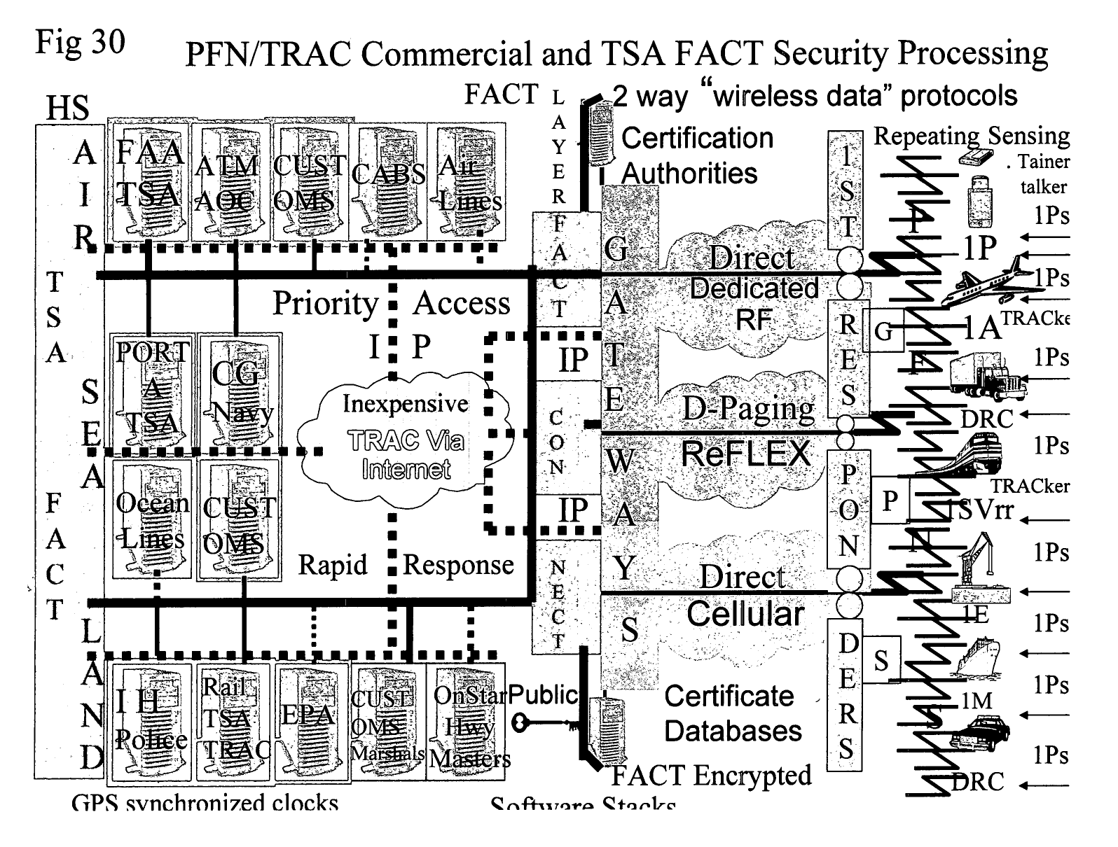

FIG. 30

In viewing FIG. 30 from the far right column the wireless PS1/HS1 “Tainer talker” sensor array and any 1Ps or HS1 stand alone sensor platforms are represented as transmitting their data to the various PFNs (left of far right) for the repeating of the reviewed data and alerts by the PFN/TRAC machine messaging units which act as wireless gateways to the PFN/TRAC System and government industrial/commercial communication FACT security matrix of networks.

Even though communications down to the wireless PS1/HS1 sensors can be two way to command the PFN units and sensor arrays to rerun system integrity checks and cycle any sensor array one way, little blue and red arrows are used to show first system notification or the monitoring embodiment and have a platform to describe the accountable robust management FACT can provide.

Data is retrieved by the PS1 or HS1 sensing plafforms and the regular PFNs and with respect to the application and the wireless technology employed by the user programmed to go to one of the normal gate ways via the long distant wireless of choice (interfaced in the PFN/TRAC unit) (either RF. Reflex paging or cellular for the most part) These are represented by the commercial network clouds to the left (The specific service system and links are determined by).

Starting from the PFN units (receiving) in the prime mover and recognizing a FACT alert and providing their exact GPS position and ESN data to the FACT software layer in each or any of the different wireless providers the signal can be cycled to the appropriate first responders and the appropriate TSA intranet Land, Sea, Air and sub networks and agencies as well as, appropriated commercial and public communication medias (To be determined in procedure and protocols if desirable at any point). The solid lines and the color red is used to symbolize FACT two way links. The other broken and lighter colored lines represent normal pathways of wireless and IP service and the PFN TRAC general machine messaging to deliver data during regular operation and management of machinery. All intranets have a FACT security layer and are responsive to data being processed application specific and can flag a FACT event and upload or download processed data as a FACT alert Emergency Action Message or EAM message (EAM, TEAM and SEAM are FACT messaging protocols described in the earlier related fillings; TEAM stands for Translated Emergency Messaging and SEAM is for high Security Emergency Action Messaging for national security-HS; all PFN/TRAC system access points can be useable into the FACT matrix but authorization is at a higher level for SEAM communications).

Data Messages have all the ESN, ISN and GPS or fixed address information in the data packet headers for how the data packet is to be handled and where it came from. This allows for the immediate link to a specific PFN asset in any of the responsive intranets from a pertinent TSA/FACT command and control center via a direct FACT access per communication provider and also the posting to all FACT intranets interfaced and tracking the FACT event. Access and use of the remote connection and control of the host vehicle to include, handoffs between the specific agency experts and or to local and remote management options to perform the accountable RC and or initiate or cease robotics must be determined and set into procedures and protocols by the experts for the specific situations—these are only—the technical options available to any planed deployment.

For an example if a DRC PFN from the tractor trailer hauling the container reported a 1Ps HS1 “Tainer talker” sensed a radioactive hot box condition the initial wireless link would be directed straight through the TSA FACT intranet, the Interactive highway the container was on, local, police EPA NRC and the first responders to include NRC qualified hazmat persons. In this scenario OnStar/Highway Masters or Qualcom wireless service, etc. would respond via the resident FACT security program by recognizing the FACT alert both in the Prime mover PFN and the system server to deliver critical data to the Prime mover PFN and all the electronic equipment and capacity available to that DRC PFN unit on board the tractor (this could include remote instructions to the HS1 platform via the DSRC from the DRC PFN).

FACT across the boards

If private networks operate their own wireless hardware or network cloud they must have a FACT Application layer for the software to run and be connect through. (*In the case of OnStar they are already connected to the 911 first responders, however the complete fact security matrix is essential to determine the complete public safety threat with regards to national security. This commercial link is shown as a lighter dotted line delivering the essential command string software for a TSA/TRAC land intranet station in homeland security or the first responders to take a handoff and perform accountable remote control and retrieve real-time data directly from FACT Connect (any OEM Key codes for this single machine or all GPS placed relevant equipment are downloaded to FACT immediately for federal access and control of trafic management and remote control (Onstar control is out of the loop—this is better for insurance and liability reasons as well during FACT operation). On star would continue to provide commercial service to these same vehicles in this area but default to FACT control as required (immediate and in real-time).

Dedicated cellular and or reflex paging is planned for long distance remote control-commands will be in a progressive relationship with OEM collision avoidance and PFN/TRAC robotics. PFN/TRAC system will initially develop the Reflex paging technology in it's architecture for a great quality to deliver a signal deep inside a building and most minimal containments and the capacity of the PFN to support extensive programming in the sophisticated mini computer. This is an important asset of having the Trusted Remote Activity Controller and router geographically spread out and all timed together by GPS. Additionally, limited data streams can be transmitted with greater local processing of the packets. This equates to more robotics and less RC. Which allows for timed efficient transmissions. However, multiple wireless are employed for redundancy to increase reliability and because the architecture can support them and provide better commercial routing options for EAMs. With each wireless protocol stack having a FACT layer at each end the system can process the EAMs or RC machine messaging commands in their FACT layer no matter how their sent originally. Additionally they are isolated in a IP application specific programming and GPS synchronized for uniform time connections through out the system (FACT encrypted as per event agency and unit and any personal authorized identifiers)

Note: These developments for FACT command structure and identifiers have to be developed by DARPA, ARL and security electronics contractors. This is stated and out lined in other PFN/TRAC filings. Government agencies will ultimately provide FACT registries that keep a current track of all operating electronics on every machine, vehicle, aircraft and piece of equipment. Some of this will be done by the Telematics service companies like Onstar with government regulation and licensing as an asset to the programs they are selling, but this is to be a national mass data handling and storage process.

The reason for this is to help control the risk of bogus electronic parts interfaced with the PFNS and used to violate Homeland Security and public safety with this nation's own wireless equipment (remote control bomb and crashes, etc). To accomplish this, the key codes for all the software/Firmware (software imbedded hardware will be developed at the highest level of national security and a process for programming and authorizing a component, part or product for use will be accomplished in final assembly check points in each nation by US nationals that are authorized and charged with this responsibility. This will help provide jobs with safer global free enterprise.

As earlier stated the United States government will be responsible for overseeing the commercial development of this tracking and component identification, programming and the checking process is to be a customs operation funded by the manufacturers, exporters, importers and buying public as well as, a portion of the resale tax automatically collected via the products identification established and traceable at each use, resale and application. Each new owner for the life of the component is known as well as all the interfaces and transactions for it's use. Additionally, as stated earlier this coding will be agency specific to identify the product to the governing agency and their registry as well as, identify any access, use/misuse and any quarries. This process is also done at the local level in the PFN/TRAC unit itself and is the initial check -point for system integrity for the life of a machine or vehicle housing the component for as long as the component resides in that host machine.

On every start up, periodically and with the original installment of a new component the Part—to include a PFN, a HS1 or other electronic device the FACT ESN of the part has to be checked and or approved via the remote governing agency's registry before service of the component is permitted. A flagged event can occur from a registry down load to the local PFN. E.g. a car radio stolen from another vehicle, the DRC PFN receives an electronic request via the radio acceptance into the system via the E/E bus. DOT/FBI UCR IBSR and NATTI for stolen cars and parts program has received a stolen radio report with this same electronic serial number. The DRC PFN recognizes can apply GPS data and Vehicle ID and notify all the agencies. Or because the component has not been given a legitimate FACT code to operated in the United states from the United States Custom's agency kill all power to the unit and alert the authorities. How to use the technology constitutionally has to be agreed to and procedures and protocols applied.

Also, proprietary to the PFN/TRAC system is the incorporation of GPS receiver chipsets being installed in all new imported and domestic vehicles and a firmware program switch that turns off the car within 20 miles of the nations boarder and only the customs agency can give commands to the vehicle to operate them for clearance via their operation.

Probably apparent to the reader is the fact that some Telematics could easily be used as a weapon against the United States and the PFN/TRAC system is full remote control and robotics and therefore must lead the way is safe manageable and accountable wireless machine messaging. This is why the unit is protected in an encasement that is tamper resistant and detective. Even to share control of equipment, vehicles and aircraft these systems have to be protected secure and their data maintained in a pristine condition to be reliable and accountable as their human counterparts for these functions.

Returning to the drawling; the red bar to the right is Homeland Security (HS) TSFACT matrix of DOT related networks for air, land and sea transportation. FACT applies to all government agencies and they are to be integrated with in the FACT network as applicable. This DOT security matrix is essential to national security today and exemplary of how the PFN/TRAC system operates. The top TSA FACT intranet is Air and to the right are the individual servers. Some are agencies and some are commercial servers. They all have FACT interfacing and the commercial entities enjoy a slave relationship to TSA/Fact directives. Normally, IP protocols and internet connections are doing regular PFN/TRAC management business helping to recover portions of lost shipments between freight forwarders, delivery companies, haulers, port authorities, rail systems via the interactive 1Ps tracking and telemetry sensing portable network of PFN/TRAC units. At all times data is recovered and run through automated assessment programs looking for public safety and national security flags through out he entire FACT network. The PFN/TRAC system is a developing movement management system with individual clock synchronized via the GPS updating of GPS coordinate packets. This can be done for stationary assets as well to determine fixed locations.

Additionally, the 1Ps devices or minute wireless units can have their positions identified via an automated triangulation algorithm using multiple confirmed GPS readings from larger PFN/TRAC units. The following is a greater description of the interaction between the various wireless derives in the PFN/TRAC System and Fact security program

The PFN/TRAC Difference

One major difference is that it incorporates every technology out there. It begins by linking data streams from existing wireless technologies (RFID, etc) and sensors like the 1Ps HS1 sensor platforms into smart cell processing pockets with larger PFNTAC units. All activities in these pockets are geo and time synced and married together as a portable network of mindful machines, smart materials and smart people (hopefully:). These processing pockets are made up of individual PFN TRAC units processing, recoding and reporting data via dedicated short range communications DSRC to each other in a group determined by a floating algorithm setting up each Geo/time sync group. (Programming determined from FACT operational procedures and specific application and then protocols and or standards are structured (if necessary) and then all is written into code for appropriate programming per application specific PFN to process data from the unit and other surrounding wireless devices.

This is the assimilation of data at the local level is accomplished by using every persons movement coordinates, every vehicle's movement coordinates, and every stationary machine's known coordinates to project all the activities and movement of materials into through and out of the port or airport etc. FACT determines immediate threats and checks available first response assets and gives appropriate local alerts and warnings to include a Prot lockdown/Terminal lock down etc and or evacuation clearance program if desirable.

System Wide Matrix of Intranets

Along with PFN/TRAC's regular long distant reporting for normal commercial freight telemetry to manage material and equipment movement the resident FACT emergency program utilizes these long distant communications (cellular/,wireless RF) to further report up the FACT ladder through wireless gateways and IP protocols to the Department of Homeland Security via TAS FACT intranets and gateway connections for Sea/Coastguard/Naval/OSI/ArmyIntel/CINC/NSA/FBI/and local law enforcement intranets. The matrix is complete locally and system wide via the Port airport terminal etc based TSA FACT wireless transceiver router with all know wireless technology regularly visiting the port or endemic to the area. This automated radio component is attached to a server in a secured building/structure at the port or airport. The total PFN/TRAC system with FACT is a massive computer power and connectivity locally that is always updated from every government agency and commercial intranet. This makes this technology different real different, and the federal access and control technology FACT is just what the ports need to link all the other technologies they already own. What advantage is it for the ports to use the technology vs. the multitude of others available?

Computer System OSI

Nationwide existing computer systems are to be networked via PFN/TRAC System and FACT Security protocols to complete the system architecture. The proprietary set of procedures standards and protocols determined or used as appropriate provide the needed seamless security the country must have better than anything else. The detailed architecture and procedures termed FACT for federal access and control technology are the best to implement, to process to link and best handle and store the diversand dispersed data from existing specific applications to serve government and commercial intranets in existence to day. The interface and computing power is intially local and also at the various needed levels with two networks TRAC and FACT constructed as a responsive wireless intranet with the existing WWW internet. The FACT programming in all the linked computing enclaves will be performing cross application factoring to determine and or predict a FACT event (e.g. Terrorist activity at the port or airport etc.). This process will develop systemic Artificial Intelligence AI, which will grow exponentially in time via the continual development of preprogrammed scenarios and a more intense understanding of what is normal and benign through the increased acquisition of sensed data.

Uniquely Different and a Distinct Advantage

Locally, this networking begins with wireless data streams obtained generally via dedicated short range communications demarked by PFN/TRAC geo- sync WLAN and employing existing sensor technologies with the PFN wireless plafforms capability to interface with other PFN/TRAC processors/the system of intranets both TRAC and FACT, which additionally provide the flexible protected PFN interface platform to augment the local TSA/FACT port authority Command Center and the sensing web with newer sensing technology as a continual improvement. (This provides forward and backward interfacing for a more complete and continual solutions at the port, airport and boarder crossing, etc.) Communication parameters of Fixed PFN's and Primary Movers to mobile PFN's within the same matrix network.

Inter-modal Connections.

Through the PFN/TRAC system and FACT, the port, etc is immediately linked with all it's stakeholders. Commercial intranets (shipping lines, freight companies, manufactures, freight forwarders, unions and labor forces, local law enforcement via and automated communications network of management via both PFN/TRAC commercial intranets and TSA/FACT intranets that are receiving and delivering data for TSA/FACT Security along with improving management and flow of material through the PORT. This is an incredible advantage in everyday processing and product tracking and essential during a FACT event where all freight systems can be notified in real-time of the nature of a Port emergency and to reroute materials to alternative installations (This provides great emergency traffic management)

TRAC Commercial Applications Enhanced

Additionally, redundant commercial tracking can aid Port management in locating lost shipments by up loading into the TSA FACT system sea intranet registry the data and signal ID ESN etc of the lost shipment or piece and a freight liner PFN downloading this information from the TSA/FACT Sea intranet via TSA FACT Registry program or as part of an enter message as the freightliner enters the port complex. The Prime mover truck, ship, forklift container crane etc PFN will quarry all contacted shipping components both commercial and governmental and the absentee shipment will be recovered by any of the PFNs and the proper authorities notified as well as all stakeholders in the shipment. (It has not been stressed to much in this filing but TRAC commercial intranets are of high security application as well. They will use PGP encryption and other forms of encryption of which they must provide FACT (Master Code Access). This system is to help law enforcement control theft of materials as well.

The system has to be secure for commercial interest and competition yet compliant with the nations needs. A violation with FACT clearances into a TRAC commercial intranet security system should be a federal offence and should meet with the highest of criminal and civil penalties. This should not be used as a fishing expedition either. Data recovered should and can be the result of a specific court order with real-time judicial over site by the court the authorizing court officer or judge via the PFN/TRAC system (connected in the investigation process). Both these systems TRAC and FACT rely heavily on public trust and this is needed for national security. Properly set up and maintained TRAC and FACT system hacking can be identified and in most cases thwarted, but rarely if ever unnoticed. The protection of the system's integrity is of equal and paramount value to all of us believing in a fair, free and just society.

Returning to the System Functions

Most importantly the nations boarders are pushed back and the Port authorities, airport official and customs will have an advanced look at the materials in shipment. Materials will be entered into a global tracking and telemetry program no matter when a PFN picks them up with identifiers or the absence of any. This allows the port to know every component being shipped in real-time the signature to expect the sensor array employed and the unique identifiers for each one of them. They will know long before it comes a shore at the port and this advantage does not only help Homeland Security, but allows the Port authority to prepare work staff and equipment needs in handling any freight or situation. This data is programmed in at the point of origin and properly disseminated back and forth through TRAC and FACT via FACT programming running in both application. This kind of inclusive management is quite unique. Relationship of fixed PFN's and Prime Mover PFNs in the Security Matrix and their communication with other 1Ps HS1 plafforms like the Tainer talker and other tracking necessary in tracking military assets in transport.

DSRC recognition 5.7 GHZ already approved for Interactive highways, Blue tooth technology, Texas instruments RFID and 802.11 are but some of the wireless interfaces that will deliver shot range data to the PFN platforms for repeating along with the 1Ps HS1 sensor platforms 916 MGHz—In setting up the PFN/TRAC unit as a local computing platform and routing hub there will needs to be a standards effort for PFN and telematics technologies to organize the hierarchy of activity control for TRAC and FACT (To be Industry and governmentally determined and sanctioned by FCC)

Real-time portable networks, the same geo-time synced networking used in the port is maintained for a group of assets in transit and as these portable networks move into and through the port—they can be quarried by loading personnel for clear and understandable shipment directions so that the integrity of the shipment is maintained. This provides a real-time inventory of all the port contents as an ongoing and continual accounting process. Through elimination algorithms and video and human observation detection of unknown or unmarked and non communicating materials will be detected and provided special handling. All transport objects must have an expected electronic signature detectable by the receiving array interfaced in the Prime mover PFNs and no FACT alert signal or they will have to be unpackaged and inspected. This local interface improves machine control and offers other technologies a more enhanced level of performance and market)

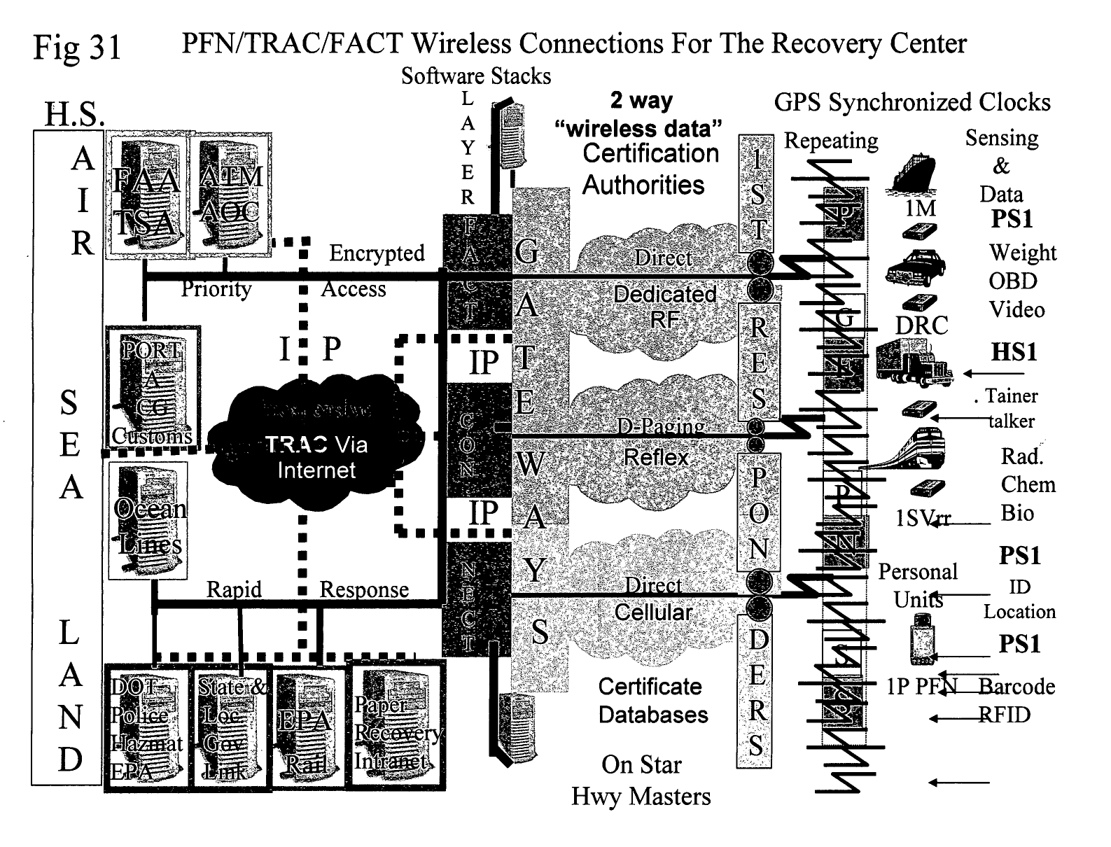

FIG. 31

This is an extension of 30 to Explain the Refuse and waste recovery industries interfacing with the FACT security network and government agencies like the EPA DOT and investigative agencies like the FBI, NSC and CIA Etc.

Post 911 Dilemma The recovery Centers Application of the PFN/TRAC system and FACT Security program relevance to national security is the direct monitoring and real-time control over the nations waste stream components to detect un safe, unusual and unauthorized use of materials, substances and equipment. And to perform monitoring and interdiction functions to protect the public in a constitutional manner that preserve freedom of movement and respect for privacy

This further breakdown of FIG. 30 FACT network architecture displays the commercial recovery center interfaced into the national Homeland Security network and regular Internet. It al shows the continual real-time reporting characteristics for efficient commercial material handling and the vast amount of data and information made available to communities government and industry for better planning in the use of resources and the impact on environment. Within obvious commercial limitations information is shared freely via near real-time posting of data via the internet connection to all relevant computer systems (the various Intranets). The separate RF wireless technologies assigned to the separate industry applications help isolate the communications via application specific PFNs for Air, Sea, Rail, and Highways. The unique advantage of the PFN/TRAC System is the local interfacing and translation to harvest data and process it quickly from normally disparate systems/technology/industry communications via the plug and play chip set transceivers and protocol processing chips inherent in the PFN ASIC architecture(first as hybrid substrates).

The progression of the PFN/TRAC technology calls for the recognition of the most ideal, needed interfacing to be further developed into SOC Systems On a Chip technology. This process makes for the continual and flexible development and teaches a progressive modality to incorporate legacy systems while advancing network capabilities to provide the most robust connections in message delivery, data sharing and data mining. The architecture also supports free enterprise and creative development with open and diverse options to interface at various levels.

To the right are both PS1 and HS1 sensor suites with the main difference being homeland security (HS! For detecting Radiation chemicals bio hazards or EDS explosive detection equipment, and PS1 or primary operational sensor suites incorporating on board equipment data sensors and add on equipment operation sensors for load and weight data calculation in real-time and engine temperature oil and water level sensing, etc. Included in the PS1 level data generating stage is the interfacing of scanners and RFID antenna interfaced with PFNs through direct connections and PS! Wireless transceivers to deliver these commercial tracking technology signals to PFN processors to run application level software process and retransmit this data t respective and responsive computer networks. Obviously some of the material and amounts may be sensitive commercially and standards efforts with government will be needed to handle these competitive concerns while maintaining the highest level of communication on public safety transport issues and national security threats.

To the left are displayed various surface vehicle platforms that will directly relate to the movement of refuse and paper fiber. Air transportation will not be discussed for the obvious reaso that not much recycled paper will be handled by air. However the waste recovery of paper fiber and transh removel will take place at airports and throughout the air travel industry for this reason application specific PFNs in the Transportation Security Authority (TSA) Federal aviationFAA Aii Traffic Management and Air Operations Center AOC will have all necessary wireless chipset to contact and query recovery vehicles PFNs and the personnel via the personal PFNs at anytime. Additionally the FACT control center in the Airport will receive all data downloaded to be stored in a archival file in the FACT Security Center Mass Data unit. The airport FACT system is well detailed in related filings. However as part of the FACT HS network normal movement operation are reviewed and used to develop normal algorithms and a basses to determine and unusual event or possible threat.

For this reason there are a certain number of PFNs in every system that have additional communication chips sets to perform these cross over industry interfaces and for inter-modal activities. This is represented by the various PFNs the 1M for marine, the 1sv PFN for surface vehicles (land) of which the DRC or Driver resource Center is specifically developed for cars and trucks and is shown here used in the police cruiser. This PFN development includes shared man and machine controls of the vehicle driver assist and collision avoidance, remote control and complete robotics of the vehicle and it's movements. All PFNs are to be progressive to help and or maintain vigilant safe operation of the equipment platform they are interfaced with. They are also relay stations to receive alert signals and retransmit them or a special emergency signal to the proper monitoring systems and management systems for the real-time remote control and or interdiction of illegal or unauthorized and or unsafe use of equipment vehicle or transported materials. Many PFNs will have preprogrammed response to hazardous material encountered in the normal movement or transportation of materials. For example if a higher that safe level of gama radiation is reported in the form of an alert signal from a His sensor suite mounted in a container stored in a field, the tractor would alert the driver the EPA, State Hazmat police and the Recover center with the proper government agency taking the lead with respect to the threat sensed.

As discussed in FIG. 30 DSRC industry specific and normal RF wireless would be in place and where long range links were required and absent the commercial wireless telephony would be employed. Cellular for larger amounts of data applications and reflex paging protocols for lesser remote signaling. Much of these applications have been detailed in the related filings and these guideline would be followed to create the most efficient and robust system and linking for the PFN/TRAC system. Looking vertically at FIG. 25 a line of boxes spelling out 1st Responders is parallel to the PFN GPS boxes outlined by a dotted box line. As detailed earlier each equipment PFN has a GPS receiver interfaced to synchronize timing and provide geographic coordinates to all messaging either directly for the PFN units or subsequently via a triangulation algorithm processed by 2 or more PFNs receiving signal from a PS1, limited RFID device or other identifiable wireless device. This is the bases for the PFN/TRAC movement management System. When desired destination is programmed into a calibrated digital map matrix program with finite movement adjustment augmented by real time sensing, collision avoidance systems can be enhance to project the best path and speed for robotics driving. Hence a means to have real-time automatic response to public safety and national security threats. These automation and remote control is a progressive technology to meet need today and to advance into the future. Right now the round circles in the first responder section are to indicate the quick turn around of data and control available to FACT government control through the PFNS on each prime mover. Each one of these certified communication clouds are set up with nenna numbers the nations emergency number program and will be tied to the 911 and first responder networks. The next step is to use these commercial communication computers to deliver a dedicated connection back to the alert signal PFN unit allowing either commercial or governmental security to intervene and control the prime mover of hazardous material or the unauthorized use of equipment. This is represented with the FACT direct solid lines. These are instant direct dedicated links tying computer access throughout all linked networks via local application FACT software running in each computer.

Most of the time data would be received and used for normal business but behind the operations level would be a FACT program assessing normal material movement and be looking for national or public safety anomalies in data processed. During off hours systems would download data for cross comparisons between agencies and commercial server and systems running FACT programs would direct suspect data to the agencies best suited to appraise it.

Recovery Invention's Communication Progression:

The wireless PFNs will report directly to the two separate operations or companies handling the trash collection and straight paper pick ups as is shown in FIG. 9. The wireless connections can first take place as a standard 2 way FM wireless communication system as is done by Motorola for thousands of commercial service companies to day. The PFNs will have a wireless gateway to a high speed internet connection and deliver suspect data to the EPA, DOT,NRC Police via a server at home offices of the companies or via Motorola switching and routing process of flagged data and Alert signals identified by the FACT security program running in each 1sv vehicle PFNs. Basically these wireless are interfaced in the PFN an will be a means to retrieve data and send remote commands in an emergency. This is represented by the very first network cloud. Two other wireless networks are represented because they are readily available communication networks that are ideal for isolated digital messaging and communication. Reflex paging is ideal for limited remote commands to activate preprogramming in PFNs or initiate robotics and AI functions. PFN/TRAC system software will determine the best communication route and wireless technology via running software in the PFNs and the computer systems by what it knows about the connection. This information or data is shared via the communication header. The many commercial Cellular systems including TDMA, CDMA and Motorola's Nextel technology round out the most readily available long range wireless connections and is the third net work cloud. As stated before and many times these wireless telephony technologies have been charged with the responsibility to develop unit location technology by the year 2000 and to be tied into the 911 and NENA emergency number program. While this is happening at a slower pace the PFN provides the means to detect wireless use more accurately via an automated FACT triangulation program and also use these networks to link machinery for an automated response to hazardous situations where humans would be at risk. They also provide the interdiction capability for the recognition and control of unauthorized and unsafe use of vehicles, equipment and materials in real-time or near real-time.

Additionally, the versatility allows for a PFN web or network to be formed with many communication options to keep a link up during an emergency. FACT secure programming is responsible for this robust connect ability and maintains an accountable record locally in the PFN and in all the Peta mass data systems of the networks commercial servers and company systems as well as in Homeland security data bases in the government. Obviously tracking and management of this data is essential to public safety privacy protection and national security and will require standards efforts form the public government and industry to insure the proper and constitutional use of this invention

At the bottom of this drawing are only two computer towers to indicate government linking of the data that is available both through direct FACT flagged events and also through the every day generated data streams that are to be available in varying degrees through the internet via selective access firewall. The names of some of the government data bases are listed in these two computer servers. Obviously they will have there own electronic addresses computer systems and data bases as well as, IP application software and possibly encryption.

Through out the related PFN/TRAC/FACT technology filings Richard Clark Walker the inventor of the system and technology has detailed how government sovereignty between agencies can be maintained via accountable access and how inter-agency cooperation can be enhanced. The value of every government agency can be put into context, improved and increased with less cost and more efficiency by being directly connected to the industries within their purview. However, this requires a mature approach from industry, the public and government. As part of the PFN/TRAC invention and this application specific to the innovative recovery center for handling recovered paper fiber, energy and the safe processing societies waste products the appropriate state local and federal government commitment and understanding is required from the outset so that business can transpire with the freedom of data necessary to take full use of both these technologies.

Inventor's discussion of the issues facing a standards effort for transacting open business between industry and government

Government Role

1 Penalty Free Abatement Program For Public Safety and Accounting Errors
Government use of data and information collected on commercial operations cannot be used to impose penalties or fines, initially.
Responsible and responding agencies must first evaluate the public safety hazard with business representatives and help arrange for tax credits and emergency abatement aid from state and federal revenue streams to correct any detected public safety hazards where the companies are struggling financially.
Companies not struggling financially must be allowed to effect change and abate public safety hazards at no cost to them commercially via tax reduction or credits they can receive and trade commercially to effect the repairs or use at a later time against profits.
Reasonable pay back arrangements should be available for struggling business of all sizes under these circumstances, to include the suspension of payments until solvent.
Education programs for business operators, workers and the surrounding public must be available and in place as part of the penalty free abatement program and suggested business direction requested to maintain a suspended payment responsibility.
Local and commercial lending interests should be brought into community meetings held to preserve and improve business operations.
   Inventor's Thoughts after 34 Years in Business and Industry.

Good Governance is the role we want from our government and that includes people in government and our business community as they are all citizens as well. The proper agencies have been wisely designed and created. The problem is we have cultivate a relationship between industry and government that is based on the profit of knowledge or the lack there of regarding the safe and proper operation industry and the impact of the use of materials and resources on our environment. Fourteen patent filings address this very issue with the solution being greater data recovered and more knowledge developed and available for better decision for us all to make a life together. This is the PFN/TRAC system of movement management for everything in the world. FACT technology was a program to provide national security written to as early as 1998 in the fourth patent application.

The point is this invention is the technology and means to protect data and deliver the essential information appropriately for us all to make a better life together. The government needs to take the lead hear by changing how we do business and make profitable to share this knowledge together, not perpetuate the use of knowledge against one another. By doing so we can change how our free enterprise system can be a better economic tool and meet the challenges we have taken on around the world.

Commercial Responsibilities

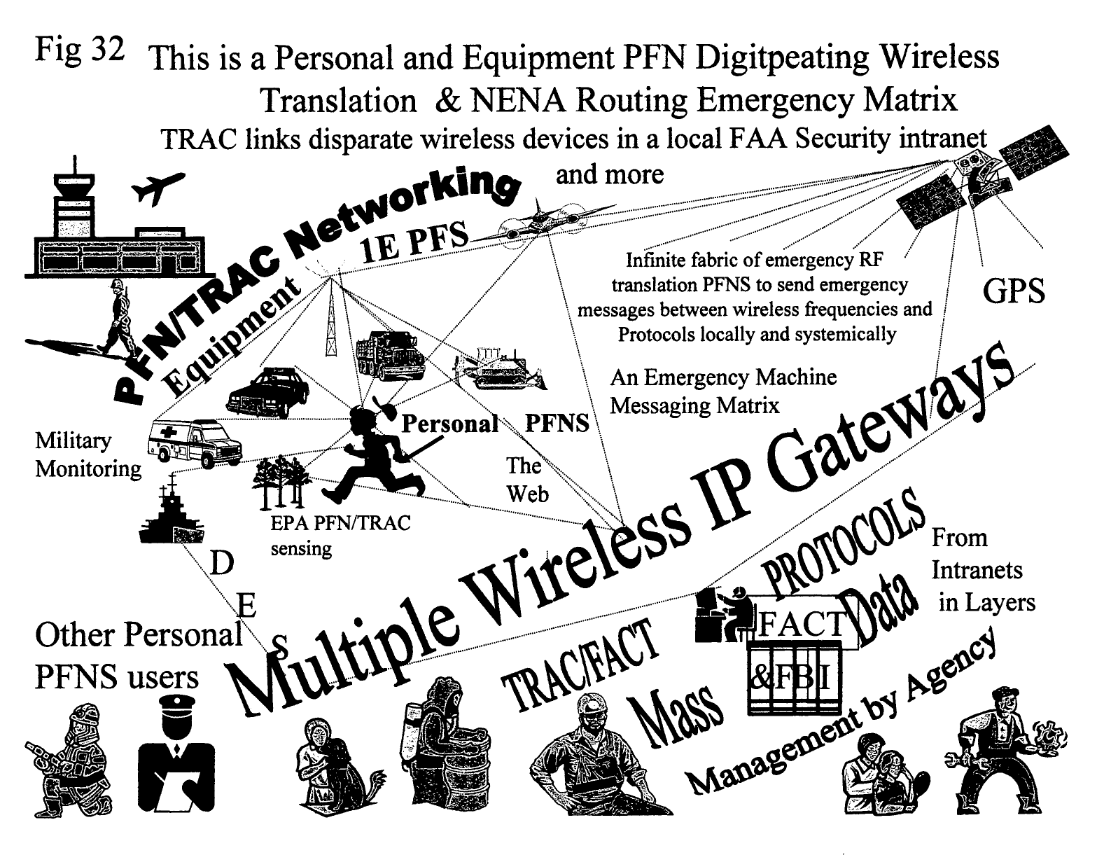

Be accurate and complete in reporting to data to the appropriate governing agencies.
Maintain good communication with the public and surrounding community.
Provide a worthwhile product and or service to the community for a reasonable fees.
Work with the community to provide the safest most efficient and environmentally sound work place.
   The Public Responsibility:
To be completely informed and objective.
Respect the cost of doing business.
Public ally participate in the process to improve government and business performance.
   FIG. 32

Individual PFN application taken from Airport application of the PFN/TRAC system 111248-1100 FACT security for homeland security in an airport facility. Different short-range frequencies. This figure is used to show how the individual is interfaced into the system and can perform remote control locally and be monitored for safety anf security during normal operation. The final application will fill out the particulars for the innovative paper recovery center.

FIG. 32 This Figure illustrates a wireless tracking network locating a lost child. The same process would be used at an airport to track human movement and interface directly with the machines vehicles, equipment and aircraft in the PFN/TRAC management matrix and seamless security network. All types of 1P PFNs or 1ps Standalone (totally self powered units) communicate with the 1E equipment, 1SV surface vehicle PFNs 1a tracker units and 1A PFN/TRAC units.

The personal PFNs can be belts like the ones used later to detail types of wireless communications and they can be placed on or in people, equipment, machines, materials, baggage, to for a portable network to track a desired mass of assets traveling or being transported together or a way to follow each and every piece of material anywhere. These self powered 1P PFNs are generally limited is size, amount of wireless options and their responsive distance, therefore the repeating and relaying of messaging is a major function of the system.

Small low powered transceivers transponders and technologies like RFID tag, are able to function through the repeating function of the PFN/TRAC units in each vehicle and equipment platform where there is stable current to energize functions and re-energize emergency batteries to insure a consistent reliable and redundant network function through mass mini repeating stations or routing nodes. Not only for tracking and telemetry of movement but to perform bi-directional accountable remote control via the machines that hosts these PFN units.

When the personal PFN/TRAC units attached to individuals communicates with equipment, machines, vehicles and other PFNs capable of repeating emergency messages through translation or repeat communication protocols and relay messages via more powerful equipment PFNs with long range communications and stable energy sources their limited range is given far greater reach to deliver data. The flexible mobile web allows for endless tracking and accountable robust remote activity control if deemed necessary.

For an example, personal units can be designed for criminal applications (and indeed some similar devices could operate to increase their distance through FACT network and PFN/TRAC repeat technology. Other applications include; child tracking, medical telemetry with automated medication and or for the criminal or criminally insane being transported by air transportation. Even debilitating responses in an emergency can be sent if considered a viable solution (These are at best near real-time though—it would be ideal to have real-time monitoring at least) These units could interface through aircraft, cars, trains, a bull dozer, a printing press or any machine using PFN/TRAC Unit and FACT programming allowing for the tracking through out a national matrix of responsive PFNs. Possibly used with illegal immigrants that may have questionable intentions in their visit and or the conditionally released to provide more freedom of movement with an improved level of public safety. (Uses to be determined legally and practically)

These devices can be configured to provide Biometrics from the individual wearing them and with scanners and sensors interfaced to these units (and other PFNS) these units could recover the same kind of data from others if the need be (e.g. applications like nurses, doctors, EMTs, stewarts, pilots, police and even the mechanic or service personnel for ID purposes via the Biometric data transfer. 1P personal units would have value for flight crews to determine healthy authorized flight staff or the medically ill when transported by air, or for tracking children traveling alone, pets and or those with diminished mental capacities. The specific intranet systems could always be in contact via the matrix of equipment and 1P PFN/TRAC units.

Additionally these personal units if only DSRC will translate and relay to Cellular in on board TRACker units and or 1A PFN/TRAC controller/routers to link personal body telemetry (Heart and respiration ) via fabric sensors supported by belt, bracelet and or band mounts or implanted in a personnel to feed critical data to surface security and or medical experts providing real-time connectivity with the most up dated information to act upon. These systems will support ID sensing systems so that Flight crew and airport authorities and legitimate work personnel can process any individuals ID information or data. Either digital Iris scan/face scan or magnetic swipe or canvas for data via smart card or finger print or DNA technologies. The units provide for sensor arrays to be powered and to process their data back to the TRACker Unit or any other PFN/TRAC unit 1E 1A or another 1P PFN in the machine messaging matrix either aloft or terrestrially through the terminal matrix and elsewhere via long distance dialups to special NENA data gateways via cellular interfaces for all specific intranets. This creates multiple modalities of connectivity for redundancy.

Description of triangulation and miniaturized personal PFNS

The equipment units fixed positions are known or determined from interfaced GPS receivers that apply location data and the units electronic identifiers ESN or other industry standard for tracking in the unit via the appropriate FACT intranet and registry. The identifiers accompany any retransmission as well as a strength of signal received coefficient for processing and display via the application specific programming in a capture window (of txt, video, audio, graphics, and with any warning alerts on a calibrated campus map and or terminal floor plan displays in the FACT'TSA terminal center. With a number of 1E, 1SV and TRACker PFNS providing (strength of signal coefficients) from their known locations to be factored by a triangulation algorithm running in the FACT Security program, seamless inexpensive tracking of the less powerful & simplistic transmitters can be accomplished. The software would adjust through the real time multiple receptions to the varying strength of the power source in the weaker short range personal PFNS and the location is determined by strength and timing of the signal vectoring to known PFN locations with a reception history from these specific coordinates.

The actual received signal might be a combination of a primary signal and several same signal echoes recovered by a PFN. Because the distance traveled by the original signal is shorter than the bounced signal, the time differential causes two signals to be received. Fixed addressed PFNs or with hot GPS readings would archive and compare a number of signals received from these minimal current 1P PFNs or COTS RFID unit (twin antennas interfaced in the portable network matrix of PFNS). These signals are overlapped and combined into a single one. In real life, the time between the first received signal and the last echoed signal is called the delay spread, which could be as high as 4 μsec (not RFID). The echoed signal is delayed in time and reduced in power. Both are caused by the additional distance that the bounced signal traveled over the primary signal. The greater the distance, the longer the delay and the lower the power of the echoed signal. You might think that the longer the delay, the better off the reception would be. However, if the delay is too long, the reception of an echoed symbol S1 and the primary symbol S2 can also interact. Because there may be no direct path for the incident signal in non-line-of-sight (LOS) environments, the primary signal may be small in comparison to other secondary signals. In analog systems such as television, this multi path situation can actually be seen by the human eye. Sometimes there is a ghost image on your television, and no matter how much you adjust the set, the image does not go away. In these analog systems, this is an annoyance. In digital systems, it usually corrupts the data stream and causes loss of data or lower performance. Correction algorithms (fuzzy logic etc)must be put in place to compensate for the multi-path, resulting in a lower available data rate. With this algorithm written in to the translation and routing program running in receiving PFNs the mini data packet recovered from these minimal personal PFN units or inject able PFN SOC units can be accurate and used to locate the exact position of the 1P PFN transmission in comparison to the receiving equipment PFN (bigger PFNs with GPS) This multi-path signal propagation has it's signal strengths evaluated by the program running in each equipment PFFN receiving the signals. Each equipment PFN sends its processed position evaluation to FACT central in the airport terminal in this case for the FACT system computer to final process all received signals from the equipment PFNs.

This tracking modality is piggy backed on the data translation and error correcting software program and can be evolutionary in the important effort to miniaturize singular purpose PFNs with no GPS to minimally powered tracking and telemetry units. This will enhance tracking immeasurably in the PFN/TRAC portable network, resulting in simple application specific SOC telemetry or transponders that can be concealed in or on a mobile object or garment or even implanted via injection or with minor surgery into an individual and report biometrics with location from all the PFNs receiving and tracking monitoring and recovering and reporting telemetry and location to the FACT Security system or managing movement of material and people via the PFA/TRAC System. On application for these 1P PFNs is for mission critical flight personnel—to insure a healthy authorized pilots are interfacing with the aircraft controls monitored by ground and air security via the Isolated TRACker unit on board picking up the 1P units signal another 02.2 grant application).

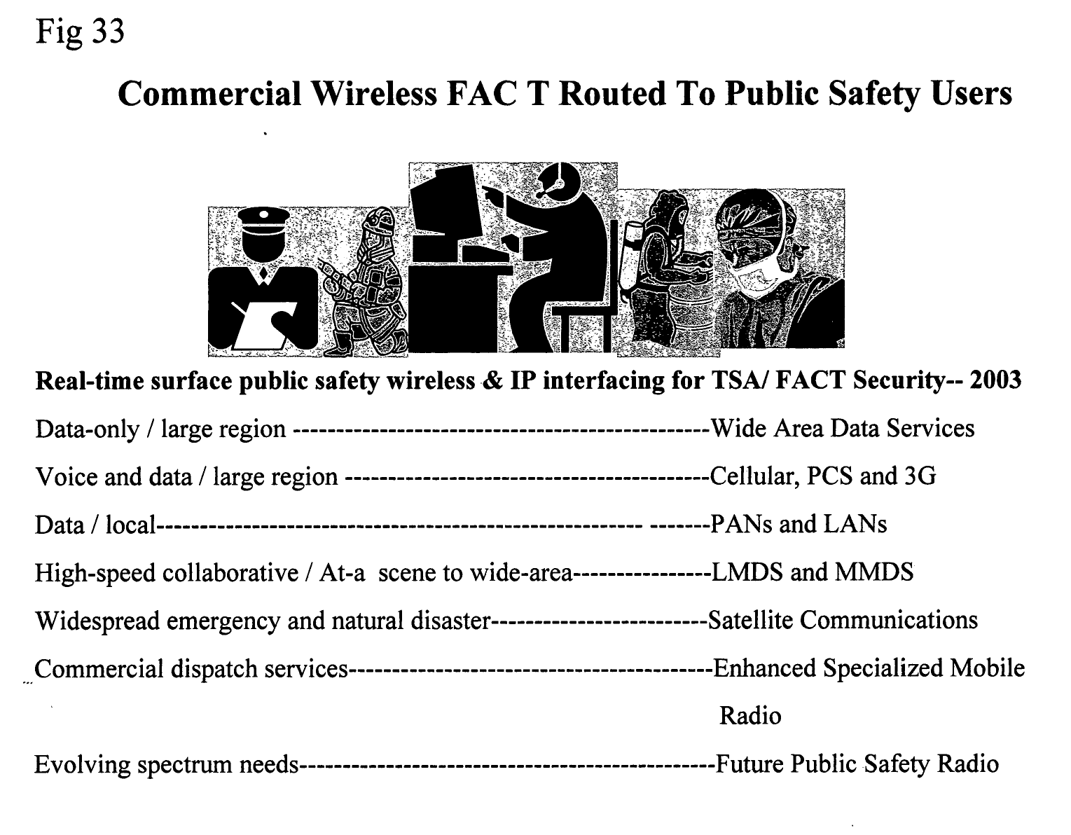

FIG. 33

This figure shows the basic wireless communications being considered for the first responders to have access via local 1E, 1SV, 1Ps and the TRACker units through responsive connections with their 1P 1Ps personal communication interface belts or other personal PFN configurations; supported by the PFNTRAC/router architecture. The wireless interfaced will be available for FACT Security functions. In coming data to a FACT event area will be supported by every working PFN/TRAC unit and have that data and information delivered on interfaced displays and audio systems for the best possible human to machine interface and control. Additionally, to these wireless services would be various DSRC communication would include in some cases infrared and laser communications for local LOS or line of sight machine messaging, access and control functions. This provides the first responders entering or arriving at an airport and or seaport the wireless controller to remotely control vehicles and equipment via the 1Ps PDAs or 1P PFN belts so long as they are authorized. These applications are detailed in earlier terrestrial PFN/TRAC applications for local law enforcement tools as part of the Federal Access and Control Technology.

Example Application

1E PFN equipment controllers coupled with building security systems, can make above wireless links responsive with public, address systems as well as, mass phone and computer messaging system to warn civilians of impending danger. All initiated from an early warning triggered by a flagged flight trajectory processed in an ATM/AOC system from a TRACker unit). Other security markers would be used as well in a FACT program (pilot/passenger panic signal or video surveillance surface monitored) to determine any flight threat and coordinate surface response from FACT/TSA command system processing GPS/geographic coordinates preprogrammed as high probability target profiles.

If the flagged FACT flight continues on a probable collision pathway (Algorithm) updates to homeland security change colors in all HMI Display units and communication mediums for general response and specific area responses. Then local tactical command gives minute by minute optimal instructions to manage emergency evacuation procedures to the weakest link—the properly trained citizen. (just kidding)—humanity responds remarkably well under pressure —when properly trained to use a technology—this training is quintessential. A total response could include operating People Transport devices (elevators and access ways) as well as, fire prevention, smoke and ventilation controls remotely and optimally to save lives. Additionally, People would be specifically trained to perform virtual fire fighting from special command support centers locally (safe position) and from remote locations. Support and assistance through building robotics and building occupants that were educated in Civil Defense procedures and protocols could help immeasurably. Personal PFN units with their GPS coordinates calibrated on command center map displays as mobile assets, coupled with public safety radio and commercial TV coverage delivered directly to the first responder and all area wide PFNs will also aid immensely to coordinate the rescue effort. Hopefully, coordinated communications in all remote command centers with all the individuals responding locally can limit the loss of life experienced by NY firefighters responding to the WTC—No.1 Tower. With coordinated well informed communications and the lessons of 911 learned, we can help protect the brave men and women that perform so special of a public safety service for our homeland. (Action plans that correlate with automated HS color codes in response to data received and processed can alert everyone to work together and well planned procedures and protocols with every citizen working with the first responders and coordinated equipment will give more of us and hopefully all of us the edge we need in any FACT event. Additionally the first responders wireless 1P PFN and equipment and vehicle PFNs will be in direct communication with the HS1 Sensor platforms security computer programs an can down load the data needed

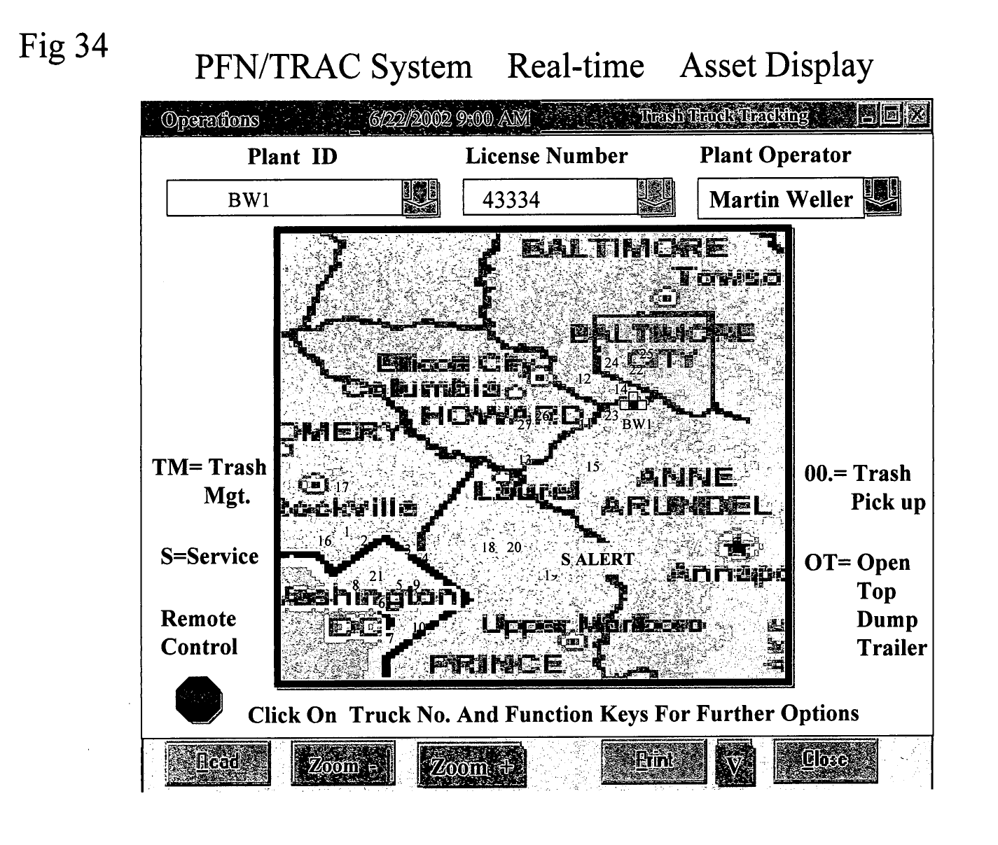

FIG. 34

Much time was dedicated to how the PFN/TRAC System FACT Security program to explain how the movement management system can be used to provide the United States flexible boarder security and maintain freedom of movement throughout the nation by changing the way we do business. By using the same wireless sensing technology and PFN/TRAC repeating stations and equipment controllers the operation of the plant can be maintained and controlled. The following is a windows application of the entire plant as reported by the various equipment PFNs.

Plant and Transportation Operation in a Windows Format

The trash truck operation shows all 36 refuse trucks location in the Baltimore Washington Corridor. Some of these are front end loaders with weight sensing hydraulics, some are rear end loaders with hydraulic sensing/winch and cantilever algorithm and fuzzy logic software, a lot are roll offs picking up compaction containers will have PS1 sensor units and stationary weight sensors.

The Roll Of truck 1SV PFN will have a resistance sensor and algorithm similar to the rear end loaders and be able to report semi accurate weights in real-time for exact readings taken at The Recovery Center with a fuzzy logic augmentation process gauging vehicle resistance for more accurate weight approximations. Other real-time readings are taking place via the aggregate tire pressure change of the vehicle after each pull. The on board 1sv PFN computer processes all available input data from the above weight sensing technology to include any COTS systems to determine the most accurate pull weight to be factored into the recovery and waste removal process. Customer paper weights are determined at the tipping floor automatically via the ID bagged paper fiber scanned and voiced in at the debagged machine. The customer number and bagged paper weight is individually invoiced in a comparison algorithm reviewing total pull weight to accurately credit and charge the account for paper recycling and waste removal. These figures are posted in within 30 minutes of processing in the recovery center on the customer web site, that requires customer ID and pass word and is either PGP encrypted or of a more customized nature. (Security protocols to be determined by nature of customer business and any specific waste processing requirements)

The trash locater graphic can zoom into a truck's street or facility location as accurate as 3 meters with GPS. In non-GPS locations the stand alone and or equipment PFNs can be placed to repeat the blocked signals and deliver a triangulated position of the vehicle if this is needed or desirable. If of course it is a secure area such as an airport facility of government installation the 1SV PFN will report solely to the facility command center (FACT Security) and clicking on the truck number will connect the recovery center personnel with the command and control center for an isolated display data link of the trash truck or the recovery center will be denied such information. Either via DES or any application specific military or government encryption the relevant government command and control Center(s) via FACT programming in the 1sv PFN of the trash truck will have access to all data generated by the trash truck operating with in the facility. They will be able to remotely shut the vehicle down or operate it to a safe area and or off the premises. Hitting the stop button lower left allows for all these options.

And if it is to risky that one of these trash trucks is incommunicado because it is at a sensitive government operation special FACT trade secret programming can be employed to control truck tracking and data reporting as well as refuse and fiber recovered in a secure manner via a special material handling process.

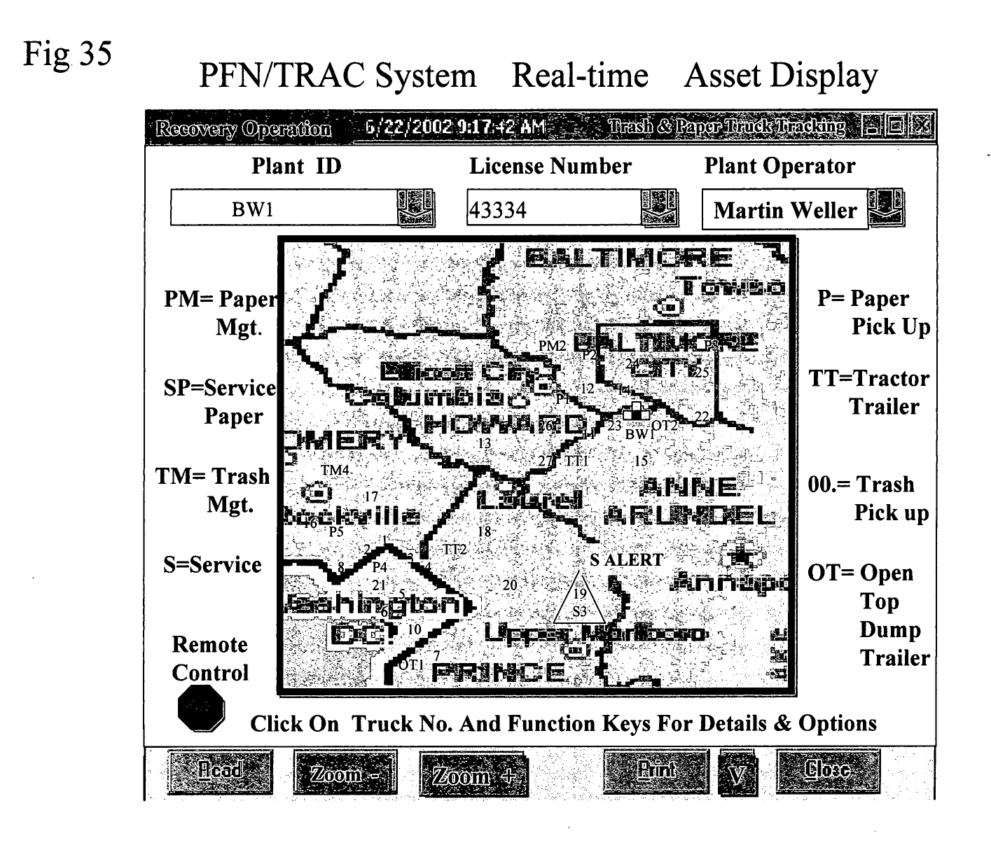

FIG. 35

This figure basically shows more assets in windows format for easy identification for the plant operator to over see The Recovery Operation. In this diagram there are more assets pertaining to the general operation and not jut the recovery of office waste and dry trash.

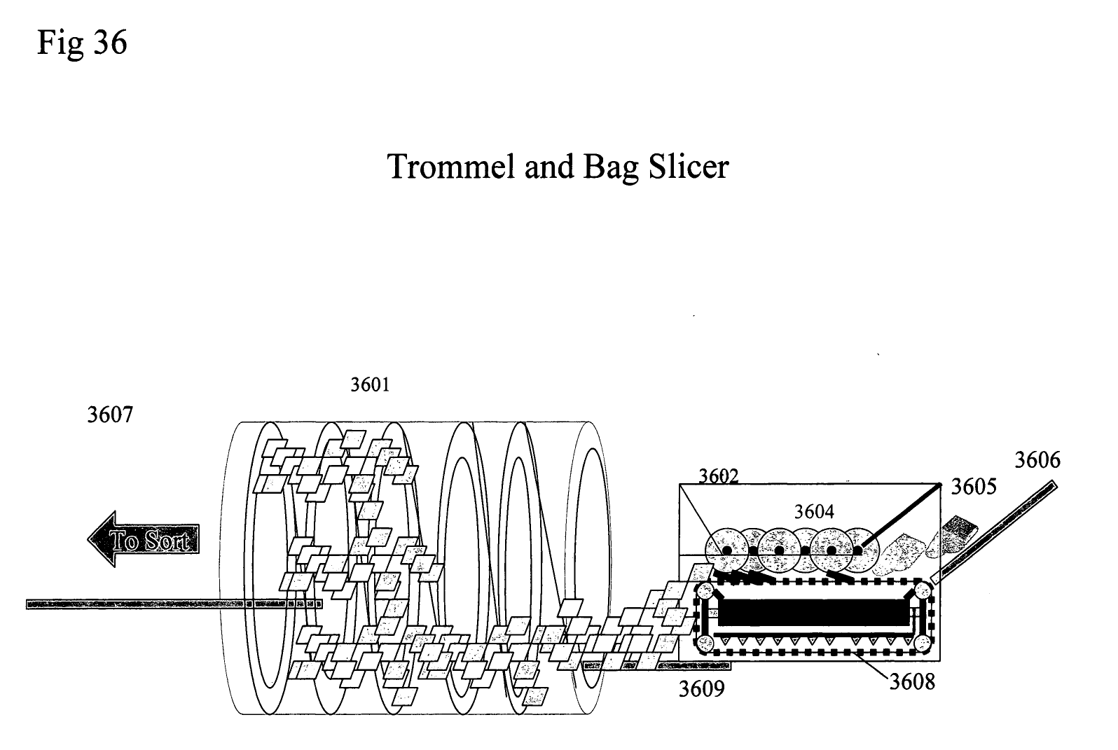

FIG. 36

This figure is a Trommel and Bag Slicer for the most minimal de-bagging needs 3605 bags are dropped onto the entry slide 3606 and slide under 3604 where the slit in to small strips and the contents fall out on 3608. This belts a web with big spaces to allow for garbage to drop to inner belt 3603 where it is carried off. The released waste paper travels on belt 3608 to it falls on the inspection station plate 3609. Here zerox print cartridges and other contaminants are negatively sorted out of the office paper.

3601 Trommel section is used when the paper in the waste stream is in clumps and needs to be spread out for easier sorting on Recovery system belts. 3607 is a take away belt to sorting. These two machines may be placed together and they may not or they may not even be required for some waste streams

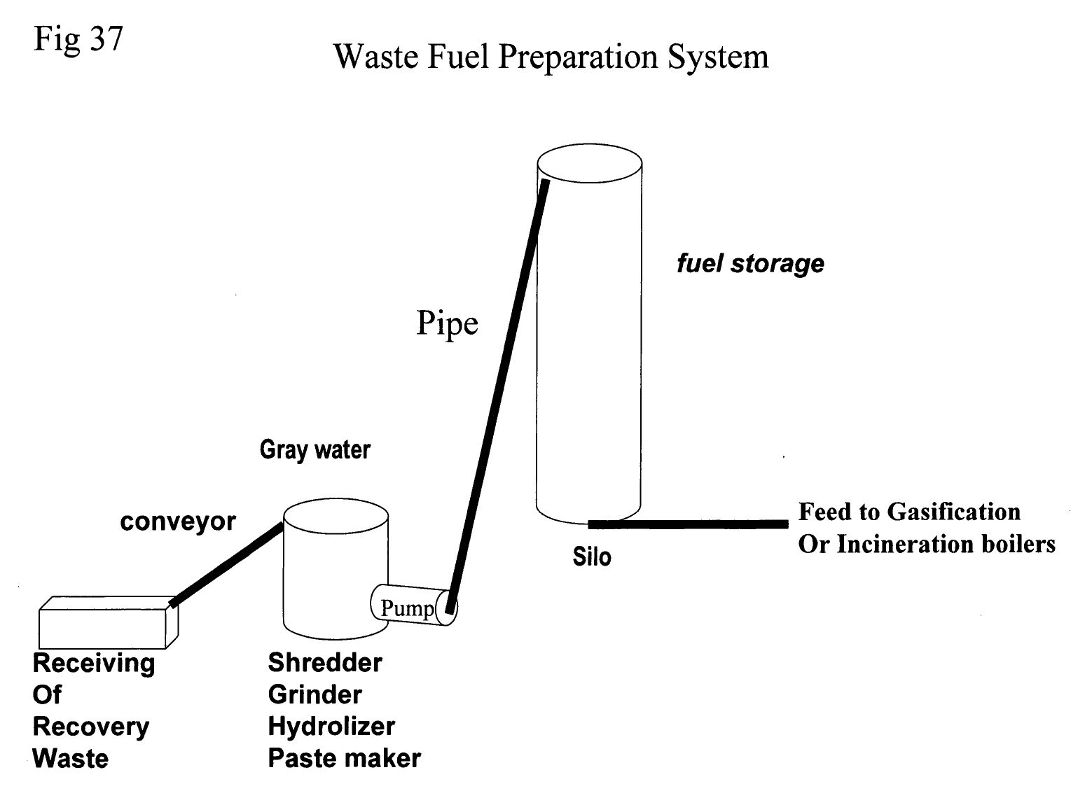

FIG. 37

This figure and the second figure are to introduce the gasification process as as a replacement or supplement to waste incineration steam generation of electricity. There are many commercial products on the market to be used in this function, and there are innovations that are Unique to The Recovery Center.

The basic process starts with the non recyclable combustibles which fall through the screens and or are discarded through the sort process. That material carried out on the pit conveyor is sorted for large metal and other materials that would not operate through the auger feed from the silo to the gasification reactor or boiler(lower right black line). The pit conveyor delivers the waste to receiving conveyor where it is loaded into a shredder/grinder and has water added to make a consistent past where it is pumped up into the fuel storage silo as a paste and then fed to the gassifier or boiler

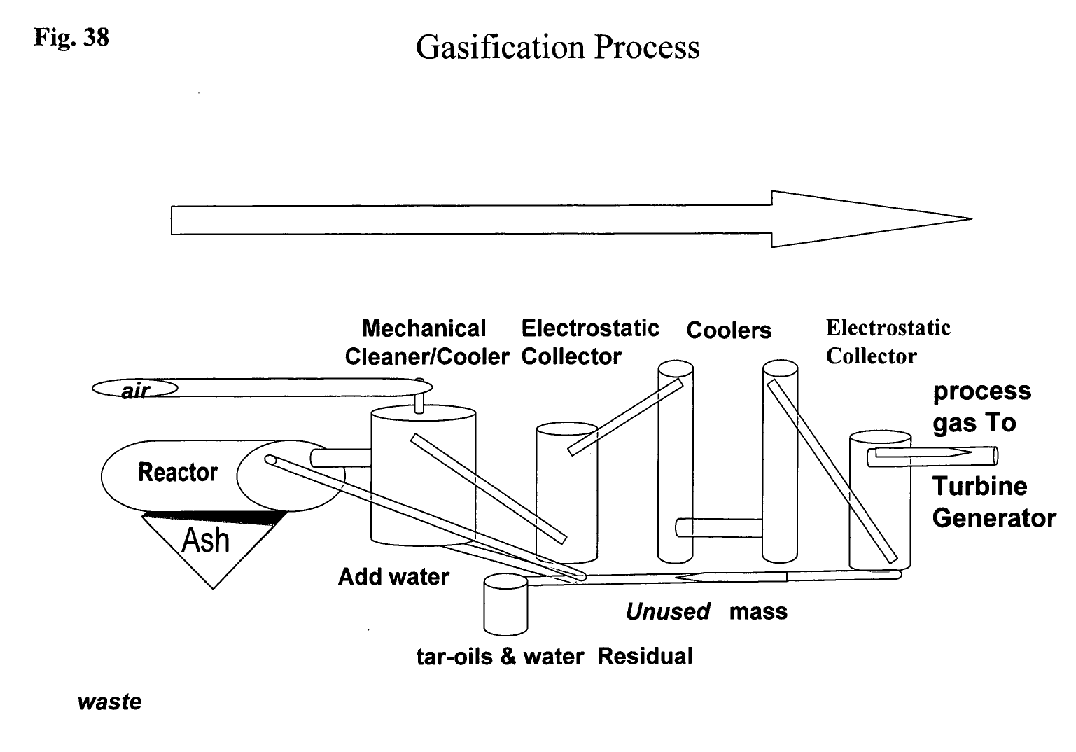

FIG. 38

There are many gassifier manufacturers as well, however The Recovery Plant uses them in a unique way to utilize not only the electricity generated but the heat as well and the filtration of the water through condensation.

The fuel paste is feed into the bottom of the reactor where it is heated up just prior to flame ignition. Just to the point that smoke is generated. Air is added to it and it is sent to the cleaner cooler, then a electrostatic collector, and two cooler or chiller stacks with residue dropping into oil water separator with sludge and tar collector pipe from another electrostatic collector that returns to a pump reservoir that allows it to separate by specific gravity which yields more recovered products like heating oil. The cooling tanks and towers throughout this process are passing super heated liquids out to heater plates that dry the absorbent pulp. And the processed gas is fed into internal combustion turbines that drive electric generators at The Recovery Center. The gasification process is not fully detailed here because the waste stream will dictate the processing and this is not a gassifier patent application. However, it is a patent application claiming the use of gassifiers to generate electricity heat and oils as part of A Recovery Center technology to produce value added products out of collected waste materials, rather than dumping the material.

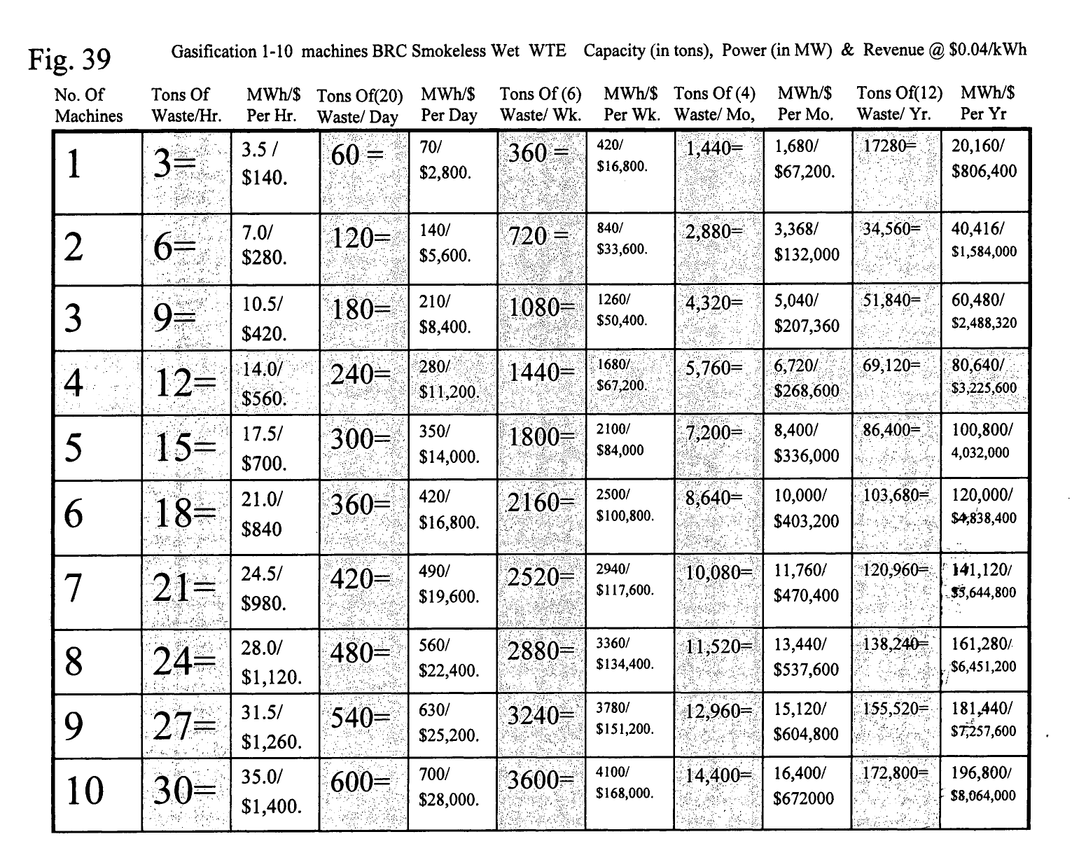

FIG. 39 The BRC the Baltimore Recovery Center project projection for gasification and turbine generation rather that incin erated waste and steam generation. The following is a description of the electrical terminology to read the chart of projected current generation.

An ELECTRIC DISTRIBUTION COMPANY is the regulated utility that owns and operates the power lines and equipment necessary to deliver purchased electricity to customers.

Electric Generation Supplier (The BRC) An ELECTRIC GENERATION SUPPLIER is a company, generator, broker, marketer, aggregator or other entity licensed by the Public Utility Commission to sell power to customers. The electricity is transported to customers by the regulated Electric Distribution Company.
Kilowatt (kW): A unit for measuring electrical energy. 1,000 watts=1 kilowatt
Kilowatt Hour (kWh): The use of 1,000 watts of electricity for one full hour.
1 kWh=ten 100 watt bulbs all burning at the same time for one hour.
10 bulbs×100 watts each×1 hour=1,000 watts hours or 1 kWh.
MW=Megawatt,=one million watts, or 1,000 kw
Gasification=the heating of combustible materials until they smoke and smolder in a reactor/containment and then use those gases to power an engine and generator combination to produce electricity. This is a SMOKELESS process
Recovery=waste recycling for OEM products/Components and the conversion of waste to energy
WTE=Waste To Energy

In the following drawing the gray lines are the tonnage we will handle and the green lines are our initial projected equipment needs, for ourf second year(within the first year of opening October 2004-October 2005).

In 3-5 years there is an additional 6 machines to=10 106 machines Maybe more Purchase

Cost of machine set up—goes from 6.5 million down to 4.5 million for four or more machines at one time (Approximately)

FIG. 40

This drawing shows the construction of two steel buildings where existing buildings are not compatible with the application. These buildings are used to illustrate the 10 square foot sensing grid set up to locate equipment and materials. The grid is the bases for a calibrated map of the facility as well.

This figure displays building a Recovery Center facility from scratch and the components could be permanently housed inside or shipped in via rail or truck for a temporary center.

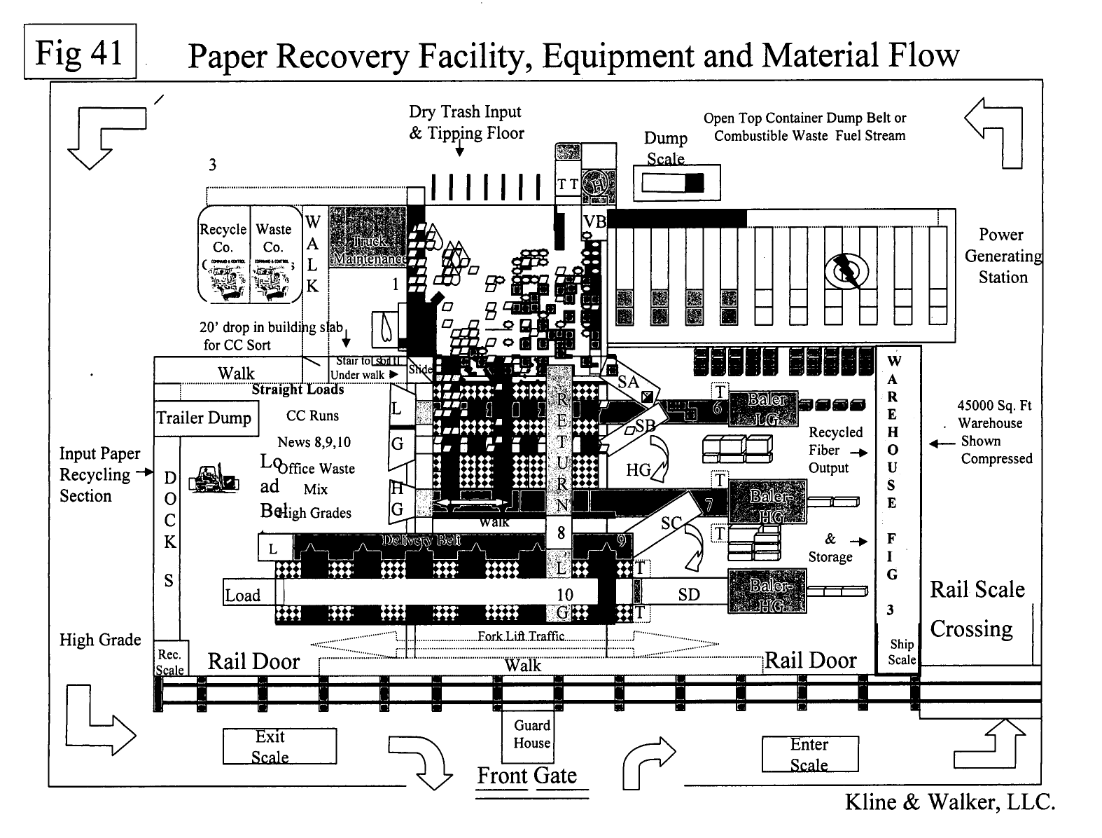

FIG. 41

This figure was explained as FIG. 2 with the exception of the gassifier stations to the right where the incineration steam powered generators or power station was located. In some cities the there is a prejudice against smoke stacks even if they are scrubbed. For this reason the gasification process still provides the electrical generation component in the Recovery Technology.

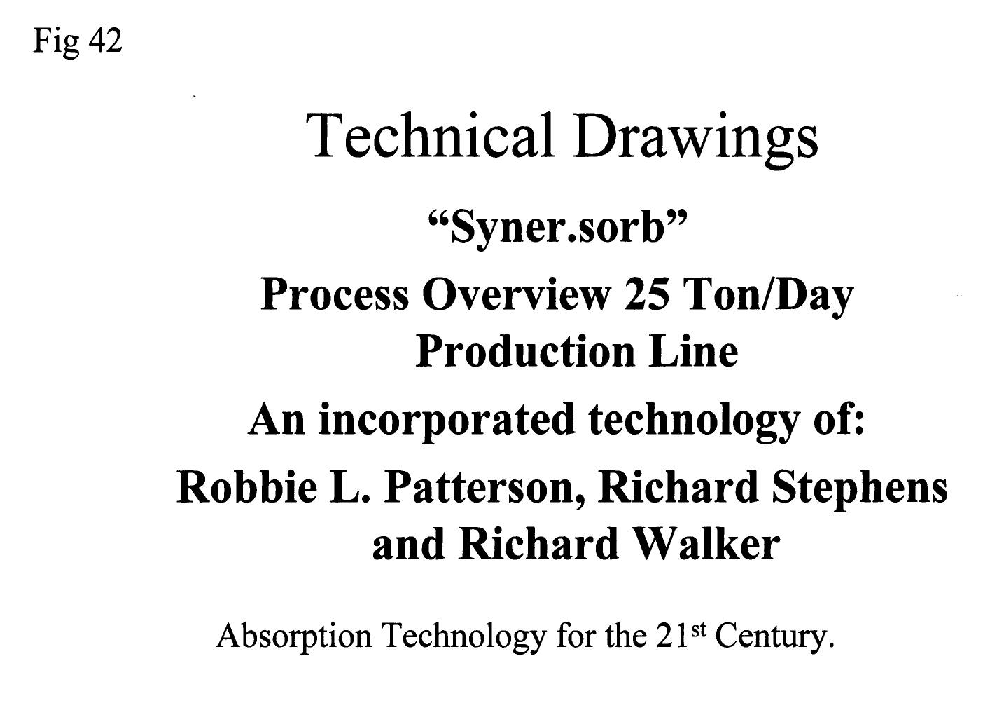

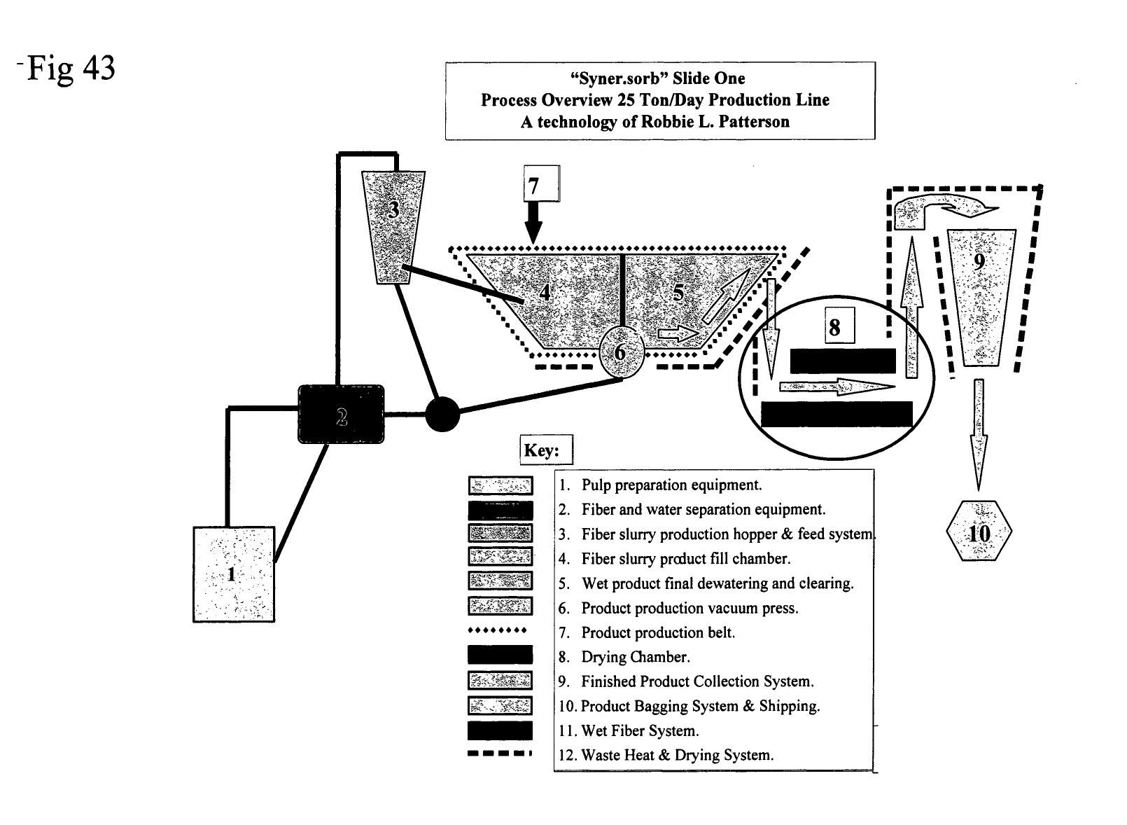

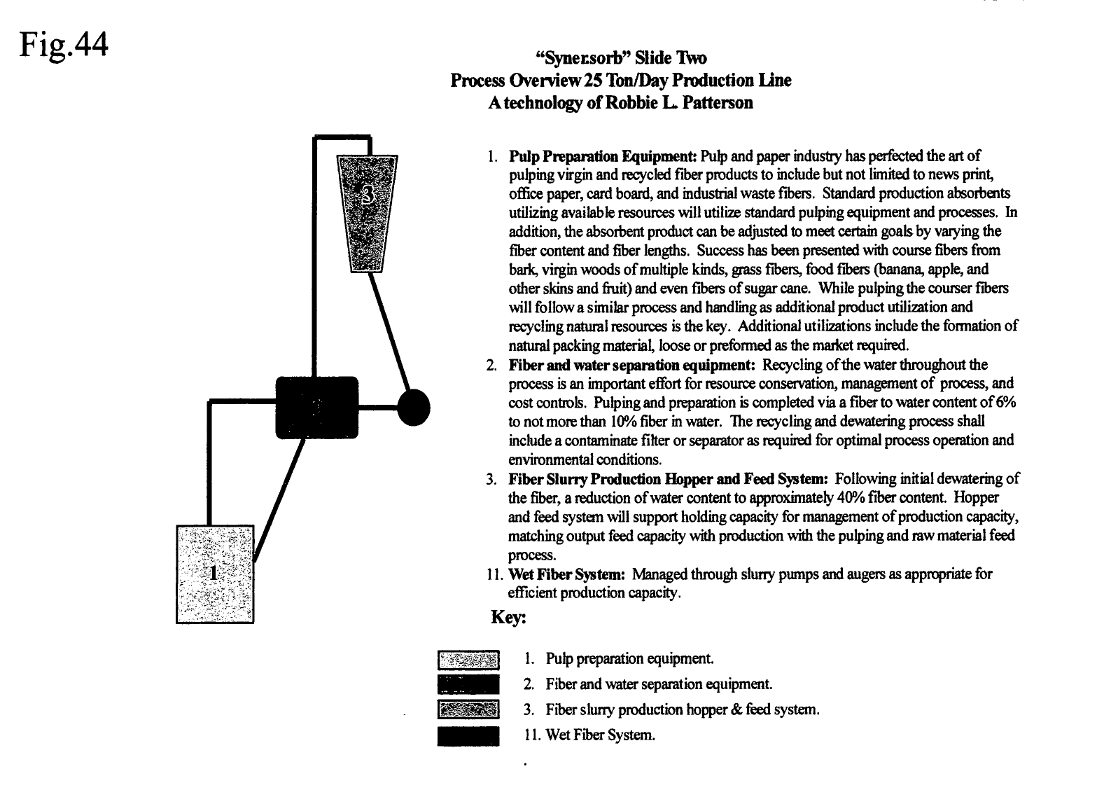

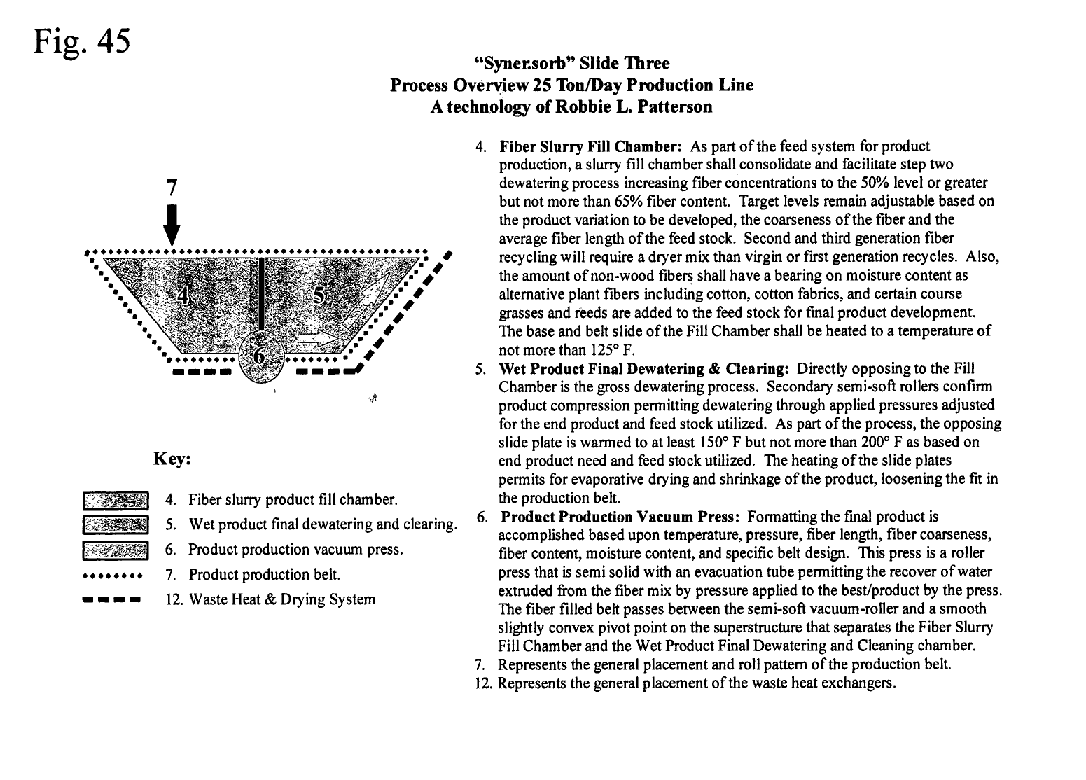

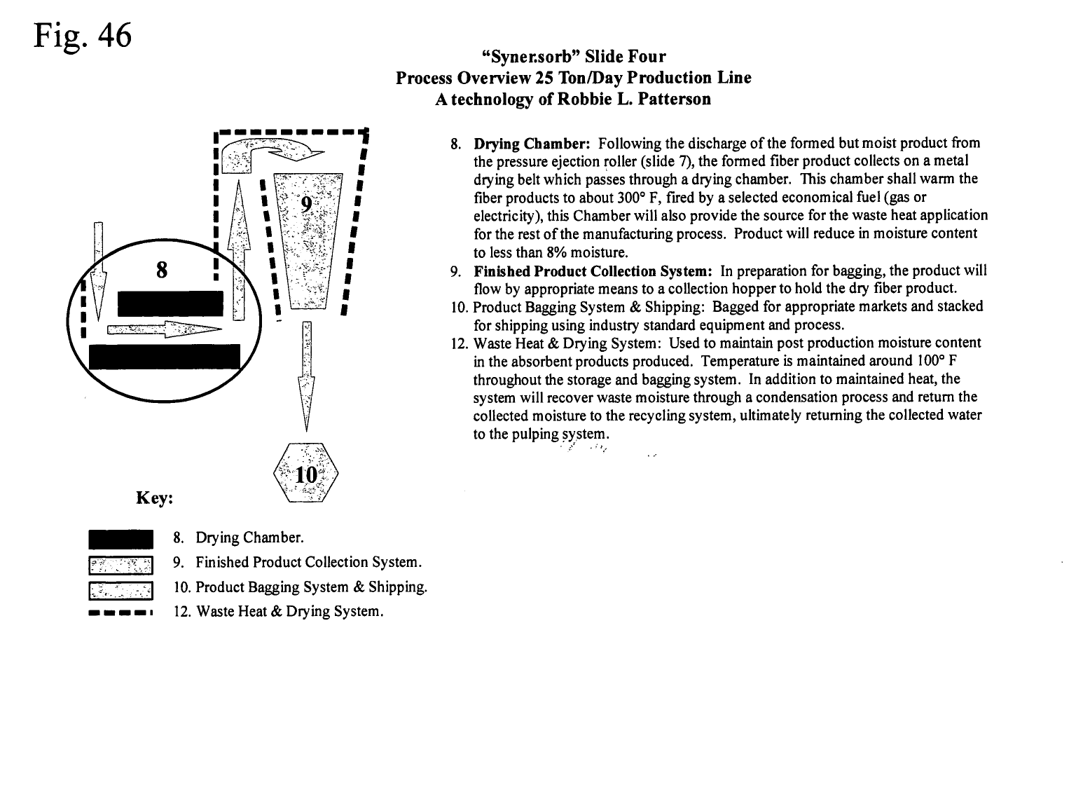

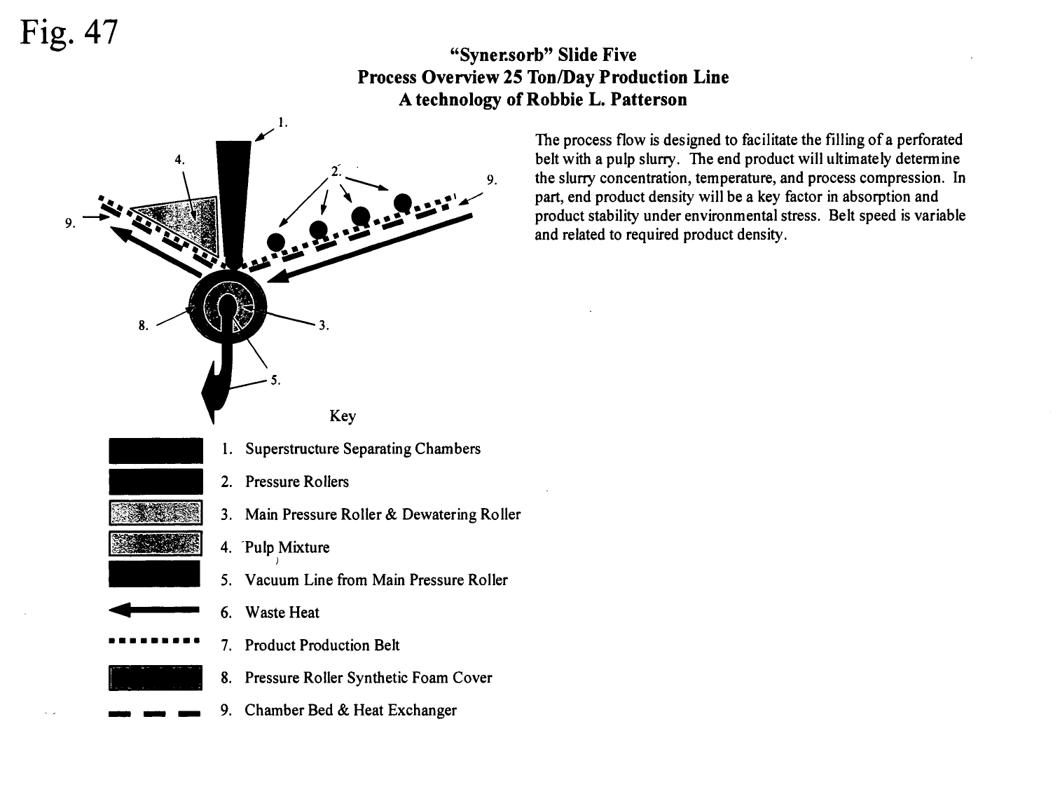

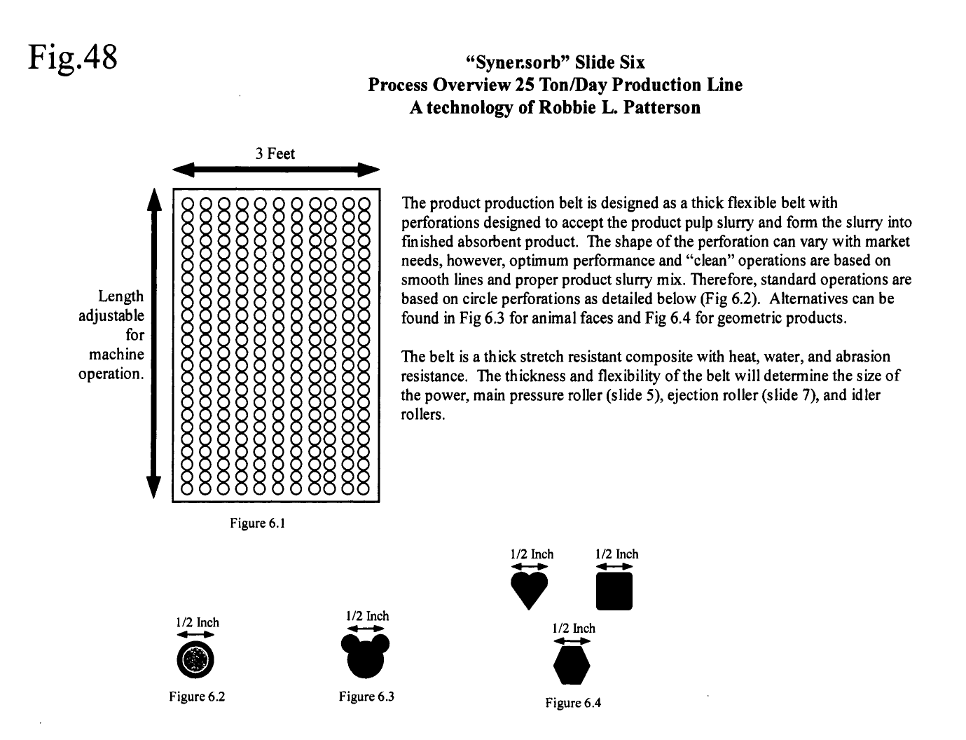

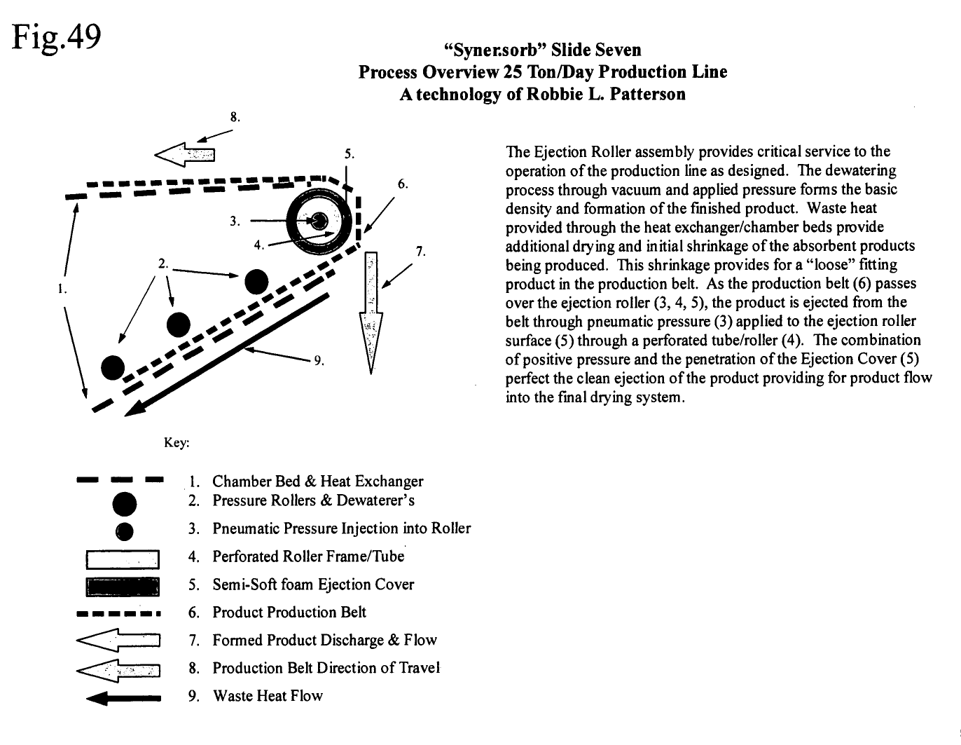

FIG. 42-49

The next eight figures are of a paper absorbent process that make fiber absorbent from wastepaper(most specifically news). This Technology (121148-PSW02) is owned by Robbie Patterson and the co-inventors to this technology are Richard Stephens (mechanical process) and Richard C Walker (for the electronic management system). It is used here to demonstrate; The Recovery Center Technology as a synergistic manufacturing technology that produces paper fiber, electricity and heat energy to run the equipment dry the product and feed the production.

This value added product can be used to trap and absorb oil and liquid hazmat substance, and serve as Kitty litter that is much more compatible to city sewage systems than the kitty gravel presently causing northeast cities a lot of flow problems due to residents flushing it down the drain, even in minimal proportions. The Recovery Center will be able to produce this finish product on location and sell it to retail markets in the city as well as, to out of town markets.

Another value added product is the recycling of computer and electronic devices retrieved from office buildings via bulk scheduled pickups. These products are broken down for usable parts or repaired for use in the electronics lab of the recovery center.

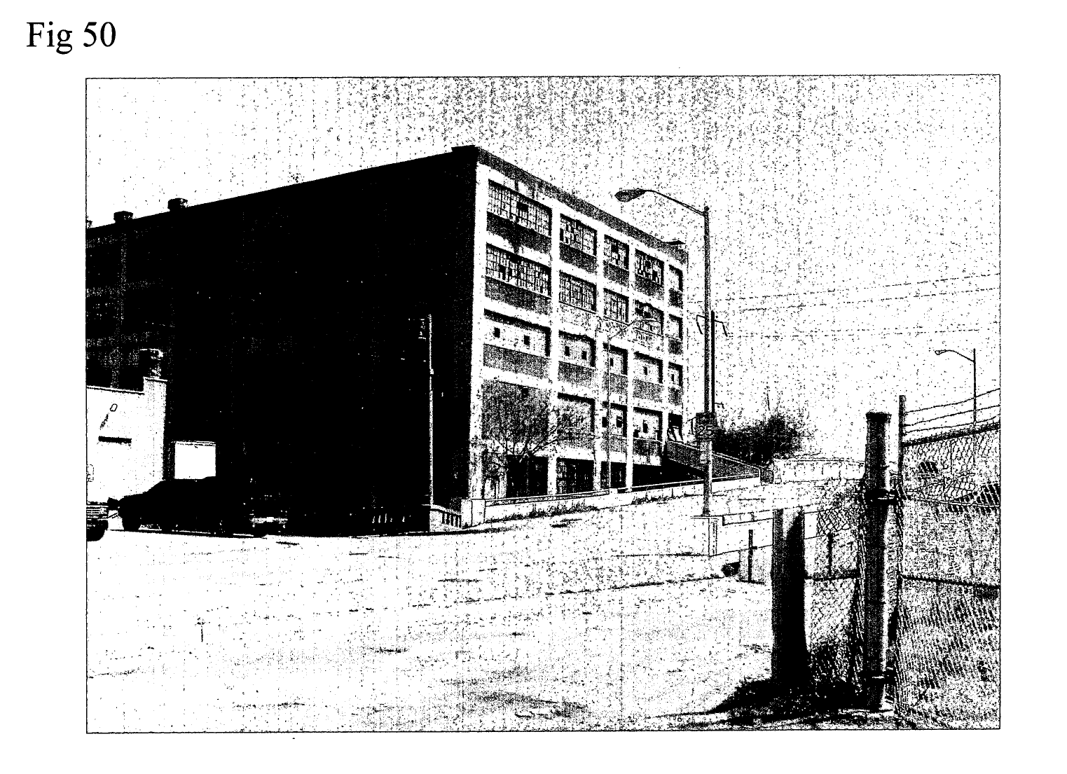

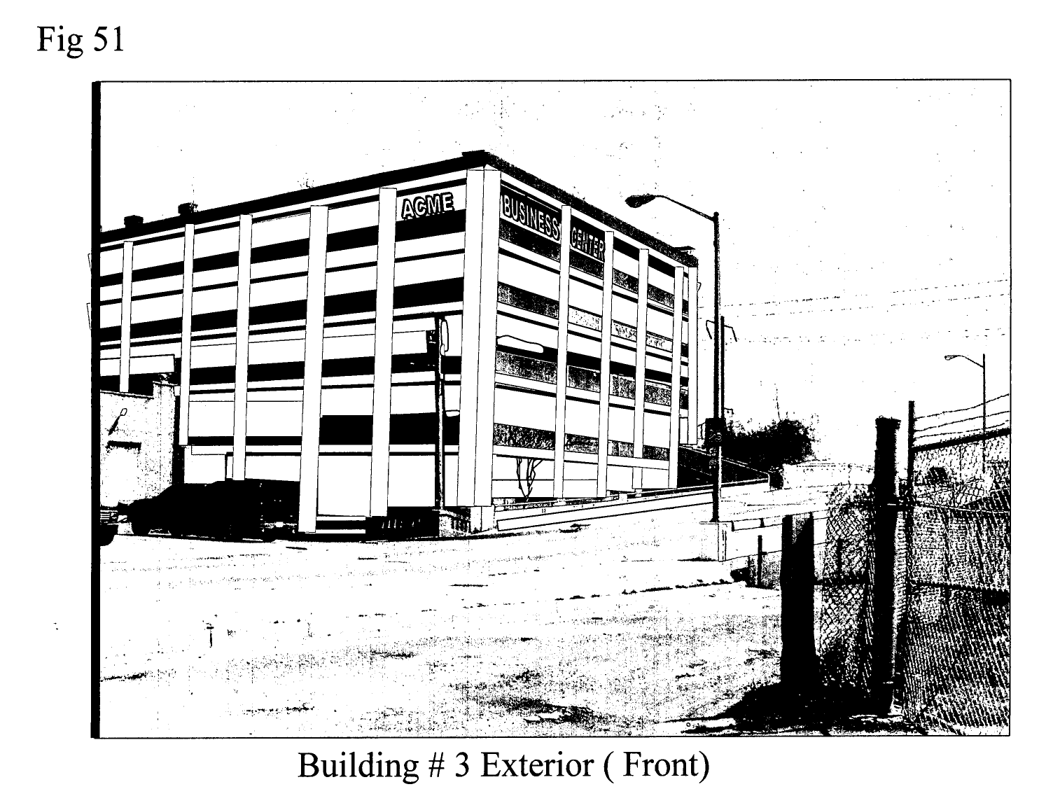

FIG. 50-51

Shows one project plan for The BRC Baltimore Recovery Center. Ino FIGS. 50 and 51 the old ACME Business Building is recovered and used to handle the small off spring businesses that the Recovery Cwnter technology can help support synergistically. For example electrical components are used in the electronic management system of The BRC and others are sold for profit on the internet, and even some more are used as instructional aids for children in the neighborhood to learn electronics, and then they are allowed to take home their own computer. More manufacturing and community based services are planed for The Recovery Center Facility, to take advantage of the resources recovered and energy produce and the area they are designed to rejuvenate.

FIG. 51

This rendering of the photo shows how the outside is improved and the stairs to the right lead into the second floor community center. Here the rest of the building houses an Electronic Recycling Company, a secure art and document storage section as well as, the Document Destruction in feeds

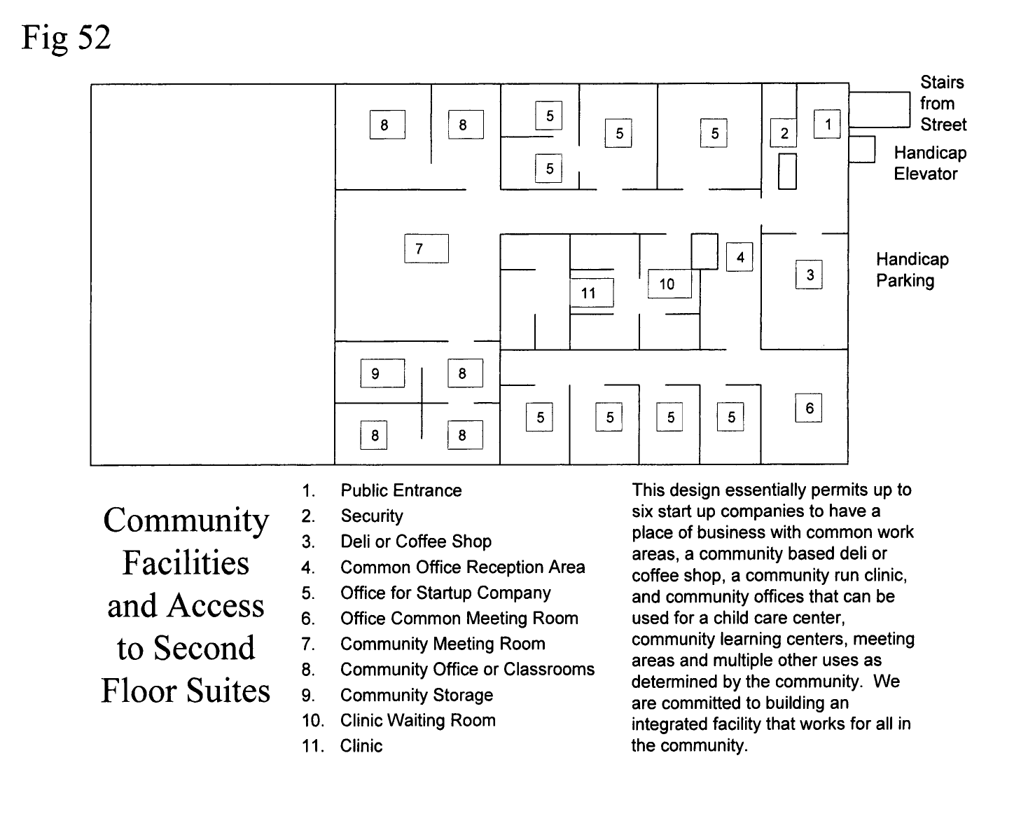

FIG. 52

This figure gives a layout of a model community center and these plans have already been presented to the BDC The Baltimore Development Corporation, with a wonderful reception. The city would fund the programs but The Recovery Center would provide The Renovated Building, Heat, and Electrical power for a community meeting place, locally owned and operated snack Bar, starter business offices, individual study centers, a health clinic and a smaller board meeting room or conference room.

The Recovery Center is designed to recover a community through using its waste stream to do so. These businesses are merely examples each city will have different needs and different properties available as well as different waste streams. It is these three things that will determine the direction and composition of an specific Recovery Center.

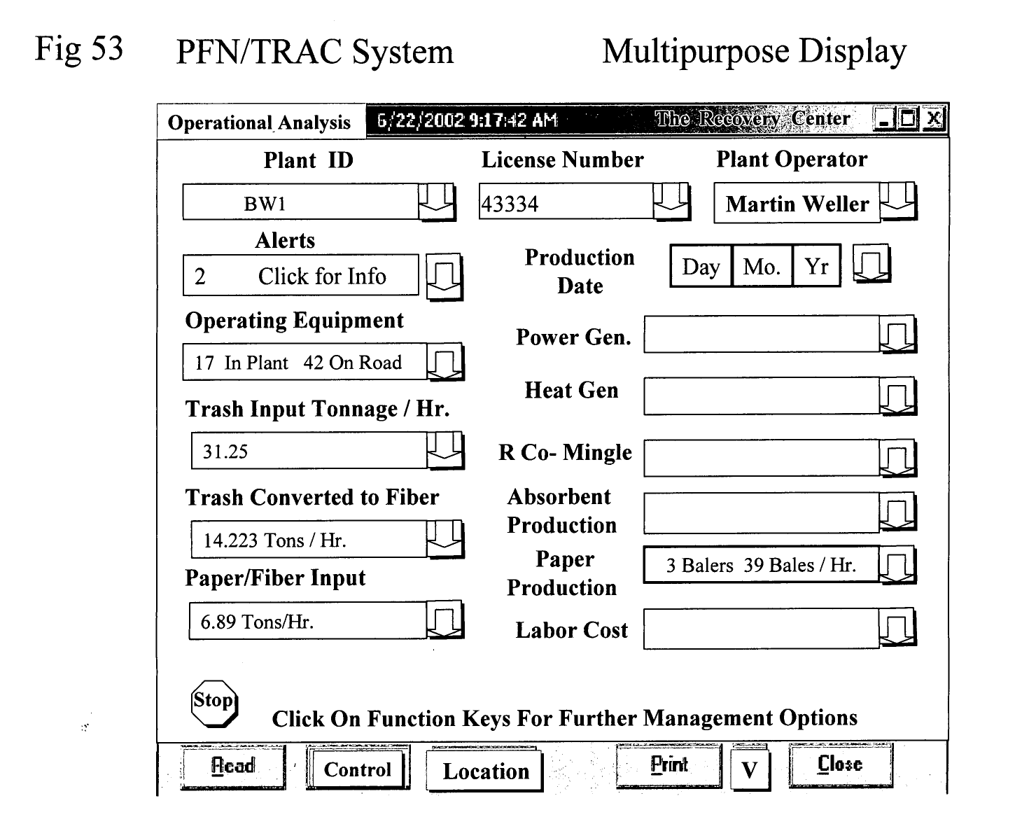

FIG. 53

Is another Windows illustration showing the production to the Plant operator for all the products being produced. This information will be on a public website if the Center is licensed on a Bond or the information will appear in a more private electronic medium (intranet or encrypted internet web site).

### SUMMARY OF INVENTION

The invention a new and unique recovery process is designed to reutilize 90 to 100 percent of the waste generated by society into like products, or flexible sub products or to reduce the volume of waste by thermo-conversion to electrical energy. The invention is based on state of the art material handling techniques that take into account what exists today in the refuse hauling business and compartmentalized recycling programs to include today's MRFS and synergistically combine their specialties through automated management like the PFN/TRAC management and security system™. Which has the capacity to flexible produce the most lucrative recyclables or recovery products to maintain a positive cash flow for this very important cleanup component of a throw away society like the United States.

History has shown us that the indirect method of allowing the market place to resolve the dilemma of waste removal and storage has resulted in the country side being destroyed by massive landfills and underground water supplies polluted. Additionally, recycling has done poorly with the exception of metals and paper fiber commercially. MRFS have sprung up in the last 15 years and all of them at times run in the red on some of the materials they are handling, causing municipalities to tax and or give up their prime paper products to small time recyclers or big refuse haulers. The reason for this is that trash haulers want to charge for all the weight and or volume they pick up and there only concern is to have the least expensive land filling cost when they travel and dump. This however [places them in direct competition with the recycler who is trying to remove his product from the same source lessening the haulers load volume and weight. So periodically the Waste companies try to buy up area recycling operations to recapture their lost tonnage and as public companies strengthen their corporate portfolio by showing the public that they are recycling as well. However in a 3 to 6 year cycles they loose these small recycling operations and either end up with more trash weight going to the land fills again or an ineffective paper recycling process with low grade paper which in many cases they lose money on. For this reason the inventors wish to see government and cities license the technology as they stand to gain the greatest return for their citizens for whom they claim to protect and serve.

Employing this technology corporately will grow corporate revenues and stabilize the recycling markets and waste hauling industry. The problem is that these individual industries (companies) want to materially handle everything but operate the process the same way they would if they were still specialized in only one aspect of the process, like the hauling and dumping trash. The hauling and dumping activity is fine, but the material handling throughout has to be changed, and this thinking out side of the box does. not get past the old skill sets of how management appraises and performs business.

Out of the Box

The invention ends the old process and eliminates land fills by reducing travel time to the landfill or transfer station where tipping fees are lowered by 60 percent. The recovery center is set up as an intermediary supplier to the Paper Mill through long term contracts with set floor numbers------. The same is true for Metal manufacturers, Glass markets, building materials and for in house manufacturing that produces value added products for local markets, and international markets. Finally, the volume of waste and garbage can always be reduced through the centers WET or waste to energy operation to generate electricity.

Because the center or invention specializes in the separation and disassociation of materials and processes them into the most cost effective and lucrative sub products for further manufacturing, it can quickly and flexibly change what it is processing to stay economically sound and continue to harvest what has been stored in legacy landfills to recoup that real estate. This process is greatly enhanced by the PFN/TRAC system of remote control and robotics automates the material handling for safer, healthier operations and accounts for all the different materials handled. The data collected by the Recovery center technology will help strategically perform present and near present day archeological reclamations and crime solving duties crimes as well as help urban planners recapture a healthy and safe environment as well as provide less expensive raw materials and sub products to present manufacturers, in many cases lowering the cost of manufacturing in the United States

Differently from singular recycling operations and the restricted MRFS of today, The Recovery Center is not reliant on a single market to survive, like the paper fiber market. If paper is down a sub product can be made locally like absorbents or fuel, or the on sight generation of electrical energy, which lowers the cost of operation as well as increases Recovery Center revenues.

The invention can be located near an urban area in need of a waste handling facility or at an existing land fill or legacy land fill, and a modular design allows much of the processes to be portable by truck or rail and shipped to an area hit by storm and need of clean up.

1. A Recovery Center claim is made for the separation, redistribution and or conversion technology to recover and or reuse paper fiber product and or other recyclables and to produce energy via efficient automated and progressive material handling, that identifies consolidates, compresses, combusts, reconstructs and or converts hauled municipal waste into value added products or fuel to reduce the need for trash transfer stations and landfill space, either past or present, and to reduce a city's dependency on fossil fuels for the production of electricity, recyclables value added products, and heat to either operate waste and or recycling operations and or other synergistic industrial, commercial and or community operations.

2. A claim according to claim 1 (one) is made for the clean combustion of reduced dry refuse and or specially prepared wet garbage to fuel boilers and create steam to drive generators and create electrical power for the center, and to sell any excess power generated back to the local utilities and the regional grid, and to use the excess heat for internal center processes and or to sell excess heat or steam back to the local community and its residents for commercial and private use.

3. A claim according to claim 1 (one) is made for the gasifying process to covert specially prepared dry waste and or wet garbage to combustible gaseous fuel, to fuel internal combustion engines and or turbines to power generators to produce electricity, and through the same gasification process to further convert waste materials to reclaim condensed oils, tars and sterile ash, that can be mixed and compressed with other building materials to produce building block; and the combination of both clean smoke stack waste to energy conversion in claim 2 two used with the gasification waste to energy process in claim 3 fall within the nature an scope of the invention an automated management technology for the handling and recovery of materials and substance.

4. A claim according to claim 1 (one) is made for the bagging of paper in translucent to transparent colored plastic bags at the source commercial or residential waste streams to quickly identify and separate different types of paper and recyclable products within a municipal refuse stream.

5. A claim according to claim 1 (one) is made to initiate source sorting for the center via educational programs either public or private funded that go out in the community and educate the commercial and residential public to the most efficient way to handle waste and recyclables for the center to be proficient and protective of personal privacy information on individuals.

6. A claim is made according to claim 1 (one) for the on site destruction of sensitive and or private documentation; for the secured containment of sensitive or private documentation at the desk of origin and for the secure material handling of that material to and through the center to it's final destruction and or recycled to an unidentifiable raw material state.

7. A claim according to claim 1 (one) is made for the special routing of specific refuse trucks to pick up dry waste and recyclable paper only known as office waste, and restrict these trucks from handling refuse materials known as wet garbage food, or bio or chemical hazardous waste such as human or animal waste products to effectively start a gross sorting process for the center.

8. A claim according to claim 1 (one) is made for the special routing of specific refuse trucks to pick up refuse known as wet garbage with food, refuse and restrict the picking up dry waste and recyclable paper known as office waste, as well as bio or chemical hazardous waste such as human or animal waste products medicinal disposals and industrial waste to effectively start a gross sorting process for the center.

9. A claim according to claim 1 (one) is made for the special routing of specific refuse trucks to pick up refuse known as Bio and or chemical waste as hazardous material and restricted from transporting any other forms of waste materials.

10. A claim according to claim 1 (one) is made for another transportation modality utilizing one vehicle pick up with separate isolated chambers or compartments to initiate and or maintain sorting integrity of like materials at the point of automotive pick up.

11. A claim is made according to claim 1 (one) to automate from a protected human participation to a non-human operation of medical and bio-waste material handling from pick up to incineration or gasification as part of the necessary BTU energy to drive either the steam or turbine generators to produce electricity, and to use this same application to destroy or destruct sensitive and or private documentation, that is guarded secured and certified so from source to consumption.

12. A claim is made according to claim 1 (one) for a new and unique recovery center that separates and recycles, office waste paper, cardboard, hard white, white ledger, mixed paper, colored paper, books news, glass, cans from wood, dry wall, metal, construction block, brick as well as processes biomass ecologically through converting the bulk rubbish into community mulch and producing electricity from rotting garbage thereby replacing the former unsanitary and unsafe trash transfer stations and their unsafe and unhealthy final repositories the municipal landfill.

13. A claim according to claim 1 (one) and further to claim 12 (twelve) is made for any federal, state, county, local, city and or municipal government' to specially and specifically license this new and unique modality to handle refuse and recyclables synergistically and with automatic reporting, thereby creating value added product and material on location in a much safer environment to be treated as a more optimal technology that provides a higher standard of waste handling and is a more acceptable replacement to legacy technologies i.e.; MRFS, recyclers, trash transfer stations and landfill operations where government must regulate and police differently, more strictly and manually.

14. A further claim according to claim 1(one) is made for the center to have a large flat receiving area for refuse and recycling trucks to unload their combined and or pre-separated loads for further rough sorting of like materials, recyclable products and wet garbage, which is slotted for reduction and energy conversion, and that the receiving area be termed the Tipping Area or Floor and the resulting distribution process be called the Presort And Feed Stock Area.

15. A further material handling claim according to claim 1 (one) is made for the separation and distribution of like refuse materials, recyclables and wet garbage by material moving equipment to include but not limited to skid steer loaders, and loaders with grapple buckets, forklifts with forks and clamps, articulating loaders, track and fixed crane and grapples or clam buckets;
sorting screens constructed with rotating disks spaced to catch card board, flat objects and building materials i.e. plywood, drywall, with a waste removal belt below the rotating sort disks;
waste below is further separated through a series of conveyor belts trommels and special chambers that identify material qualities and sort by them i.e. magnets, eddy currents, Optical Recognition Systems to include but not limited to light, video, vibration, sound, weight sensing;
and human labor, which is more greatly utilized in initial recovery center set ups and then coupled with more automation to increase volume with the same labor.

16. A further equipment claim according to claim 1 (one) is made for the use of conveyor belts, sorting belts, blowers, tumblers, magnets, bins, containers, and for hoppers to store, transport and separate, route and load recyclables and consolidated dry waste into compaction and baling equipment, transport vehicles and or auger and shredders to fuel boilers or gassifiers to energize turbines to drive generators and produce electricity.

17. A claim of technical synergy according to claim 1 (one) is made for the center to recover news and other suitable paper fiber, and process it in a pauper to produce value added paper stock products by using the excess heat generated from the gasification or production of steam for electricity to also dry the pulp paper products.

18. A claim of recycling according to claim 1 (one) is made for the collection and designed crushing of glass per applications 1 through 6 for use as follows 1. for construction and landscaping fill, 2. aquatic or aquifer straining mechanism or screen to trap solid contaminants in fluids, 3. to pack radioactive waste containers in to keep them dry, stable and isolated in Yucca mountain as well as provide an energy depleting medium, and 4. to support underground nuclear vaults and tunnel structures from shocks of earthquakes as well geological shifts, with 5. the added benefit from glass refraction/reflection qualities to trap particle energy expenditure from the stored nuclear waste products, and 6. use recycled glass as packing or storage medium for shipments of nuclear waste in casks to maintain a stabilized environment. 7. tumbled glass to make decorative smooth stones.

19. A Homeland Security Claim is made for the recovery center according to claim 1 (one) to detect terrorist activities and or unsafe, unauthorized and or hazardous use of equipment, materials and substances via sensors, computers and wireless to include; the PFN/TRAC System and PS1/HS1 sensor suites for monitoring and managing transportation and material movement of refuse, both, waste and recyclables to include the separation, sorting, reuse and or storage of materials or by products in a community and elsewhere.

20. A further electronics claim according to claim 1(one) is made for the center's automated management system's capacity to detect and processes alert signals that are generated from the electronic recognition of hazardous materials and or substances flowing in the waste stream as well as pinpoint material origins, and notify the appropriate authorities and first responders of such occurrences in real-time or near real-time.

21. A further claim according to claim 1 (one) is made for the detection of dangerous microbes/bio-hazards, chemical molecules and elements to include radio-active contaminants.

22. A further claim according to claim 1 (one) is made for the multiple delivery of alert signals as national security data to the appropriate agencies and local responders simultaneously.

23. A claim according to claim 1 (one) is made for the local and multiple recording of data at the PFN and HS-1 sensor suite level and at the mass data storage level in the control center and with encrypted archive files generated at all internet and intranet contacts simultaneously.

24. A claim according to claim 1 (one) is made for the formation of an advanced detection agency or operation with inter agency and inter-industry cooperation and operation to develop standards for alert status and protocols for monitoring and managing waste stream products to include the process and flow for hazardous materials such as (e.g. Red bag Bio/chemical medical waste products, (which are prime materials for dirty bombs and terrorists) to their safe destruction reuse or storage and for emergency scenarios with first responders and homeland security.

25. A claim according to claim 1 (one) is made for the recovery center to recognize and handle safe processes by which hazardous waste e.g. red bag waste is separated and destroyed through isolation and incineration and to include final disposition of hazardous material either via sensing and monitoring the smoke stack particles to insure safe air emission levels are maintained;
and to develop similar and specific standard identification criterion and handling procedures and protocols to be employed in gasification technology, micro wave treatment, and chemical treatments at the recovery center, and to be specific there to.

26. A claim according to claim (one) for certification is made for the recovery center to provide part or all of the following certified functions both flexible and application specific to the municipality or installation's needs; a qualified, Document Destruction Operation, Hazardous Material Handling Facility, for Biological and or Chemical Waste materials, Paper Fiber recycling, wet garbage or Municipal Waste Facility, Dry Waste, Office waste, Building Materials, Scrap Metal Re-distribution Center and Municipal Biomass Waste with mulching and or composting.

27. A claim according to claim 1 (one) is made for the standardization of this recovery facility and technology to include protocols developed by government and industry standards efforts to monitor the nations waste stream for dangerous materials that could be used by terrorist to negatively affect public safety, national security and the economy and to further design a cookie cutter or modular approach to the country's Municipalities waste handling needs, where the technology taught in this specification can be used to combine disparate recycling and trash hauling to day

28. A claim according to claim 1 (one) is made for the elimination of Trash Transfer Stations with the recovery center becoming a redistribution center for waste materials to be processed into raw materials and sub products for shipment to other manufacturing processes or sold locally as value added product.

29. A claim is made according to claim 1 (one) for the elimination of landfills as the final resting place for municipal waste and garbage to decompose, due initially to recovery center technology located near the source of the trash and waste producers, and secondly when it is placed near existing land fills to re-harvest the slow to decompose waste into value added products, energy and to reclaim the real estate in a favorable manner to the community, and raise the value of the location for other use.

30. A claim according to claim 1 (one) is made for a modular mobile version of The Recovery Center (the Invention to be trucked or transported by rail to a location for the rapid processing of waste materials and recyclable products, and to make sub products, fuel and electrical energy.

31. A claim according to claim 1 (one) for urban and community improvement is made for the Recovery Center technology, the invention to include increased, employment, increased value and public safety for past landfill property, elimination of trash transfer stations, greater recycling in type and volume, more alternative energy produced, and less waste residually stored in landfill operations

32. A claim according to claim 1 (one) is made for a wireless stop or kill button to improve industrial safety that allows a person operating around equipment to stop the equipment through remote control, robotics and or pre-programmed automation that recognizes when the person is in harms way of the operating equipment.

33. A further claim of accessory function is made according to claim 1 (one) for the PFN/TRAC system to incorporate this locate and or equipment stop function in the 1Ps personal PFN/TRAC units worn by individuals and to responsive with any relevant equipment, with further claim for this capacity with any other wireless device or personal communication device such as but not limited to; Cellular phones, wireless PDAs, hand held radios, walkie-talkies, application specific stop or kill buttons and or personal RF beacons.

34. A claim is made for a plastic bag design to have an elastic top that hold the bag open and in place when placed over a waste container and then automatically closes when released from the container.

35. A further claim according to 34 is made for the bag to be manufactured in a pile or set of 4 to 12 bags to be set in the container bottom for rapid installation upon removal of the filled one and or to be utilized in this manner.

36. A claim according to claim 34 is made for another plastic bag modality to employ four or multiple rubber bands around the circumference of the bag to first attach the bag to the waste container to hold it up and open and then secondly to close the container to hold contents in and give flexible expansion to a neck orifice to allow compressed air out of the bag without rupturing it upon compaction.

37. A further claim according to claim 34 is made for the multiple stacking of these bags in the bottom of a waste container for easy replacement during the changing of the bags both as a manufacturing quality and or in use.

38. A claim according to claim 34 (thirty four) is made for the use of plastic bags to materially handle different waste, and to identify that waste by bag color or barcode or RFID technology or tagging or labeling or transparency to visually identify or translucent color shading visually identify for the purpose to aid in routing and or sorting of materials to recycle and or recover and or destroy or secure and handle in a safe manner.

39. A claim is made for a plastic bag with holes to allow air to pass out of the bag without rupturing the bag when compressed while retaining the contents of the bag.

40. A claim is made according to 34 or 39 for manual and or machine gross sorting of bagged materials deposited from collection vehicles to include but not limited to the automated debagging of the materials.

41. An information technology and material handling claim according to claim 1(one) is made for material handling equipment either mobile or stationary to transmit and receive data and information with a shipping and or receiving department via wireless computer interfacing;
and further that the hardware and software on the material handling equipment have the capacity to read and transmit, receive and print bar code data and information, RFID data, magnetic strip data and or any arbitrary shipping and or receiving data or information as well as, pre pare or generate the appropriate labels for the materials being handled;
and further that this capacity is made for the PFN/TRAC System Units 1E, 1P, 1SV, 1A, 1M, 1RR

42. A claim according to claim 1 (one)is made for the use of gassifiers to generate electricity heat and oils as part of A Recovery Center technology that produces value added products from waste materials and the energy they can provide.
